(19) United States
(12) Patent Application Publication
(10) Pub. No.: US 2022/0396654 A1
(43) Pub. Date: Dec. 15, 2022

(54) Modified Diene Copolymers and Their Use

(71) Applicant: Dynasol Elastómeros, S.A. de C.V., Altamira (MX)

(72) Inventors: Sergio Alberto Moctezuma Espiricueto, Tampico (MX); Gabriela Elizabeth Blanco Reyes, Madero (MX); Jesús Eduardo Ibarra Rodríguez, Madero (MX); Gabriel Hernández Zamora, Tampico (MX); Jose Luis García Vidales, Tampico (MX); Luis Antonio Rodríguez Guadarrama, Madrid (ES); Sergio Corona Galván, Madrid (ES); Luis Serrano Avilés, Madrid (ES); Christopher J. Hardiman, Farmington, CT (US)

(73) Assignee: Dynasol Elastómeros, S.A. de C.V., Altamira (MX)

(21) Appl. No.: 17/773,379

(22) PCT Filed: Nov. 6, 2020
(86) PCT No.: PCT/IB2020/000963

§ 371 Date: Apr. 29, 2022

Related U.S. Application Data
(60) Provisional application No. 62/932,216, filed on Nov. 7, 2019.

(51) Int. Cl. C08F 297/04; C04B 26/26; C04B 24/26; C09D 153/02; C09J 153/02; C09K 3/10; C08L 53/02

(52) U.S. Cl. CPC C08F 297/046; C08F 297/042; C08F 297/044; C04B 26/26; C04B 24/2688; C09D 153/025; C09J 153/025; C09K 3/10; C08L 53/025; C08F 2810/40; C09K 2200/0642

(57) ABSTRACT

The present invention provides a modified diene copolymer composition having a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be in-chain and/or chain-end modified with at least one unit of at least one substituted vinyl aromatic monomer; optionally having a block copolymer made from the modified A-B-C or C-B-A copolymer, wherein the block copolymer comprises at least two of the modified A-B-C or C-B-A copolymers. The invention also provides a process for making the modified diene copolymer composition.

### CROSS-REFERENCE TO RELATED APPLICATIONS

This is a national stage application filed under 35 U.S.C. 371 for International Application No. PCT/IB2020/000963 filed on 6 Nov. 2020, which was published as Publication No. WO 2021/090068 A2, which is incorporated by reference. This application claims priority to U.S. Provisional Patent Application No. 62/932,216 filed on 7 Nov. 2019.

### BACKGROUND OF INVENTION

### 1. Field of the Invention

The invention relates to modified diene copolymers and their use, reinforced materials containing the modified diene copolymers, and articles made from the reinforced materials.

### 2. Description of the Related Art

The polymers prepared by anionic polymerization may be modified to improve their characteristics for their intended applications. Many modification routes have been developed over the years. The most common modifications routes include: molecular weight; molecular weight distribution; monomer composition; diene microstructure; monomer sequence length distribution; stereochemistry; monomer addition order and sequencing; chain coupling through reactions of multifunctional species with living anions to synthesize polymers with linear, radial, comb, arm-like, branched or hyper-branched structures; and combinations of the above modifications. More sophisticated modifications routes include: introducing chemical functionalities through end-capping reactions or functional initiators; polymerization with multifunctional initiators to directly synthesize polymers with linear, radial, comb, arm-like, branched or hyper-branched structures; hydrogenation of residual double bonds; and combinations of the above modifications.

Elastomers based on monovinyl aromatic and conjugated diene monomers are extensively used as pressure-sensitive adhesives (PSA), spray and contact adhesives, panel and construction mastics, sealants and coatings. Isoprene-containing elastomers are preferred for hot melt pressure sensitive adhesives (HMPSA) because they can be readily tackified at low cost. Butadiene-containing elastomers are generally preferred for construction or laminating adhesives because they can provide stiffness and cohesive strength. Hydrogenated versions of these elastomers are preferred for sealants because of their higher weather resistance.

The polymers prepared by anionic polymerization may be useful in their own right as elastomers for adhesives, sealants and coatings, tires and other industries. However, many styrene/butadiene-based polymers prepared by anionic polymerization show low compatibility and/or low reactivity, and have met with limited success in the pressure and non-pressure sensitive hot melt and solvent based adhesives for taping, labeling, packaging, construction and positioning adhesive end-use applications. High molecular weight styrene/diene-based polymers are typically formulated in blends or mixtures useful as adhesives, sealants and coatings to provide cohesive strength and adequate balance between adhesive and cohesive properties for each end-use application, wherein problems are observed related to low concentrations, poor dispersibility and high viscosity of the polymers prepared by anionic polymerization, which reflects on formulations with high emission of volatile organic compounds (VOCs), long processing times and low production efficiency.

In addition, polymers prepared by anionic polymerization may be used to modify the characteristics of various materials such as asphalt, plastics and rubbers. For example, the polymers prepared by anionic polymerization may be used as compatibilizers and reinforcing agents in asphalt. Similar problems, related to low concentrations, poor dispersibility and high viscosity, have arisen where anionically polymerized polymers are used in the asphalt modification such as paving and roofing end-use applications.

However, it is still highly desirable to combine the unique processing properties of low viscosity diene copolymers and the potential reactivity of specific monomer moieties in such a way as to improve on the balance between processability and reinforcement performance in many applications. It is desirable to prepare modified diene copolymer compositions and find a route by any living polymerization to further develop the reactivity of those compositions in the end-use applications. Thus, it would also be desirable to develop a method for preparing modified diene copolymer compositions that are: more processible, dispersible, reactive and/or compatible with a wide variety of materials and other substrates, including adhesive, sealant and coating ingredients, asphalt and bitumen modification materials, and; suitable to meet the specific reinforcement requirements, production efficiencies and environmentally-friendly regulations for a broad range of end-use applications such as tapes, labels, contact and sprayable adhesives, sealants and coatings, and asphalt/bitumen modification and emulsions for road paving, roofing, shingles and waterproofing membranes.

It has now surprisingly been found a novel modified diene copolymer composition that achieves a tailored compatibility and reactivity, and an improved balance between processability and reinforcement performance for various applications such as adhesives, sealants, coatings, tires, plastic modification, and asphalt/bitumen modification and their emulsions for road paving, roofing, shingles and waterproofing membranes. The novel modified diene copolymer composition is useful for pressure and non-pressure sensitive, hot melt and solvent based formulations for taping, labeling, packaging, construction and positioning adhesive end-use applications. In addition, the novel modified diene copolymer composition is useful for low viscosity and reactive hot-melt adhesive compositions, particularly for sprayable and contact adhesives with high heat resistance, low energy processability, and low emission of volatile organic compounds (VOCs) relative to solvent-based formulations. More specifically, the novel modified diene copolymer composition provides the above mentioned applications with: tailored compatibility with formulation ingredients, reactive sites susceptible to modification, and cross-linkable moieties that allow photo-, thermal- and chemical-cured crosslinking; easy processing advantages such as short dispersion time, low mixing temperature, low viscosity, low VOC level, and excellent storage stability; and good reinforcement advantages such as high heat resistance, high cohesive strength and shear resistance, high tack and peel resistance, high elastic response, wide range of performance grade, high ductility and penetration, good compromise between high and low temperature properties, and self-healing behavior.

### SUMMARY OF THE INVENTION

The present invention provides modified diene copolymer compositions, methods for producing the modified diene copolymer compositions, polymer blends and mixtures containing the modified diene copolymers, reinforced materials containing either the modified diene copolymer compositions or the polymer blends and mixtures containing the modified diene copolymers, and articles made from the reinforced materials.

The present invention provides a modified diene copolymer composition, which comprises: (i) a copolymer comprising units of a conjugated diene (CD) monomer, an unsubstituted vinyl aromatic (UVA) monomer and a substituted vinyl aromatic (SVA) monomer, wherein the copolymer includes a segment that comprises a copolymer of the CD monomer and the SVA monomer in addition to or other than by bonding of a block of CD monomer to a block of SVA monomer; or (ii) a mixture of a copolymer of CD monomer and UVA monomer with a copolymer of CD monomer, UVA monomer and SVA monomer, where the SVA monomer provides an in-chain or a chain-end reaction site useful in end-use applications for the modified diene copolymer composition. The SVA monomer is preferably a ring-substituted vinyl aromatic monomer. The structure of the copolymer of CD and SVA is a random, tapered, counter-tapered or a controlled distribution of the units of the CD and the SVA monomers.

The copolymer comprising units of the CD monomer, the UVA monomer and the SVA monomer has a structure of

[CD/SVA]-[CD/SVA/UVA]-[UVA/SVA-SVA],

where a forward slash, /, indicates a copolymer of the units of the monomer identified by its abbreviation, where a closed pair of brackets, [ ], indicates a segment of the copolymer, and where the structure is determined by simultaneous anionic copolymerization of CD, UVA and SVA under unaltered reaction kinetics.

In one embodiment the copolymer has a structure X-([CD/SVA]-[CD/SVA/UVA]-[UVA/SVA-SVA])n determined by using a multifunctional initiator or a linking agent, where the copolymer comprises at least two of the copolymer chains, and where the copolymer may be totally or partially multi-initiated or linked.

The copolymer in another embodiment comprises a block copolymer, where the block copolymer has a structure of UVA-(CD-UVA)-SVA or UVA-(CD-SVA)-SVA or SVA-(CD-UVA)-SVA or SVA-(CD-SVA)-SVA. The structure of the (CD-UVA) block or the (CD-SVA) block is a random, tapered, counter-tapered or a controlled distribution of the units of the CD and the UVA or SVA monomers. With partial coupling, the copolymer may further comprise a second copolymer having a structure of [UVA-(CD-UVA)]ₙ-X or [UVA-(CD-SVA)]ₙ-X or [SVA-(CD-UVA)]ₙ-X or [SVA-(CD-SVA)]ₙ-X, where X is a residual moiety from a coupling agent.

The present invention provides a process for making a modified diene copolymer composition, which comprises the steps of:

adding a solvent to a reactor;

adding an unsubstituted vinyl aromatic (UVA) monomer to the reactor;

adding a substituted vinyl aromatic (SVA) monomer to the reactor;

adding a conjugated diene (CD) monomer to the reactor;

adding an initiator to the reactor to initiate a reaction; and

copolymerizing the CD, UVA and SVA monomers simultaneously, thereby forming a product copolymer comprising units of the CD. UVA and SVA monomers. The SVA monomer is preferably a ring-substituted vinyl aromatic monomer. The ring-substituted vinyl aromatic monomer is preferably selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene.

The product copolymer from the process has a structure of

[CD/SVA]-[CD/SVA/UVA]-[UVA/SVA-SVA],

where a forward slash, /, indicates a copolymer of the units of the monomer identified by its abbreviation, and wherein a closed pair of brackets, [ ], indicates a segment of the product copolymer.

If a multifunctional initiator or a linking agent is used, the copolymer has a structure X-([CD/SVA]-[CD/SVA/UVA]-[UVA/SVA-SVA])n, where the copolymer preferably has at least two of the copolymer chains, and the copolymer may be totally or partially multi-initiated or linked.

The present invention provides a modified diene copolymer composition, which comprises: (i) a copolymer comprising units of a conjugated diene (CD) monomer, styrene (STY) monomer and a ring-substituted vinyl aromatic (P) monomer, wherein the copolymer includes a segment that comprises a copolymer of CD and P in addition to or other than by bonding of a CD block to a P block; or (ii) a mixture of a STY-CD copolymer and a STY-CD-P copolymer, where P provides an in-chain or a chain-end reaction site useful in end-use applications for the modified diene copolymer composition. The structure of the copolymer of CD and P is a random, tapered, counter-tapered or a controlled distribution of the units of the CD and the P monomers.

In one embodiment, the modified diene copolymer composition comprises a copolymer that has a structure of [CD/P]-[CD/P/STY]-[STY/P-P], where a forward slash, /, indicates a copolymer of the units of the monomer identified by its abbreviation, wherein a closed pair of brackets, [ ], indicates a segment of the copolymer, and wherein the structure is determined by simultaneous anionic copolymerization of CD, STY and P under unaltered reaction kinetics. Example 1 below provides a preferred embodiment. If a multifunctional initiator or a linking agent is used, the copolymer has a structure X-([CD/P]-[CD/P/STY]-[STY/P-P])n, where the copolymer preferably comprises at least two of the copolymer chains. The copolymer may be totally or partially multi-initiated or linked. The ring-substituted vinyl aromatic monomer P is preferably selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene. By definition, alpha methylstyrene is not a ring-substituted vinyl aromatic monomer P.

The present invention provides a copolymer, which comprises a block copolymer, where the block copolymer has a structure of STY-([CD/P]-[CD/P/STY]-[STY/P-P]), where the [CD/P]-[CD/P/STY]-[STY/P-P] block is formed by simultaneous anionic copolymerization of CD, STY and P. The second block is preferably formed under altered reaction kinetics due to a polar modifier. Also, the second block copolymer is preferably formed while adding the CD to a reactor at a slower rate than the STY and/or the P are added to the reactor, thereby forming a counter-tapered structure in which more STY and/or P are initially incorporated into the [CD/P]-[CD/P/STY]-[STY/P-P] block copolymer than if the CD had been added to the reactor at the same rate that the STY was added to the reactor. Counter tapered means that the molar ratio of the CD monomer to STY or P monomer in the second block is lower proximal to the STY block relative to the molar ratio of the CD monomer to the STY and/or the P monomer distal to the STY block. The applicant's U.S. Patent Application Pub. No. 20170210841 A1 provides further information on a counter tapered structure and is incorporated by reference. Example 2 below provides a preferred embodiment.

The present invention provides a block copolymer that has a structure of P-([CD/P]-[CD/P/STY]-[STY/P-P]), where the P block is formed by anionic polymerization of P, and wherein the [CD/P]-[CD/P/STY]-[STY/P-P] block is formed by simultaneous anionic copolymerization of CD, STY and P. It was a surprising and unexpected discovery that the simultaneous anionic copolymerization of CD, STY and P, particularly for butadiene, styrene and p-methylstyrene, readily copolymerized with the conjugated diene to first yield a segment of the conjugated diene and the P monomer, which may be a tapered segment, followed by a tapered segment that includes units of each of the CD, P and STY monomers, and after all of the CD monomer is consumed, a tapered segment of units of STY and P monomers is formed, ending with a homopolymer segment of units of the P monomer. This structure may depend on the relative concentrations of the monomers, and examples are provided below, where this structure was found.

The second block may be formed in the presence of a polar modifier, which alters reaction kinetics. Further, the second block copolymer may be formed while adding the CD to a reactor at a slower rate than the STY and/or the P are added to the reactor, thereby forming a counter-tapered structure in which more STY and/or P are initially incorporated into the [CD/P]-[CD/P/STY]-[STY/P-P] block copolymer than if the CD had been added to the reactor at the same rate that the STY was added to the reactor, wherein counter tapered means that the molar ratio of the CD monomer to STY and/or P monomer in the second block is lower proximal to the P block relative to the molar ratio of the CD monomer to the STY and/or the P monomer distal to the P block.

The present invention provides a block copolymer that has a structure of STY-(CD/STY)-P or STY-(CD/P)-P or P-(CD/STY)-P or P-(CD/P)-P. The block copolymer is preferably formed in the presence of a polar modifier, preferably forming a counter-tapered structure. The copolymer is preferably formed as taught in Example 3 below, where partial coupling is employed. In this case, the copolymer further comprises a second copolymer having a structure of [STY-(CD/STY)]ₙ-X or [STY-(CD/P)]ₙ-X or [P-(CD/STY)]ₙ-X or [P-(CD/P)]ₙ-X, wherein X is a residual moiety from a coupling agent.

The present invention also provides a copolymer that comprises a mixture of a triblock copolymer and a coupled copolymer, where the triblock copolymer has a structure of STY-CD-P, and wherein the coupled copolymer has a structure of (STY-CD)n-X, wherein X is a residual moiety from a coupling agent. Example 5 below teaches how this composition can be obtained and discloses a preferred embodiment.

The present invention provides in another embodiment a block copolymer that has a structure of STY-(CD/P)-P or P-(CD/P)-P or STY-(CD/P)-STY. The (CD/P) block is counter tapered in a preferred embodiment, but a normal tapered or random or controlled distribution may also have a variety of applications. Example 6 illustrates a particular embodiment that yields this structure. The conjugated diene monomer CD is preferably a butadiene or isoprene, and the ring-substituted vinyl aromatic monomer P is preferably p-methylstyrene or p-tertbutylstyrene. The copolymer can be selectively, partially or fully hydrogenated. A final product of the modified diene copolymer composition is preferably in the form of a bale, free-flowing, powder, emulsion, or encapsulated.

There are a number of end-use applications for the modified diene copolymer compositions of the present invention, including in asphalt, adhesives, sealants and in plastics. One end-use application is in a bituminous or asphalt composition, which comprises at least one bitumen or asphalt; at least one additive selected from the group consisting of plasticizers, fillers, coupling agents, crosslinking agents, photoinitiators, flow resins, tackifying resins, processing aids, antiozonants and antioxidants; and any one of the modified diene copolymer (MDC) compositions described above, where the bituminous or asphalt composition includes from about 0.5 to about 25 percent by weight of the MDC composition. An emulsifying agent can also be used, and the bituminous or asphalt composition can be emulsified in water.

Another end-use application is in an adhesive or coating composition, which comprises at least one additive selected from the group consisting of plasticizers, fillers, coupling agents, crosslinking agents, photoinitiators, flow resins, tackifying resins, processing aids, antiozonants and antioxidants; and any one of the modified diene copolymer (MDC) compositions described above, where the adhesive or coating composition includes from about 0.5 to about 50 percent by weight of the MDC composition.

The present invention provides a sealant composition, which comprises at least one additive selected from the group consisting of plasticizers, fillers, coupling agents, crosslinking agents, photoinitiators, flow resins, tackifying resins, processing aids, antiozonants and antioxidants; and any one of the modified diene copolymer (MDC) compositions described above, where the sealant composition includes from about 0.5 to about 50 percent by weight of the MDC composition.

The present invention provides plastic composition, which comprises a polymeric composition; and any one of the modified diene copolymer (MDC) compositions described above, where the MDC composition is mixed into the polymeric composition.

A preferred embodiment for making a modified diene copolymer (MDC) composition according to the present invention includes the steps of:

adding a solvent to a reactor;

adding styrene (STY) monomer to the reactor;

adding a ring-substituted vinyl aromatic (P) monomer to the reactor;

adding a conjugated diene (CD) monomer to the reactor;

adding a lithium initiator to the reactor to initiate a reaction; and

copolymerizing the CD, STY and P monomers simultaneously, thereby forming a product copolymer comprising units of the CD, STY and P monomers, wherein P is selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene. The product copolymer has a structure of [CD/P]-[CD/P/STY]-[STY/P-P], where a forward slash, /, indicates a copolymer of the units of the monomer identified by its abbreviation, and wherein a closed pair of brackets, [ ], indicates a segment of the product copolymer. See Example 1 for a particular embodiment.

By using a multifunctional initiator or a linking agent, one can obtain a copolymer that has a structure X-([CD/P]-[CD/P/STY]-[STY/P-P])n, wherein the copolymer comprises at least two of the copolymer chains. The copolymer may be totally or partially multi-initiated or linked.

In one embodiment, the STY, the P and the CD monomers form a total monomer mixture, and the STY monomer is 5 to 49 wt % of the total monomer mixture, the P monomer is 1 to 20 wt % of the total monomer mixture, and the CD monomer is 50-94 wt % of the total monomer mixture. Preferably, the STY monomer is 5 to 24 wt % of the total monomer mixture, the P monomer is 1 to 20 wt % of the total monomer mixture, and the CD monomer is 66-94 wt % of the total monomer mixture. In a preferred embodiment, the CD monomer is 70 to 80 wt % of the total monomer mixture. The CD, STY and P monomers are preferably copolymerized until conversion is complete, after which an alcohol is added to the reactor to terminate any living polymer chains, and preferably, the peak molecular weight (Mp) of the [CD/P]-[CD/P/STY]-[STY/P-P] copolymer is between about 90 to 200 kg/mol.

Another process for making a modified diene copolymer (MDC) composition includes the steps of:

adding a solvent to a reactor;

adding a polar modifier to the reactor;

adding styrene (STY) monomer or a ring-substituted vinyl aromatic (P) monomer to the reactor;

adding a lithium initiator to the reactor to initiate a reaction;

allowing the STY monomer or the P monomer to polymerize, thereby forming a STY block or a P block, respectively;

adding P monomer to the reactor;

adding STY monomer to the reactor;

adding a conjugated diene (CD) monomer to the reactor, and allowing the CD monomer, the STY monomer and the P monomer to copolymerize, thereby forming a ([CD/P]-[CD/P/STY]-[STY/P-P]) copolymer block and finally forming a STY-([CD/P]-[CD/P/STY]-[STY/P-P]) diblock copolymer or a P-([CD/P]-[CD/P/STY]-[STY/P-P]) diblock copolymer. See Example 2 for a particular embodiment. The STY, the P and the CD monomers form a total monomer addition to the reactor, and preferably, the first STY or P monomer addition is from about 3 to about 20 wt % of the total monomer addition. Preferably, the STY monomer addition used to form the ([CD/P]-[CD/P/STY]-[STY/P-P]) copolymer block is from about 10 to about 40 wt % of the total monomer addition. The P monomer addition used to form the ([CD/P]-[CD/P/STY]-[STY/P-P]) copolymer block is preferably from about 0.5 to about 15 wt % of the total monomer addition. The CD monomer addition is preferably at least about 40 wt % of the total monomer addition, more preferably at least about 50 wt % of the total monomer addition, and most preferably at least about 60 wt % of the total monomer addition.

STY monomer is preferably used to make the first block, and the STY, the P and the CD monomers form a total monomer addition to the reactor, where the first STY monomer addition is from about 5 to about 10 wt % of the total monomer addition, the second STY monomer addition is from about 25 to about 30 wt % of the total monomer addition, the P monomer addition is from about 0.5 to about 5 wt % of the total monomer addition, and the CD monomer addition is from about 60 to about 70 wt % of the total monomer addition. Preferably, an alcohol is added to the reactor to terminate any living polymer chains. The peak molecular weight (Mp) of the ([CD/P]-[CD/P/STY]-[STY/P-P]) copolymer block is preferably from 90 to 180 kg/mol.

Another process for making a modified diene copolymer composition comprises the steps of:
adding a solvent to a reactor;
adding a polar modifier to the reactor;
adding styrene (STY) monomer or a ring-substituted vinyl aromatic (P) monomer to the reactor;
adding a lithium initiator to the reactor to initiate a reaction; allowing the STY monomer or the P monomer to polymerize, thereby forming a STY block or a P block, respectively;
adding a conjugated diene (CD) monomer and P monomer to the reactor; allowing the CD and P monomers to copolymerize, thereby forming a CD/P copolymer block and a living STY-(CD/P) diblock copolymer or P-(CD/P) diblock copolymer; and
adding P or STY monomer to the reactor and allowing copolymerization to proceed, thereby forming a STY-(CD/P)-P triblock copolymer or a P-(CD/P)-P triblock copolymer or a STY-(CD/P)-STY triblock copolymer. See Example 6 for a particular embodiment.

In one embodiment, the CD monomer is added to the reactor more slowly than the P monomer is added to the reactor for making the CD/P copolymer block, thereby forming a counter-tapered copolymer, wherein counter tapered means that the molar ratio of the CD monomer to P monomer in the CD/P block is lower proximal to the first STY or the first P block relative to the molar ratio of the CD monomer to the P monomer distal to the first STY or the first P block. The polar modifier and the slow addition changes the reaction kinetics and was found to provide an initial higher concentration of units of the P monomer as the CD/P block is formed relative forming the CD/P block without a polar modifier and with a fast charge of the CD monomer.

The CD, the STY and the P monomers form a total monomer addition to the reactor, and preferably the CD monomer addition is from about 40 to about 80 wt % of the total monomer addition, the STY or P monomer addition for the STY or P block, respectively, is from about 10 to about 50 wt % of the total monomer addition, and the P monomer addition for the CD/P copolymer block is from about 1 to about 20 wt % of the total monomer addition.

When STY is used to make an initial block, the CD, the STY and the P monomers form a total monomer addition to the reactor, and preferably the CD monomer addition is from about 50 to about 70 wt % of the total monomer addition, the STY monomer addition is from about 20 to about 40 wt % of the total monomer addition, and the P monomer addition is from about 5 to about 15 wt % of the total monomer addition.

The present invention also provides a process for making a modified diene copolymer (MDC) composition that comprises the steps of:

adding a solvent to a reactor;

adding a polar modifier to the reactor;

adding styrene (STY) monomer or a ring-substituted vinyl aromatic (P) monomer to the reactor;

adding a lithium initiator to the reactor to initiate a reaction; allowing the STY or P monomer to polymerize, thereby forming a STY block or a P block;

adding STY monomer or P monomer and a conjugated diene (CD) monomer to the reactor;

allowing the CD monomer and the STY monomer or the P monomer to copolymerize, thereby forming a [(CD/STY) or a (CD/P)] copolymer block and a living [STY-(CD/STY) or P-(CD/STY) or STY-(CD/P) or P-(CD/P)] diblock copolymer;

adding a coupling agent to the reactor and partially coupling the living [STY-(CD/STY) or P-(CD/STY) or STY-(CD/P) or P-(CD/P)] diblock copolymer, thereby forming a mixture of the living [STY-(CD/STY) or P-(CD/STY) or STY-(CD/P) or P-(CD/P)] diblock copolymer and coupled [STY-(CD/STY)]ₙ-X or [P-(CD/STY)]ₙ-X or [STY-(CD/P)]ₙ-X or [P-(CD/P)]ₙ-X copolymer, where X is a residual moiety from the coupling agent; and

adding P monomer to the reactor and allowing copolymerization to proceed, thereby forming a mixture of a [STY-(CD/STY)-P or P-(CD/STY)-P or STY-(CD/P)-P or P-(CD/P)-P] triblock copolymer and coupled [STY-(CD/STY)]ₙ-X or [P-(CD/STY)]ₙ-X or [STY-(CD/P)]ₙ-X or [P-(CD/P)]ₙ-X copolymer.

See Example 3 for a particular embodiment, which illustrates that the CD monomer can be added to the reactor more slowly than the STY monomer or the P monomer is added to the reactor in the step of adding STY monomer or P monomer and the conjugated diene (CD) monomer to the reactor to forming a counter-tapered (CD/STY) copolymer block or a counter-tapered (CD/P) copolymer block.

When STY is used to make the initial block, the CD, the STY and the P monomers form a total monomer addition to the reactor, and preferably, the CD monomer addition is from about 55 to about 85 wt % of the total monomer addition, the STY monomer addition is from about 20 to about 30 wt % of the total monomer addition, and the P monomer addition is from about 5 to about 10 wt % of the total monomer addition. More preferably, the CD monomer addition is from about 60 to about 75 wt % of the total monomer addition, the STY monomer addition is from about 10 to about 40 wt % of the total monomer addition, and the P monomer addition is from about 1 to about 15 wt % of the total monomer addition.

The present invention further proves a process for making a modified diene copolymer (MDC) composition that comprises the steps of:

adding a solvent to a reactor;

adding a polar modifier to the reactor;

adding styrene (STY) monomer or a ring-substituted vinyl aromatic (P) monomer to the reactor;

adding a lithium initiator to the reactor to initiate a reaction;

allowing the STY or P monomer to polymerize, thereby forming a STY block or a P block;

adding a conjugated diene (CD) monomer to the reactor;

allowing the CD monomer to polymerize, thereby forming a CD polymer block and a living [STY-CD or P-CD] diblock copolymer;

adding a coupling agent to the reactor and partially coupling the living [STY-CD or P-CD] diblock copolymer, thereby forming a mixture of the living [STY-CD or P-CD] diblock copolymer and coupled [(STY-CD)ₙ-X or (P-CD)ₙ-X] copolymer, where X is a residual moiety from the coupling agent; and

adding P monomer to the reactor and allowing copolymerization to proceed, thereby forming a mixture of a [STY-CD-P or P-CD-P] triblock copolymer and coupled [(STY-CD)ₙ-X or (P-CD)ₙ-X] copolymer.

When STY monomer is used to make the initial block, the CD, the STY and the P monomers form a total monomer addition to the reactor, and preferably, the CD monomer addition is from about 40 to about 60 wt % of the total monomer addition, the STY monomer addition is from about 30 to about 50 wt % of the total monomer addition, and the P monomer addition is from about 1 to about 20 wt % of the total monomer addition. More preferably when STY monomer is used to make the initial block, the CD monomer addition is from about 45 to about 55 wt % of the total monomer addition, the STY monomer addition is from about 35 to about 45 wt % of the total monomer addition, and the P monomer addition is from about 5 to about 15 wt % of the total monomer addition. Example 5 provides a particular example.

P is preferably selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene for all of the processes described above, more preferably p-methylstyrene or p-tertbutylstyrene. The examples were carried out using p-methylstyrene. The CD monomer is preferably a butadiene or isoprene for all of the processes described above.

### BRIEF DESCRIPTION OF THE DRAWINGS

FIG. 1A depicts the monomer distributions [pMS], [S], and [B] along the modified C-B-A copolymer chain for each copolymer block or segment of inventive modified diene copolymer MDC A.

FIG. 1 depicts the Effect of p-MethylStyrene Concentration in Modified Diene Copolymers MDC 1-9 on Brookfield Viscosities and Softening Temperatures of Hot Melt Pressure Sensitive Adhesives.

FIG. 2 depicts the Effect of Temperature on Brookfield Viscosities of Hot Melt Pressure Sensitive Adhesives with increasing p-MethylStyrene Concentration in Modified Diene Copolymers MDC 1-9.

FIG. 3 depicts the Viscoelastic Spectrum (G*) of Hot Melt Pressure Sensitive Adhesives with Modified Diene Copolymers MDC 10-13 by DMA @ 10 rad/s and 3° C./min.

FIG. 4 depicts the Viscoelastic Spectrum (Tan delta) of Hot Melt Pressure Sensitive Adhesives with Modified Diene Copolymers MDC 10-13 by DMA @ 10 rad/s and 3° C./min.

FIG. 5 depicts the Effect of p-MethylStyrene Concentration in Modified Diene Copolymers MDC 10-13 on Reinforcement Performance of Hot Melt Pressure Sensitive Adhesives.

FIG. 6 depicts the Effect of p-MethylStyrene Concentration in Modified Diene Copolymers MDC 1-9 on Brookfield Viscosities and Softening Temperatures of Polymer Modified Asphalt @ 3 wt %.

FIG. 7 depicts the Effect of p-MethylStyrene Concentration in Modified Diene Copolymers MDC 1-9 on Reinforcement Performance of Polymer Modified Asphalt @ 3 wt %.

FIG. 8 depicts the Effect of p-MethylStyrene Concentration in Modified Diene Copolymers MDC 10-13 on Reinforcement Performance of Polymer Modified Asphalt @ 8 wt %.

FIG. 9 depicts the Effect of p-MethylStyrene Concentration in Modified Diene Copolymers MDC 1-9 on Reinforcement Performance of Polymer Modified Asphalt @ 11 wt %.

### DETAILED DESCRIPTION OF THE PREFERRED EMBODIMENTS

The present invention provides modified diene copolymer compositions, methods for producing the modified diene copolymer compositions, polymer blends and mixtures containing the modified diene copolymers, reinforced materials containing either the modified diene copolymer compositions or the polymer blends and mixtures containing the modified diene copolymers, and articles made from the reinforced materials. All documents cited herein are incorporated in their entireties by reference.

One aspect of the invention provides novel modified diene copolymer compositions, comprising: a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be modified with at least one unit of at least one substituted vinyl aromatic monomer.

The present invention provides novel modified diene copolymer compositions, comprising: a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be in-chain modified with at least one unit of at least one substituted vinyl aromatic monomer along the chain to tailor compatibility and/or increase processability.

The present invention provides novel modified diene copolymer compositions, comprising: a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be chain-end modified with at least one unit of at least one substituted vinyl aromatic monomer and/or with at least one functionalizing agent to provide terminal reactive sites available for further modification.

The present invention provides novel modified diene copolymer compositions, comprising: a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein at least one unit of at least one substituted vinyl aromatic monomer in any of the homopolymers or the copolymers provide the novel modified diene copolymer compositions with moieties that are available for crosslinking.

The present invention provides novel modified diene copolymer compositions, comprising: a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, wherein any of the homopolymers or the copolymers comprising at least one conjugated diene monomer and/or at least one unsubstituted vinyl aromatic monomer may be modified with at least one unit of at least one substituted vinyl aromatic monomer, wherein any of the homopolymers or the copolymers comprising at least one conjugated diene monomer and/or at least one unsubstituted vinyl aromatic monomer may be in-chain modified with at least one unit of at least one substituted vinyl aromatic monomer along the chain to tailor compatibility and/or increase processability, wherein any of the homopolymers or the copolymers comprising at least one conjugated diene monomer and/or at least one unsubstituted vinyl aromatic monomer may be chain-end modified with at least one unit of at least one substituted vinyl aromatic monomer and/or with at least one functionalizing agent to provide terminal reactive sites available for further modification, and wherein at least one unit of at least one substituted vinyl aromatic monomer in any of the homopolymers or the copolymers provide the novel modified diene copolymer compositions with moieties that are available for crosslinking.

In addition, the present invention provides novel modified diene copolymer compositions, comprising:

a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be modified with at least one unit of at least one substituted vinyl aromatic monomer; and

a block copolymer made from the modified A-B-C or C-B-A copolymer with a multifunctional initiator and/or a coupling agent and/or a linking agent, and wherein the block copolymer comprises at least two of the modified A-B-C or C-B-A copolymers, or at least two of the modified A-B or C-B copolymers;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking.

Additionally, the present invention provides novel modified diene copolymer compositions, comprising:

a block copolymer comprising a modified A-B-C or C-B-A copolymer made with a multifunctional initiator and/or a coupling agent and/or a linking agent, and wherein the block copolymer comprises at least two of the modified A-B-C or C-B-A copolymers, or at least two of the modified A-B or C-B copolymers;

wherein the modified A-B-C or C-B-A copolymers comprise at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be modified with at least one unit of at least one substituted vinyl aromatic monomer;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking.

Furthermore, the present invention provides novel modified diene copolymer compositions, comprising:

a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, wherein any of the copolymers have a distribution configuration that is tapered, counter tapered, random or controlled, and wherein any of the homopolymers or the copolymers comprising at least one conjugated diene monomer and/or at least one unsubstituted vinyl aromatic monomer may be modified with at least one unit of at least one substituted vinyl aromatic monomer; and/or

a block copolymer made from the modified A-B-C or C-B-A copolymer with a multifunctional initiator and/or a coupling agent and/or a linking agent, and wherein the block copolymer comprises at least two of the modified A-B-C or C-B-A copolymers, or at least two of the modified A-B or C-B copolymers;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking;

wherein the novel modified diene copolymer compositions achieve a tailored compatibility and reactivity, and an improved balance between processability and reinforcement performance for various applications such as adhesives, sealants, coatings, tires, plastic modification, and asphalt/bitumen modification and their emulsions for road paving, roofing, shingles and waterproofing membranes, wherein the novel modified diene copolymer compositions are useful for pressure and non-pressure sensitive, hot melt and solvent based formulations for taping, labeling, packaging, construction and positioning adhesive end-use applications, wherein the novel modified diene copolymer compositions are useful for low viscosity and reactive hot-melt adhesive compositions, particularly for sprayable and contact adhesives with high heat resistance, low energy processability, and low emission of volatile organic compounds (VOCs) relative to solvent-based formulations, and wherein more specifically, the novel modified diene copolymer compositions provide the above mentioned applications with: tailored compatibility with formulation ingredients, reactive sites susceptible to modification, and cross-linkable moieties that allow photo-, thermal- and chemical-cured crosslinking; easy processing advantages such as short dispersion time, low mixing temperature, low viscosity, low VOC level, and excellent storage stability; and good reinforcement advantages such as high heat resistance, high cohesive strength and shear resistance, high tack and peel resistance, high elastic response, wide range of performance grade, high ductility and penetration, good compromise between high and low temperature properties, and self-healing behavior.

Another aspect of the present invention provides a process for making a modified diene copolymer composition comprising:

forming a modified A-B-C or C-B-A copolymer comprising reacting at least one conjugated diene monomer and at least one unsubstituted vinyl aromatic monomer and at least one substituted vinyl aromatic monomer under living polymerization conditions either in the presence or the absence of suitable polar modifier and/or co-initiator and/or co-catalyst;

wherein reacting each block or segment in the modified A-B-C or C-B-A copolymer comprises the use of at least one conjugated diene monomer and/or at least one unsubstituted vinyl aromatic monomer and/or at least one substituted vinyl aromatic monomer to form either a homopolymer or a copolymer, wherein any of the copolymers have a distribution configuration that is tapered, counter tapered, random or controlled, wherein the homopolymers and the copolymers are either formed by an initial and/or a simultaneous addition to the reactor of all the monomers in the modified A-B-C or C-B-A copolymer, or formed by a sequential addition to the reactor of the corresponding monomers for each block or segment in the modified A-B-C or C-B-A copolymer;

wherein modifying any of the homopolymers or the copolymers comprising at least one conjugated diene monomer and/or at least one unsubstituted vinyl aromatic monomer with at least one unit of at least one substituted vinyl aromatic monomer may be either controlled by intermittent addition or dosing to the reactor of the at least one substituted vinyl aromatic monomer or controlled by initial, simultaneous or sequential addition to the reactor of the at least one substituted vinyl aromatic monomer and the corresponding monomers for each block or segment in the modified A-B-C or C-B-A copolymer;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking.

In addition, the present invention provides a process for making a modified diene copolymer composition comprising:

forming a modified A-B-C or C-B-A copolymer comprising reacting at least one conjugated diene monomer and at least one unsubstituted vinyl aromatic monomer and at least one substituted vinyl aromatic monomer under living polymerization conditions either in the presence or the absence of suitable polar modifier and/or co-initiator and/or co-catalyst; and

forming a block copolymer made from the modified A-B-C or C-B-A copolymer initiating polymerization totally or partially with a multifunctional initiator, and/or terminating polymerization totally or partially with a coupling agent or a functionalizing agent, and/or joining living chains totally or partially with a linking agent, wherein the block copolymer comprises at least two of the modified A-B-C or C-B-A copolymers, wherein optionally the multifunctional initiator is added after a first block or segment A or C is formed in the modified A-B-C or C-B-A copolymer; and wherein optionally the coupling agent and/or the linking agent is added after a second block or segment A-B or C-B is formed in the modified A-B-C or C-B-A copolymer;

wherein reacting each block or segment in the modified A-B-C or C-B-A copolymer comprises the use of at least one conjugated diene monomer and/or at least one unsubstituted vinyl aromatic monomer and/or at least one substituted vinyl aromatic monomer to form either a homopolymer or a copolymer, wherein any of the copolymers have a distribution configuration that is tapered, counter tapered, random or controlled, wherein the homopolymers and the copolymers are either formed by an initial and/or a simultaneous addition to the reactor of all the monomers in the modified A-B-C or C-B-A copolymer, or formed by a sequential addition to the reactor of the corresponding monomers for each block or segment in the modified A-B-C or C-B-A copolymer;

wherein modifying any of the homopolymers or the copolymers comprising at least one conjugated diene monomer and/or at least one unsubstituted vinyl aromatic monomer with at least one unit of at least one substituted vinyl aromatic monomer may be either controlled by intermittent addition or dosing to the reactor of the at least one substituted vinyl aromatic monomer or controlled by initial, simultaneous or sequential addition to the reactor of the at least one substituted vinyl aromatic monomer and the corresponding monomers for each block or segment in the modified A-B-C or C-B-A copolymer;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking.

An additional embodiment of the present invention is a process for making a modified diene copolymer composition comprising:

adding a solvent and an initial monomer mixture comprising at least one conjugated diene monomer and/or at least one unsubstituted vinyl aromatic monomer and/or at least one substituted vinyl aromatic monomer corresponding to either a first A or C block or segment, or a first-second A-B or C-B blocks or segments, or a first-second-third A-B-C or C-B-A blocks or segments of a modified A-B-C or C-B-A copolymer to a reactor to form an initial reaction mixture, optionally adding a polar modifier and/or a co-initiator and/or a co-catalyst, wherein the amount of the polar modifier and/or the co-initiator and/or the co-catalyst in the initial reaction mixture is less than 20 wt %;

adding an initiator compound to the reactor and living polymerizing the initial monomer mixture to form either the corresponding first A block or segment with a peak molecular weight of at least 3 kg/mol and/or a number of monomer units of at least 30, or the corresponding first C block or segment with a peak molecular weight of at most 30 kg/mol and/or a number of monomer units of at most 300, or the corresponding first-second A-B or C-B blocks or segments, or the corresponding first-second-third A-B-C or C-B-A blocks or segments of the modified A-B-C or C-B-A copolymer;

optionally adding a multifunctional initiator after the first A or C block or segment is formed to partially initiate a B block or segment in the modified A-B-C or C-B-A copolymer;

adding a second monomer mixture comprising at least one conjugated diene monomer and/or at least one unsubstituted vinyl aromatic monomer and/or at least one substituted vinyl aromatic monomer to form either the corresponding second B block or segment with a peak molecular weight of at least 3 kg/mol and/or a number of monomer units of at least 30, or the corresponding third C or A block or segment, or the corresponding second-third B-C or B-A blocks or segments of the modified A-B-C or C-B-A copolymer;

optionally adding a coupling agent and/or a linking agent after the second B block or segment is formed to partially couple and/or to link the A-B or C-B blocks or segments in the modified A-B-C or C-B-A copolymer;

adding a third monomer mixture comprising at least one conjugated diene monomer and/or at least one unsubstituted vinyl aromatic monomer and/or at least one substituted vinyl aromatic monomer to form either the corresponding third C block or segment with a peak molecular weight of at most 60 kg/mol and/or a number of monomer units of at most 600, or the corresponding third A block or segment with a peak molecular weight of at least 3 kg/mol and/or a number of monomer units of at least 30, thereby forming the modified A-B-C or C-B-A copolymer with a peak molecular weight from 6 kg/mol to 1,500 kg/mol, wherein any of the copolymers have a distribution configuration that is tapered, counter tapered, random or controlled; and

optionally adding a coupling agent or a combination of coupling agents and/or a functionalization agent to totally or partially couple and/or to functionalize the modified A-B-C or C-B-A copolymer to form a block copolymer comprising at least two of the modified A-B-C or C-B-A copolymers, thereby forming either a linear block or multiblock copolymer, a radial coupled block or multiblock copolymer, a multiarm coupled block or multiblock copolymer, or mixtures thereof;

wherein modifying any of the homopolymers or the copolymers comprising at least one conjugated diene monomer and/or at least one unsubstituted vinyl aromatic monomer with at least one unit of at least one substituted vinyl aromatic monomer may be either controlled by intermittent addition or dosing to the reactor of the at least one substituted vinyl aromatic monomer or controlled by initial, simultaneous or sequential addition to the reactor of the at least one substituted vinyl aromatic monomer and the corresponding monomers for each block or segment in the modified A-B-C or C-B-A copolymer;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer and/or with at least one functionalizing agent to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking.

In some embodiments, novel modified diene copolymer compositions according with the present invention are characterized by:

peak molecular weight of the modified diene copolymer compositions from about 6 kg/mol to about 1,500 kg/mol;

weight average molecular weight of the modified diene copolymer compositions from about 8 kg/mol to about 2,500 kg/mol;

wherein the peak molecular weight of any homopolymer or copolymer block or segment comprising at least one conjugated diene monomer and/or at least one unsubstituted vinyl aromatic monomer in the modified diene copolymer composition is at least about 3.0 kg/mol;

wherein the peak molecular weight of any homopolymer or copolymer block or segment comprising at least one substituted vinyl aromatic monomer, and optionally at least one conjugated diene monomer and/or at least one unsubstituted vinyl aromatic monomer in the modified diene copolymer composition is at most about 60 kg/mol;

wherein the peak molecular weight of at least one substituted vinyl aromatic monomer in at least one homopolymer or copolymer block or segment comprising at least one conjugated diene monomer and/or at least one unsubstituted vinyl aromatic monomer and/or at least one substituted vinyl aromatic monomer in the novel modified diene copolymer compositions is from about 0.1 kg/mol to about 60 kg/mol;

wherein the number of units of at least one substituted vinyl aromatic monomer in at least one homopolymer or copolymer block or segment comprising at least one conjugated diene monomer and/or at least one unsubstituted vinyl aromatic monomer and/or at least one substituted vinyl aromatic monomer in the novel modified diene copolymer compositions is from about 1 unit to about 600 units;

wherein the total content of vinyl aromatic monomer in the modified diene copolymer composition is from about 5 percentage by weight to about 85 percentage by weight; and

wherein the total content of vinyl configuration is from about 5 percentage by weight to about 90 percentage by weight based on the total amount of conjugated diene units in the modified diene copolymer composition.

Other aspect of the present invention provides polymer blends and mixtures containing modified diene copolymers, reinforced materials containing either the modified diene copolymer compositions or the polymer blends and mixtures containing the modified diene copolymers, comprising:

polymer blends or mixtures containing the novel modified diene copolymer compositions of the present invention comprise at least one polymer selected from polar plastics, polar engineering plastics and non-polar plastics; in an additional embodiment, the polymer blends or mixtures containing the novel modified diene copolymer compositions of the present invention comprise at least one commercially available polymer or elastomer selected from: linear, radial, multiarm; tapered, random, block, diblock, triblock or multiblock copolymers, or any combinations thereof, and some examples include but are not limited to SIS, SBS, SEBS, SEPS, SIBS, SI/BS, SEPEBS, SEP/EBS, SBR, SIR, SIBR, SEBR, SEPR, SEPEBR, including counter tapered thermoplastic elastomers such as: (S-S/B), (S-S/B)n-X, (S-S/I), (S-S/I)n-X, (S-S/I/B), (S-S/I/B)n-X; and hybrid polymers with blocks, segments or arms with different sizes, compositions and/or microstructures; in another embodiment of the present invention, the polymer blends or mixtures containing the novel modified diene copolymer compositions of the present invention comprise at least one polymer or copolymer based on: ethylene monomer, substituted ethylene monomers, acrylate and methacrylate monomers, substituted acrylate and methacrylate monomers, acrylonitrile and methacrylonitrile monomers; in other embodiment of the present invention, the polymer blends or mixtures containing the novel modified diene copolymer compositions of the present invention comprise: at least one polymer based on bio-monomers or at least one copolymer based on bio-monomers and/or bio-degradable monomers or at least one copolymer or terpolymer based on a combination of bio-monomers and/or bio-degradable monomers with oil-based monomers; wherein a mixing step may be necessary to provide intimate contact between at least one polymer and the modified diene compositions;

reinforced materials containing either the modified diene copolymer compositions or the polymer blends and mixtures containing the modified diene copolymers achieve a tailored compatibility and reactivity, and an improved balance between processability and reinforcement performance for various applications such as adhesives, sealants, coatings, tires, plastic modification, and asphalt/bitumen modification and their emulsions for road paving, roofing, shingles and waterproofing membranes, wherein the novel modified diene copolymer compositions are useful for pressure and non-pressure sensitive, hot melt and solvent based formulations for taping, labeling, packaging, construction and positioning adhesive end-use applications, wherein the novel modified diene copolymer compositions are useful for low viscosity and reactive hot-melt adhesive compositions, particularly for sprayable and contact adhesives with high heat resistance, low energy processability, and low emission of volatile organic compounds (VOCs) relative to solvent-based formulations, and wherein more specifically, the novel modified diene copolymer compositions provide the above mentioned applications with: tailored compatibility with formulation ingredients, reactive sites susceptible to modification, and cross-linkable moieties that allow photo-, thermal- and chemical-cured crosslinking; easy processing advantages such as short dispersion time, low mixing temperature, low viscosity, low VOC level, and excellent storage stability; and good reinforcement advantages such as high heat resistance, high cohesive strength and shear resistance, high tack and peel resistance, high elastic response, wide range of performance grade, high ductility and penetration, good compromise between high and low temperature properties, and self-healing behavior.

Other additional aspects of the invention provide compositions and articles made from novel modified diene copolymer compositions, reinforced materials made from a mixture of the novel modified diene copolymer compositions or the polymer blends and mixtures containing the modified diene copolymers with a material to be reinforced and articles made from the reinforced materials. Other aspects of the invention provide novel modified diene compositions, and their blends with other block copolymers, with enhanced adhesion to specific substrates and articles made from the adhesion enhanced materials. The novel modified diene compositions achieve a desired balance between compatibility, processability and reinforcement performance for various adhesive, asphalt, sealant, coating, tire and plastic applications. Certain types of modified diene copolymer compositions or the polymer blends and mixtures containing the modified diene copolymers may also be used as reinforcing agents, viscosity modifiers, flow modifiers, processing aids and impact modifiers in rubbers and plastics.

In some additional embodiments, the present invention provides a process for making a modified diene copolymer composition comprising:

forming a modified A-B-C or C-B-A copolymer comprising reacting at least one conjugated diene monomer and at least one unsubstituted vinyl aromatic monomer and at least one substituted vinyl aromatic monomer under living polymerization conditions either in the presence or the absence of suitable polar modifier and/or co-initiator and/or co-catalyst;

wherein the living polymerization conditions are selected from a variety of polymerization techniques including but not limited to examples such as: anionic polymerization, cationic polymerization, ring-opening polymerization, and controlled radical polymerization (CRP) or living radical polymerization (LRP) including but not limited to nitroxide mediated polymerization (NMP), atom transfer radical polymerization (ATRP), and reversible addition-fragmentation chain transfer (RAFT) polymerization;

wherein the living polymerization techniques not only allow control of the architecture, molecular weight, and molecular weight distribution, but also are versatile on the type of monomers amenable to polymerization including but not limited to examples such as: t-butyl methacrylate, e-caprolactone, isobutylene, ethylene, acrylates, methacrylates, acrylonitrile, methacrylonitrile, etc.; substituted and/or functionalized versions; and mixtures thereof;

wherein reacting each block or segment in the modified A-B-C or C-B-A copolymer comprises the use of at least one conjugated diene monomer and/or at least one unsubstituted vinyl aromatic monomer and/or at least one substituted vinyl aromatic monomer and/or at least one other monomer amenable to polymerization by any of the living polymerization techniques to form either a homopolymer or a copolymer, wherein any of the copolymers have a distribution configuration that is tapered, counter tapered, random or controlled, wherein the homopolymers and the copolymers are either formed by an initial and/or a simultaneous addition to the reactor of all the monomers in the modified A-B-C or C-B-A copolymer, or formed by a sequential addition to the reactor of the corresponding monomers for each block or segment in the modified A-B-C or C-B-A copolymer;

wherein modifying any of the homopolymers or the copolymers comprising at least one conjugated diene monomer and/or at least one unsubstituted vinyl aromatic monomer with at least one unit of at least one substituted vinyl aromatic monomer or at least one unit of at least one other monomer amenable to polymerization by any of the living polymerization techniques may be either controlled by intermittent addition or dosing to the reactor of the at least one substituted vinyl aromatic monomer or controlled by initial, simultaneous or sequential addition to the reactor of the at least one substituted vinyl aromatic monomer or the at least one other monomer amenable to polymerization by any of the living polymerization techniques, and the corresponding monomers for each block or segment in the modified A-B-C or C-B-A copolymer;

wherein any of the homopolymers or the copolymers comprising at least one conjugated diene monomer and/or at least one unsubstituted vinyl aromatic monomer may be either in-chain modified with at least one unit of at least one substituted vinyl aromatic monomer or at least one unit of at least one other monomer amenable to polymerization by any of the living polymerization techniques along the chain to tailor compatibility and/or increase processability or chain-end modified with at least one unit of at least one substituted vinyl aromatic monomer or at least one unit of at least one other monomer amenable to polymerization by any of the living polymerization techniques to provide terminal reactive sites available for further modification, or both, and wherein at least one unit of at least one substituted vinyl aromatic monomer or at least one unit of at least one other monomer amenable to polymerization by any of the living polymerization techniques in any of the homopolymers or the copolymers provide the novel modified diene copolymer compositions with moieties that are available for crosslinking.

Preferably, the present invention provides novel modified diene copolymer compositions prepared by using known living anionic polymerization techniques in the absence of polar modifiers or additives. Typical alkyllithium-initiated copolymerization of conjugated diene and monovinyl aromatic monomers in hydrocarbon solvents, in the absence of polar modifiers or additives, yields an interesting type of structure with compositional heterogeneity along the copolymer chain, which is commonly known as tapered, gradual or gradient diblock copolymer structure. Relatively large differences between monomer reactivity ratios (i.e., r1>10 and r2<0.1) are observed despite the similar stabilities of the carbanionic chain ends corresponding to the conjugated diene (1) and monovinyl aromatic (2) monomers. Contrary to the observed faster homopolymerization of monovinyl aromatic monomers relative to conjugated diene monomers, in the initial stage of copolymerization the less reactive conjugated diene monomer is preferentially incorporated into the copolymer chain until it is nearly exhausted, forming a diene-rich, tapered block B with gradual change in composition, and then in the final stage most of the monovinyl aromatic monomer forms a terminal block A.

B-(B/A)-A

Furthermore, during copolymerization in hydrocarbon solvents and in the absence of polar additives, a distinct intermediate stage occurs that forms a small, sharp and steep interphase -(B/A)- with sudden change in composition, which acts as a transition within the copolymer chain between two large A and B blocks. Lower melt viscosities of tapered diblock copolymers relative to pure diblock copolymers, with the same composition and molecular weight, are ascribed to the presence of this small interphase, which weakens the intrachain and interchain repulsion and enhances mixing between dissimilar adjacent blocks. Since alkyllithium-initiated copolymerization of conjugated diene and monovinyl aromatic monomers under the above conditions behaves statistically with a tendency toward random placement of the monomeric units (i.e., r1r2˜0.5) mainly due to the large difference in monomer reactivity ratios, both the block B and the interphase -(B/A)- have a compositional drift along the copolymer chain that is directly dependent on the instantaneous relative monomer concentration. Therefore, the initial relatively small concentration of monovinyl aromatic monomer is incorporated into the diene-rich, tapered block B almost randomly and predominantly as isolated aromatic units. On the contrary, the intermediate relatively large concentration of monovinyl aromatic monomer is incorporated into the small, sharp and steep interphase -(B/A)- statistically and predominantly as long aromatic sequences that should rapidly become aromatic-rich segments with residual isolated diene units.

The present invention provides novel modified diene copolymer compositions based on an unexpected and surprising kinetic behavior of the alkyllithium-initiated polymerization comprising reacting at least one conjugated diene monomer and at least one unsubstituted vinyl aromatic monomer and at least one substituted vinyl aromatic monomer; wherein in a preferred embodiment of the present invention, relative monomer reactivity ratios for polymerization of butadiene (1), styrene (2) and p-methylstyrene (3) in hydrocarbon solvent and the absence of polar modifiers were calculated to be r1=18.8, r2=0.5 y r3=0.07; wherein based on the relative monomer reactivity ratios, a tapered (butadiene/styrene/p-methylstyrene) gradual block structure with small, sharp and steep interphases first between -(butadiene/styrene)- and then between -(styrene/p-methylstyrene)- was expected; wherein the unexpected and surprising kinetic behavior is that p-methylstyrene (pMS) begins incorporation into the polymer chain from the start of the polymerization and copolymerizes only with butadiene (BD or B) to form a first C block or segment, [butadiene/p-methylstyrene] or [BD/pMS] or [B/pMS], even before styrene (STY or S) begins incorporation into the copolymer chain, then a very broad and enlarged interphase forms a second B block or segment, -[butadiene/p-methylstyrene/styrene]- or -[BD/pMS/STY]- or -[B/pMS/S]-, that is a terpolymer composition not only rich in butadiene but also with higher p-methylstyrene than styrene incorporation, after butadiene monomer is depleted then incorporation of styrene increases and a styrene-rich copolymer with p-methylstyrene forms a third A block or segment, [styrene/p-methylstyrene-p-methylstyrene] or [STY/pMS-pMS] or [S/pMS-pMS], with a small number of terminal p-methylstyrene monomer units that slowly incorporates into the polymer chain after styrene monomer is exhausted, wherein the copolymer blocks or segments in the modified C-B-A copolymer have a distribution configuration that is tapered.

C-B-A

or

[BD/pMS]-[BD/pMS/STY]-[STY/pMS-pMS]

or

[B/pMS]-[B/pMS/S]-[S/pMS-pMS]

Preferably, the present invention provides novel modified diene copolymer compositions comprising:

a modified A-B-C or C-B-A copolymer that incorporates novel microstructure and composition characteristics derived from the unexpected and surprising kinetic behavior of the alkyllithium-initiated living anionic polymerization comprising reacting in hydrocarbon solvent and the absence of polar modifier at least one conjugated diene monomer and at least one unsubstituted vinyl aromatic monomer and at least one substituted vinyl aromatic monomer;

wherein the novel microstructure and composition characteristics include a first C block or segment comprising at least one conjugated diene monomer (CD) and at least one substituted vinyl aromatic monomer (SVA); then a second B block or segment comprising at least one conjugated diene monomer and at least one substituted vinyl aromatic monomer and at least one unsubstituted vinyl aromatic monomer (UVA); and a third A block or segment comprising at least one unsubstituted vinyl aromatic monomer and at least one substituted vinyl aromatic monomer; wherein the A block or segment is chain-end modified with a small number of terminal monomer units comprising at least one substituted vinyl aromatic monomer; wherein the copolymer blocks or segments in the modified C-B-A copolymer have a distribution configuration that is tapered;

C-B-A

or

[CD/SVA]-[CD/SVA/UVA]-[UVA/SVA-SVA]

wherein any homopolymer or copolymer comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking;

wherein the novel microstructure and composition characteristics contribute in minimizing repulsion and maximizing compatibility within the modified A-B-C or C-B-A copolymer, which may promote interfacial mixing and improve toughness and fracture strength,

wherein the novel microstructure and composition characteristics in the modified A-B-C or C-B-A copolymer provide increased processability and low viscosity to the novel modified diene copolymer compositions;

wherein the novel microstructure and composition characteristics in the modified A-B-C or C-B-A copolymer improve compatibility, processability and reinforcement performance for various adhesive, asphalt, sealant, coating, tire and plastic applications; and

wherein the novel modified diene copolymer compositions of the present invention provide the various applications with: tailored compatibility with formulation ingredients, reactive sites susceptible to modification, and cross-linkable moieties that allow photo-, thermal- and chemical-cured crosslinking.

In addition, the present invention provides novel modified diene copolymer compositions prepared by using known living anionic polymerization techniques in hydrocarbon solvent and the presence of at least one polar modifier or additive. Typical copolymerization of conjugated diene and monovinyl aromatic monomers with alkyllithium in hydrocarbon solvent and the absence of polar modifiers or additives typically results in tapered diblock copolymers with low vinyl configuration content (1,2-addition diene microstructure). It is known that polar modifiers or additives simultaneously act as randomizing agents and microstructure modifiers during the copolymerization of conjugated diene and monovinyl aromatic monomers with alkyllithium initiators. The relatively large differences between monomer reactivity ratios decrease with increasing polar additive concentration, which gradually changes the copolymerization behavior from statistical to random, and transform the monomer sequence length distribution from tapered diblock to random diblock and then to a completely random copolymer structure. This randomization effect is typically accompanied by a corresponding microstructure modification effect that increases the vinyl configuration content. Although both effects are directly dependent on polar modifier or additive concentration, and moreover the modification effect is counterly dependent on polymerization temperature, the extent and specific behavior of each effect is particularly dependent on polar additive type and specific properties. It is possible to combine polar modifiers or additives to overcome some handicaps and obtain synergistic or desired differentiated effects on monomer sequence length distribution and/or 1,2-diene microstructure.

In another embodiment, the present invention provides novel modified diene copolymer compositions comprising:

a modified A-B-C or C-B-A copolymer that incorporates novel microstructure and composition characteristics derived from the unexpected and surprising kinetic behavior of the alkyllithium-initiated living anionic polymerization comprising reacting, in hydrocarbon solvent and the presence of at least one polar modifier, at least one conjugated diene monomer and at least one unsubstituted vinyl aromatic monomer and at least one substituted vinyl aromatic monomer;

wherein the novel microstructure and composition characteristics include a first C block or segment comprising at least one conjugated diene monomer and at least one substituted vinyl aromatic monomer; then a second B block or segment comprising at least one conjugated diene monomer and at least one substituted vinyl aromatic monomer and at least one unsubstituted vinyl aromatic monomer; and a third A block or segment comprising at least one unsubstituted vinyl aromatic monomer and at least one substituted vinyl aromatic monomer; wherein the A block or segment is chain-end modified with a small number of terminal monomer units comprising at least one substituted vinyl aromatic monomer; wherein the copolymer blocks or segments in the modified C-B-A copolymer have a distribution configuration that is tapered and/or random, with an increased incorporation of the at least one substituted vinyl aromatic monomer and the at least one unsubstituted vinyl aromatic monomer into the C and B blocks or segments;

wherein any homopolymer or copolymer comprising at least one conjugated diene monomer and/or at least one unsubstituted vinyl aromatic monomer may be either in-chain modified with at least one unit of at least one substituted vinyl aromatic monomer along the chain to tailor compatibility and/or increase processability or chain-end modified with at least one unit of at least one substituted vinyl aromatic monomer to provide terminal reactive sites available for further modification, or both, and wherein at least one unit of at least one substituted vinyl aromatic monomer in any of the homopolymers or the copolymers provide the novel modified diene copolymer compositions with moieties that are available for crosslinking;

wherein increasing the polar modifier concentration gradually changes polymerization behavior from statistical to random, and transform monomer sequence length distribution from tapered block to random block and then to a completely random terpolymer structure; and wherein the randomization effect is accompanied by a corresponding microstructure modification effect that increases the vinyl configuration of the polymerized conjugated diene monomer units;

wherein the homopolymers and/or the copolymers blocks or segments in the modified A-B-C or C-B-A copolymer comprising at least one conjugated diene monomer and/or at least one unsubstituted vinyl aromatic monomer are polymerized in the presence of increasing amount of the at least one polar modifier, the homopolymers and/or the copolymers blocks or segments may be modified with increasing number of monomer units comprising at least one substituted vinyl aromatic monomer; and

wherein the novel modified diene copolymer compositions of the present invention provide various applications such as adhesive, asphalt, sealant, coating, tire and plastic applications with increasing: tailored compatibility with formulation ingredients, reactive sites susceptible to modification, and cross-linkable moieties that allow photo-, thermal- and chemical-cured crosslinking.

In another embodiment, the present invention provides novel modified diene copolymer compositions comprising:

a modified A-B-C or C-B-A copolymer comprising at least one conjugated diene monomer and at least one unsubstituted vinyl aromatic monomer and at least one substituted vinyl aromatic monomer, wherein each block or segment in the modified A-B-C or C-B-A copolymer is either a homopolymer or a copolymer comprising at least one conjugated diene monomer and/or at least one unsubstituted vinyl aromatic monomer and/or at least one substituted vinyl aromatic monomer, and wherein any of the homopolymers or the copolymers comprising at least one conjugated diene monomer and/or at least one unsubstituted vinyl aromatic monomer may be modified with at least one unit of at least one substituted vinyl aromatic monomer;

wherein the modified A-B-C or C-B-A copolymer may comprise at least one counter tapered or at least one controlled distribution copolymer block or segment with gradual change in both composition and vinyl diene microstructure comprising at least one conjugated diene monomer and/or at least one unsubstituted vinyl aromatic monomer and/or at least one substituted vinyl aromatic monomer; wherein the at least one counter tapered or the at least one controlled distribution copolymer block or segment may be prepared as described in US Patent Application 2017/0210841 A1 or in US Patent Application US 2003/0176582 A1, which are incorporated herein by reference, in the presence of at least one polar modifier, by adding the at least one conjugated diene monomer at a controlled feed rate to the polymerization mixture while the at least one unsubstituted vinyl aromatic monomer and/or the at least one substituted vinyl aromatic monomer are being polymerized; wherein the dosification to the reactor of the at least one conjugated diene monomer at a predetermined dose rate for a predetermined time is performed in such a way as to control the instantaneous relative monomer concentration; and wherein this polymerization step is allowed to proceed in either isothermal mode for a pre-established residence time or quasi-adiabatic mode up to a peak temperature;

wherein the modified A-B-C or C-B-A copolymer comprises at least one terminal homopolymer or copolymer block or segment comprising at least one conjugated diene monomer and/or at least one unsubstituted vinyl aromatic monomer and/or at least one substituted vinyl aromatic monomer;

wherein optionally a coupling agent and/or a linking agent is added after the second B block or segment is formed to partially couple and/or to link at least two of the A-B or C-B blocks or segments in the modified A-B-C or C-B-A copolymer and before forming the at least one terminal homopolymer or copolymer C or A block or segment comprising at least one conjugated diene monomer and/or at least one unsubstituted vinyl aromatic monomer and/or at least one substituted vinyl aromatic monomer; and

wherein the at least one terminal homopolymer or copolymer block or segment comprising at least one conjugated diene monomer and/or at least one unsubstituted vinyl aromatic monomer and/or at least one substituted vinyl aromatic monomer provides various applications such as adhesive, asphalt, sealant, coating, tire and plastic applications with: tailored compatibility with formulation ingredients, reactive sites susceptible to modification, and cross-linkable moieties that allow photo-, thermal- and chemical-cured crosslinking.

Throughout this disclosure, the molecular weights cited are measured using gel permeation chromatography under ASTM D 3536 with linear polystyrene standards. All molecular weights (Mp and Mw) are given in units of 1000 (k) (i.e., kg/mol) and calculated relative to polystyrene standards by GPC. Also, the composition and microstructure are measured by nuclear magnetic resonance using deuterated chloroform. The blocking vinyl aromatic characterization is performed via degradative oxidation with osmium tetroxide. The novel modified diene copolymer compositions of the present invention are characterized by peak molecular weights of from about 6 kg/mol to about 1,500 kg/mol, preferably from about 6 kg/mol to about 1,000 kg/mol, and more preferably from about 6 kg/mol to about 500 kg/mol. In some embodiments of the present invention, weight average molecular weights of the novel modified diene copolymer compositions are from about 8 kg/mol to about 2,500 kg/mol, preferably from about 8 kg/mol to about 2,000 kg/mol, and more preferably from about 8 kg/mol to about 1,500 kg/mol. In other embodiments, the peak molecular weight of any homopolymer or copolymer block or segment comprising at least one conjugated diene monomer and/or at least one unsubstituted vinyl aromatic monomer in the modified diene copolymer composition is at least about 3.0 kg/mol, preferably at least about 6.0 kg/mol, and more preferably at least about 8.0 kg/mol. In some other embodiments, the peak molecular weight of any homopolymer or copolymer block or segment comprising at least one substituted vinyl aromatic monomer, and optionally at least one conjugated diene monomer and/or at least one unsubstituted vinyl aromatic monomer in the modified diene copolymer composition is at most about 60 kg/mol, preferably at most about 45 kg/mol, and more preferably at most about 30 kg/mol. In additional embodiments of the present invention, the peak molecular weight of at least one substituted vinyl aromatic monomer in at least one homopolymer or copolymer block or segment comprising at least one conjugated diene monomer and/or at least one unsubstituted vinyl aromatic monomer and/or at least one substituted vinyl aromatic monomer in the novel modified diene copolymer compositions is from about 0.1 kg/mol to about 60 kg/mol, preferably from about 1.5 kg/mol to about 45 kg/mol, and more preferably from about 3.0 kg/mol to about 30 kg/mol. In other additional embodiments of the present invention, the number of units of at least one substituted vinyl aromatic monomer in at least one homopolymer or copolymer block or segment comprising at least one conjugated diene monomer and/or at least one unsubstituted vinyl aromatic monomer and/or at least one substituted vinyl aromatic monomer in the novel modified diene copolymer compositions is from about 1 unit to about 600 units, preferably from about 15 unit to about 450 units, and more preferably from about 30 unit to about 300 units. In further embodiments, the total content of vinyl aromatic monomer in the novel modified diene copolymer compositions preferably ranges from about 5 to about 85 percentage by weight, more preferably from about 5 to about 70 percentage by weight, and even more preferably from about 5 to 55 percentage by weight. Furthermore, the total content of vinyl configuration preferably ranges from about 5 to about 90 percentage by weight, more preferably from about 5 to about 75 percentage by weight, and even more preferably from about 5 to 60 percentage by weight, based on the total amount of conjugated diene units in the novel modified diene copolymer compositions. The present invention is not limited to modified diene copolymer compositions falling within the preferred molecular weight, composition and vinyl configuration ranges.

Examples of modified diene copolymer compositions that may be made from anionically polymerizable monomers include, but are not limited to, tapered, random, counter tapered, controlled distribution, block, multiblock, linear, radial, multiarm, miktoarm or hybrid elastomers and thermoplastic elastomers made from homopolymer and/or copolymers and/or terpolymers blocks or segments of an unsubstituted vinyl aromatic monomer such as styrene (S), a substituted vinyl aromatic monomer such as p-methylstyrene (pMS), and a conjugated diene monomer such as butadiene and/or isoprene (D) of varying composition, microstructure, sizes and number of blocks, including symmetric or assymetric blocks in any of such characteristics, mixtures and combinations thereof. Examples of such elastomers and thermoplastic elastomers include but are not limited to: D/pMS-[D/S/pMS]m-S/pMS; (D/pMS-[D/S/pMS]m-S/pMS)n-X; X-(D/pMS-[D/S/pMS]m-S/pMS)n; (D/pMS-[D/S/pMS]m)n-X-(S/pMS)n; S-[S/D]m-pMS; (S-[S/D]m-pMS)n-X; (S-[S/D]m)n-X-(pMS)n; (S-[S/D]m)n-X-(D/pMS)n; S-D-pMS; (S-D-pMS)n-X; (S-D)n-X-(pMS)n; (S-D)n-X-(D/pMS)n; pMS-[pMS/D]m-S; (pMS-[pMS/D]m-S)n-X; (pMS-[pMS/D]m)n-X-(S)n; (pMS-[pMS/D]m)n-X-(D/S)n; pMS-D-S; (pMS-D-S)n-X; (pMS-D)n-X-(S)n; (pMS-D)n-X-(D/S)n; D/pMS-D-S/pMS; (D/pMS-D-S/pMS)n-X; (D/pMS-D)n-X-(S/pMS)n; (D/pMS-D)n-X-(D-S/pMS)n; S/pMS-D-D/pMS; (S/pMS-D-D/pMS)n-X; (S/pMS-D)n-X-(D/pMS)n; (S/pMS-D)n-X-(D-D/pMS)n; D/pMS-D-D/pMS; (D/pMS-D-D/pMS)n-X; (D/pMS-D)n-X-(D/pMS)n; (D/pMS-D)n-X-(D-D/pMS)n; (D/pMS-D)n-X-(D)n; (D)n-X-(D-D/pMS)n; (S/pMS-D)n-X-(D)n; (D)n-X-(D-S/pMS)n; (pMS-D)n-X-(D)n; (D)n-X-(D-pMS)n; (pMS-D)n-X-(D/S-S)n; (pMS-D)n-X-(D/S-S)n; and mixtures thereof; wherein m is an integer equal or greater than 1; and wherein X is the residue of either a coupling agent or a linking agent or a multifunctional initiator and n is an integer from 2 to about 30; as well as functionalized and derivatized versions, including their hydrogenated, selectively hydrogenated, and/or partially hydrogenated counterparts.

The novel modified diene copolymer compositions may be polymer blends (a) obtained in situ by partial coupling and/or partial linking and/or by partial multi-initiation of modified A-B-C or C-B-A copolymers, prepared with a coupling agent and/or a linking agent and/or a multifunctional initiator in a first reactor; or may be multiarm, branched, radial or linear polymers (b) obtained by total coupling, total linking and/or total multi-initiation of modified A-B-C or C-B-A copolymers in a first reactor; or may be modified A-B-C or C-B-A copolymers (c) polymerized in a first reactor; and may be polymer blends (d) similar to (a) prepared by mixing (b) and (c) at a desired ratio in a second reactor. The modified diene copolymer compositions may be blends prepared in situ by adding to the reactor a suitable amount of a coupling agent or a linking agent at the end of polymerization of any of the homopolymer or copolymer blocks or segments in the modified A-B-C or C-B-A copolymers of the present invention and form a desired coupled or linked intermolecularly different structure: (A-B-C)n-X or (C-B-A)n-X; (A-B)n-X or (C-B)n-X; (A)n-X or (C)n-X; which may be linear, radial, branched and/or multiarm block copolymers. The partial coupling or linking is achieved by controlling the stoichiometric ratio of coupling or linking agent to living polymer. The coupling agents terminate the living polymer chains by attaching a coupling residue X. The linking agents join the living polymer chains and allow further polymerization from the linking residue X of similar or intramolecularly different polymer chains (i.e., miktoarm or hybrid): (A-B)n-X-(C)n or (C-B)n-X-(A)n; (A)n-X-(B-C)n or (C)n-X-(B-A)n; which may be linear, radial, branched and/or multiarm block copolymers. The modified diene copolymer compositions may also be blends prepared in situ by using a suitable multifunctional initiator combined with the typical monofunctional initiator, such as an alkyllithium, to initiate the polymerization of any of the homopolymer or copolymer blocks or segments in the modified A-B-C or C-B-A copolymers of the present invention and form a desired multi-initiated intermolecularly different structure: X-(A-B-C)n or X-(C-B-A)n; X-(A-B)n or X-(C-B)n; X-(A)n or X-(C)n; which may be linear, radial, branched and/or multiarm block copolymers. The partial initiation is achieved by controlling the stoichiometric ratio of multifunctional initiator to monofunctional initiator. The multifunctional initiator initiates the living polymer chains and allow further polymerization of multiple living polymer chains from the initiating residue X. The linear, radial, branched and multiarm modified (A-B-C)n-X or (C-B-A)n-X; X-(A-B-C)n or X-(C-B-A)n copolymers of the novel modified diene copolymer compositions may have from 2 to 30 anionically polymerized polymers chains (n=number of arms) per multifunctional initiator or coupling agent or linking agent molecule; or may be a polydisperse mixture from about 2 to about 60 of anionically polymerized polymer chains (n=average number of arms) or up to about the degree of functionality and/or polydispersity of the multifunctional initiator, the coupling agent or the linking agent. The modified A-B-C or C-B-A copolymer may have a peak molecular weight from about 6 kg/mol to about 1,500 kg/mol. The novel modified diene copolymer compositions may be polymer blends having preferably a weight average molecular weight from about 8 kg/mol to 2,500 kg/mol. In some embodiments of the present invention, the total content of vinyl aromatic monomer in the novel modified diene copolymer compositions preferably ranges from about 5 to about 85 percentage by weight, more preferably from about 5 to about 70 percentage by weight, and even more preferably from about 5 to 55 percentage by weight. In other embodiments of the present invention, the total content of vinyl configuration preferably ranges from about 5 to about 90 percentage by weight, more preferably from about 5 to about 75 percentage by weight, and even more preferably from about 5 to 60 percentage by weight, based on the total amount of conjugated diene monomer units in the novel modified diene copolymer compositions. The invention is not limited to modified diene copolymer compositions falling within the preferred molecular weight, composition and vinyl configuration ranges.

The anionically polymerized polymers can be made by any suitable method known in the art, such as those described in U.S. Pat. Nos. 3,281,383, and 3,753,936, which are incorporated herein in their entirety by reference. In these methods the anionically polymerized polymers are made by contacting anionically polymerizable monomers with an organolithium compound as an initiator. The preferred class of these compounds can be represented by the formula RLi wherein R is a hydrocarbon radical selected from the group consisting of aliphatic, cycloaliphatic, and aromatic radicals containing from 1 to 20 carbon atoms, although higher molecular weight initiators can be used. Many anionic polymerization initiators are well known and commercially available. Monofunctional organolithium compounds, such as butyllithium, are examples of commonly used initiators. Specific examples of these initiators include methyllithium, ethyllithium, tert-butyllithium, sec-butyllithium, n-butyllithium, n-decyllithium, isopropyllithium, eicosyllithium, cycloalkyllithium compounds, such as cyclohexyllithium, and aryllithium compounds, such as phenyllithium, naphthllithium, p-toluyllithium, 1,1-diphenylhexyllithium, and the like. Monofunctional organolithium compounds substituted with protected polar functional groups may also be used as initiators for anionic polymerization.

The amount of initiator varies depending upon the desired molecular weight of the anionically polymerized polymer. Number average molecular weights between about 4 kg/mol and 1,000 kg/mol can be obtained by adding about 0.09 to 25.0 millimoles of the RLi initiator per mole of monomers corrected by the factor 100/(MW of monomer).

Multifunctional organolithium initiators may also be used as initiators to prepare linear, branched and radial, or multiarm block copolymers with a desired functionality range of 2 to about 30 anionically polymerized polymers chains (arms) per initiator molecule. Multifunctional organolithium initiators are readily prepared by direct addition reaction of a stoichiometric amount of a monofunctional organolithium compound to a polyvinyl compound such as 1,3-diisopropenyl benzene, 1,3,5-triisopropenyl benzene, 1,3-bis(1-phenylethenyl)benzene,1,3,5-tris(1-phenylethenyl)benzene, 1,3-divinylbenzene, 1,3,5-trivinylbenzene, and the like. Oligomeric polyvinyl compounds may be used to prepare multifunctional organolithium initiators with high functionality. Monofunctional organolithium compounds, such as butyllithium, are examples of commonly used initiators for the above addition reaction. Specific examples of these commonly used initiators include tert-butyllithium, sec-butyllithium, and n-butyllithium. Monofunctional organolithium compounds substituted with protected polar functional groups may also be used to prepare multifunctional organolithium initiators. Multifunctional organolithium compounds may be mixed or combined among them and/or with monofunctional organolithium compounds to partially initiate anionic polymerization with the multifunctional organolithium compound. The partial initiation is achieved by controlling the stoichiometric ratio of multifunctional initiator to monofunctional initiator.

Anionic polymerization is typically carried out in inert hydrocarbon solvents at relatively low temperatures under vacuum or an inert atmosphere with highly purified reagents to prevent the premature termination of the polymerization reaction. The anionic polymerization reactions may take place in a variety of organic solvents. Examples of suitable solvents include, but are not limited to, pentane, hexane, heptane, octane, cyclopentane, cyclohexane, cycloheptane, benzene, naphthalene, toluene, xylene, methyl ether, methyl ethyl ether, diethyl ether, tetrahydrofuran, acetone, methyl ethyl ketone, and mixtures thereof. Cyclohexane in particular, is well suited for use as the solvent in anionic polymerizations.

The anionic polymerization is normally carried out at temperatures in the range from about −100° C. to 150° C., preferably between −75° C. and 75° C. Normally 50 to 90% by weight of a reaction solvent is used to control the viscosity inside the reaction zone, preferably 70 to 85%. Typical residence times for anionic polymerization vary depending on the reaction temperature and initiator level between 0.1 and 5 hours, preferable from 0.2 to 2 hours.

Polar additives that are known in the art and may be used to prepare the novel modified diene copolymer compositions of the present invention include but are not limited to Lewis bases such as ethers, tertiary amines and aminoethers, Group Ia alkali metal alkoxides. Lewis base-substituted alkali metal alkoxides, multifunctional polar additives such as amine-ether, ether-alkoxide, amine-alkoxide, binary and ternary mixtures and combinations thereof. Specific examples of these suitable ether polar additives include monofunctional, multifunctional and oligomeric alkyl and cyclic ethers such as dimethyl ether, diethyl ether, ethyl methyl ether, ethyl propyl ether, di-n-propyl ether, tetramethylene oxide (tetrahydrofuran), 1,2-dimethoxyethane, bis-tetrahydrofuran, ditetrahydrofurylpropane (DTHFP), combinations thereof and the like. Specific examples of these suitable tertiary amine polar additives include monofunctional, multifunctional and oligomeric alkyl and cyclic tertiary amines such as dimethylethyl amine, trimethyl amine, triethyl amine, N, N, N′, N′-tetramethyl ethylene diamine (TMEDA), N, N, N′, N′, N″-pentamethyl diethyl triamine, Bis[2-(N,N-dimethylamino)ethyl] ether, combinations thereof, and the like. Specific examples of suitable aminoethers are bis[2-(N,N-dimethylamino)ethyl] ether, tetrahydrofurfuryl-N,N-dimethylamine, and the like. Specific examples of these suitable Group Ia alkali metal alkoxides (lithium, sodium, potassium, rubidium and cesium salts) include monofunctional, multifunctional and oligomeric alkyl and cyclic metal alkoxides such as sodium tert-butoxide, sodium tert-amylate, sodium mentholate, potassium tert-butoxide, potassium tert-amylate, potassium mentholate, combinations thereof, and the like. Specific examples of suitable Lewis base-substituted alkali metal alkoxides are sodium diethylene glycol monoethyl ether, sodium 1,3-bis(dimethylamino)-2-propanolate, sodium 2-[2-(dimethylamino)ethoxy] ethanolate and sodium 2-{[2-(dimethylamino)ethyl] methylamino} ethanolate, and the like.

The amount of the suitable polar additive is in the range of 0.0005 to 50 percentage by weight of the total reaction mixture and is preferably in the range of 0.0005 to 20.0 percentage by weight of the total reaction mixture. A more preferred range is about 0.0005 to about 10.0 wt % of the total reaction mixture. Most preferred Lewis bases are TMEDA, THF and DTHFP. A preferred combination is one that combines two alkali metal alkoxides (e.g., lithium and sodium, lithium and potassium). A more preferred combination is one that combines two Lewis bases (i.e. one ether and one tertiary amine). A most preferred combination is one that combines one Lewis base and one alkali metal alkoxide. The most preferred combination is one that combines two Lewis bases and one alkali metal alkoxide. Preferred concentrations of polar additive or combination of polar additives depend on the type of polar additive or additives, and the desired monomer sequence length distribution, microstructure and properties of the novel modified diene copolymer compositions. The desired properties will, in turn, depend on the intended application of the modified diene copolymer compositions.

Suitable conjugated dienes for use in building the modified diene copolymer compositions of the present invention include, but are not limited to, 1,3 butadiene, isoprene or 2-methyl-1,3-butadiene, 2-ethyl-1,3-butadiene, piperylene or 1,3-pentadiene, methylpentadiene, phenylbutadiene, 2,3-dimethyl-1,3-butadiene, 2,4-hexadiene, 1,3-hexadiene, 1,3-cyclohexadiene, 3,4-dimethyl-1,3-hexadiene, 1,3-octadiene, 4,5-diethyl-1,3-octadiene, P-myrcene or 7-Methyl-3-methylene-1,6-octadiene, P-farnesene or 7,11-Dimethyl-3-methylene-1,6,10-dodecatriene, isomeric mixtures and combinations thereof. These suitable conjugated diene monomers for the modified diene copolymer compositions of the present invention also include and are not limited to bio-source and/or bio-based conjugated diene monomers, substituted conjugated diene monomers with at least one substituent selected from C1-C18 alkyl or alkoxy, cycloalkyl and/or aromatic groups, protected functionalized conjugated diene monomers, isomeric mixtures and combinations thereof.

Suitable unsubstituted and substituted vinyl aromatic monomers for use in building the novel modified diene copolymer compositions of the present invention include, but are not limited to, styrene and styrene derivatives such as 3-methylstyrene, p-methyl styrene or 4-methyl styrene, vinyl toluene, a-methyl styrene or alpha-methyl styrene, α,4-dimethylstyrene, t-butyl styrene, o-chlorostyrene, 2-butenyl naphthalene, 4-t-butoxystyrene, 3-isopropenyl biphenyl, 4-vinylpyridine, 2-vinylpyridine and isopropenyl naphthalene, 4-n-propylstyrene, isomeric mixtures and combinations thereof. These suitable unsubstituted and substituted vinyl aromatic monomers for the modified diene copolymer compositions of the present invention also include and are not limited to bio-source and/or bio-based unsubstituted and substituted vinyl aromatic monomers, protected functionalized unsubstituted and substituted vinyl aromatic monomers including but not limited to hydrosilylated monomers and hydrosilane functional monomers, isomeric mixtures and combinations thereof. Among the substituted vinyl aromatic monomers with at least one substituent selected from C1-C18 alkyl or alkoxy, cycloalkyl and/or aromatic groups are various compounds that include but are not limited to: alkyl-substituted styrenes, alkoxy-substituted styrenes, vinyl napthalene, alkyl-substituted vinyl napthalenes, 1,1-diphenyl ethylene, 1,4-diisopropenyl benzene, 1,4-bis(1-phenylethenyl) benzene, and the like, which are suitable compounds for the novel modified diene copolymer compositions.

In some embodiments of the methods provided here, the novel modified diene copolymer compositions undergo total or partial coupling to prepare linear, branched or radial, or multiarm copolymers. Partial coupling means that a portion of the total living anionically polymerized polymer chain-ends undergo coupling with coupling agents. The coupling agents desirably couple between 2 and 30 anionically polymerized polymer chains (number of arms), although coupling agents capable of coupling a greater number of chains may also be employed. Suitable coupling agents for use in the total or partial coupling step include, but are not limited to, tin halides, silicon halides, tin alkoxides, silicon alkoxides, alkyl-substituted tin and silicon trihalides, alkyl-substituted tin and silicon dihalides, hexahalodisilanes, hexahalo disiloxanes, functionalized tin compounds, functionalized silicon compounds, alkoxy-silane compounds, alkoxy-substituted silicon and tin halides, alkoxy-alkyl-silanes, epoxysilane compounds, amino and/or amine silane compounds, isocyanato silane compounds, methacrylate silane compounds; acrylate silane compounds; sulfur silane compounds, fluoro silane compounds, fluoroalkyl silane compounds, sulfanylsilane compounds, mercaptosilane compounds, sulfide silane compounds, sulfide tin compounds, and functionalized oligomeric compounds such as the ones listed in U.S. Pat. Nos. 3,281,383, 7,517,934 and 8,883,927, multifunctional compounds, mixtures or combinations of the aforementioned compounds. The entire disclosures of U.S. Pat. Nos. 3,281,383, 7,517,934 and 8,883,927 are incorporated herein by reference. Other suitable coupling agents include siloxanes, multifunctional epoxides, esters, epoxidized oils, and polyalkenyl compounds. Polyalkenyl coupling agents as disclosed in, for example, U.S. Pat. Nos. 3,985,830; 4,391,949; and 4,444,953; and Canadian Pat. No. 716,645. Suitable polyalkenyl coupling agents include divinylbenzene, and preferably m-divinylbenzene. Silicon tetrachloride, tin tetrachloride, m-divinylbenzene, epoxidized oils and functionalized oligomeric compounds, are specific examples of suitable coupling agents, with silicon tetrachloride and tin tetrachloride being particularly well-suited for this application. Functionalized silicon and tin compounds may be used to attach specific functionalities into the polymer chains of the novel modified diene copolymers including but not limited to chloro-propyl-trialkoxysilanes, trialkyltinchloride and trialkoxytinchloride such as chloro-propyl-triethoxysilane, chloro-propyl-trimethoxy-silane, trimethyltinchloride, trimethoxytinchloride, triethyltinchloride, triethoxytinchloride, trioctyltinchloride, trioctyloxytinchloride, and the like. The total or partial coupling is achieved by controlling the stoichiometric ratio of coupling agent to living polymer. The partial coupling may provide a polymer blend with desired properties. The coupling agent, combination of coupling agents or mixture of coupling agents may be sequentially, partially, intermittently or continuously added during the polymerization to achieve polydispersity, functionality, asymmetry, and the like. A preferred combination is one that combines two silicon coupling agents such as silicon halide and silicon alkoxide. A more preferred combination is one that combines a silicon compound and a tin compound such as silicon halide and a tin alkoxide. A most preferred combination is one that combines a silicon compound and a functionalized oligomeric compound. The most preferred combination is one that combines a silicon compound, a tin compound and a functionalized oligomeric compound.

Specific examples of coupling agents can also be selected from polyepoxides, polyisocyanates, polyimines, polyaldehides, polyketones, polyanhydrides, polyesters, polyhalides, and the like as disclosed by Zellinski in U.S. Pat. No. 3,281,383. The functionalized oligomeric coupling agent compounds may be based on monomers such as methacrylate, acrylate, aromatic, olefin, unsaturated dicarboxylic anhydride, acrylonitrile, and the like, and may be functionalized with at least one functional group selected from esters, carboxylic acids, anhydrides and epoxies, or multifunctional oligomers comprising at least two, and in some instances at least three or more functionalities, as disclosed by Deeter et al. in U.S. Pat. No. 7,517,934. Additional examples of coupling agents such as polyesters, polyacrylates, polymethacrylates, and polyketone compounds include, but are not limited to, poly(methyl acrylate), poly(ethyl acrylate), poly(n-propyl acrylate), poly(i-propyl acrylate), poly(n-butyl acrylate), poly(s-butyl acrylate), poly(i-butyl acrylate), poly(t-butyl acrylate), poly(n-amyl acrylate), poly(i-amyl acrylate), poly(isobornyl acrylate), poly(n-hexyl acrylate), poly(2-ethylbutyl acrylate), poly(2-ethyl-hexyl acrylate), poly(n-octyl acrylate), poly (isooctyl acrylate), poly(n-decyl acrylate), poly(methylcyclohexyl acrylate), poly(cyclopentyl acrylate), poly(cyclohexyl acrylate), poly(methyl methacrylate), poly(ethyl methacrylate), poly(n-propyl methacrylate), poly(n-butyl methacrylate), poly(i-propyl methacrylate), poly(i-butyl methacrylate), poly(n-amyl methacrylate), poly(n-hexyl methacrylate), poly(i-amyl methacrylate), poly(s-butyl methacrylate), poly(t-butyl methacrylate), poly(2-ethyl-butyl methacrylate), poly(2-ethyl-hexyl methacrylate), poly(n-octyl methacrylate), poly(isooctyl methacrylate), poly(methyl-cyclohexyl methacrylate), poly(cinnamyl methacrylate), poly(crotyl methacrylate), poly(cyclohexyl methacrylate), poly(cyclopentyl methacrylate), poly(2-ethoxy-ethyl methacrylate), poly(isobornyl methacrylate), and their copolymers, mixtures or combinations thereof. To increase coupling efficiency, metal alkyl compounds may be used as coupling promoters in an anionic polymerization process. Some examples of metal alkyl compounds are triethyl aluminum, trimethyl aluminum, tri-n-propyl aluminum, tri-n-butyl aluminum, triisobutyl aluminum, tri-n-hexyl aluminum, and trioctyl aluminum. Triethyl aluminum is preferred, as disclosed by Rojas Garcia et al. in U.S. Pat. No. 8,883,927.

Specific examples of suitable functionalized silicon and tin compounds, and silane coupling agents such as the ones listed in U.S. Pat. Nos. 6,229,036, 8,053,512 and PCT Patent Application WO 2018/091955. The entire disclosures of U.S. Pat. Nos. 6,229,036, 8,053,512 and PCT Patent Application WO 2018/091955 are incorporated herein by reference. Examples of sulfanylsilanes are: (EtO)3-Si-(CH2)3-S-Si(CH3)3, [(EtO)3-Si-(CH2)3-S]2-Si(CH3)2, [(EtO)3-Si-(CH2)3-S]3-Si(CH3), [(EtO)3-Si-(CH2)3-S]2-Si(OEt)2, [(EtO)3-Si-(CH2)3-S]4-Si, (EtO)3-Si-(CH2)3-S-Si(OEt)3, (MeO)3-Si-(CH2)3-S-Si(C2H5)3, (MeO)3-Si-(CH2)3-S-Si(CH3)3, [(MeO)3-Si-(CH2)3-S]2-Si(CH3)2, [(MeO)3-Si-(CH2)3-S]2-Si(OMe)2, [(MeO)3-Si-(CH2)3-S]4-Si, [(MeO)3-Si-(CH2)3-S]3-Si(OMe), and similar C1-C100 linear or branched, alkyl or alkoxy or cycloalkyl or cycloalkoxy or phenyl or benzyl substituted sulfanylsilanes compounds, including but not limited to silicon sulfide modifiers and tin sulfide modifiers, and functionalized and modified versions such as nitrile, amine, NO, alkoxy, thioalkyl, mercaptan, monosulfide, disulfide and tetrasulfide compounds. Specific examples of suitable silane coupling agents are 3-mercaptopropyl trialkoxy silane, bis-(3-trialkoxysilylpropyl)-disulfide, bis-(3-trialkoxysilylpropyl)-tetrasulfide, bis-(3-triethoxysilylpropyl)-disulfide, bis-(3-triethoxysilylpropyl)-tetrasulfide, 3-mercaptopropyltriethoxysilane, 3-mercaptopropyl trimethoxysilane, bis-(3-trimethoxysilylpropyl)-disulfide (TMSPD), mercaptopropyltriethoxy silane(MPTES), bis-(3-triethoxysilylpropyl)-disulfide (TESPD), bis-(3-trimethoxysilylpropyl)-disulfide, mercaptopropyltriethoxysilane (MPTES), bis-(3-triethoxysilylpropyl)-tetrasulfide, bis-(3-trimethoxysilylpropyl)-tetrasulfide (TMSPT), 3-mercaptopropyl trimethoxy silane, bis-(3-trimethoxysilylpropyl)-disulfide,bis-(3-trimethoxysilylpropyl)-tetrasulfide, their derivatives of ethoxysilanes and chlorosilanes, and combinations thereof. Other suitable functionalized silicon and tin compounds, and silane coupling agents include but are not limited to silane functionalized silicon or tin compounds that can be used to perform in-chain hydrosilylation reactions on the polymer chain of the modified diene copolymer compositions and attach either functional groups and/or other polymer side chains to the main chain.

In additional embodiments of the methods provided here, the novel modified diene copolymer compositions undergo total or partial linking to join polymer chains and prepare linear, branched or radial, multiarm or grafted in structure copolymers that retain the living character and are capable of polymerizing remaining or new monomer to prepare miktoarm, hybrid and/or assymetric novel modified diene copolymer compositions, which include at least one polymer chain (intramolecular) with at least one different characteristic such as composition, microstructure, size, vinyl configuration, and the like. Partial linking means that a portion of the total living anionically polymerized polymer chain-ends undergo linking with linking agents. The linking agents desirably join between 2 and 30 anionically polymerized polymer chains (number of arms), although linking agents capable of linking a greater number of chains may also be employed. Suitable linking agents for use in the total or partial linking step include, but are not limited to, polyvinyl compounds such as 1,3-diisopropenyl benzene, 1,4-diisopropenyl benzene, 1,3,5-triisopropenyl benzene, 1,3-bis(1-phenylethenyl)benzene, 1,4-bis(1-phenylethenyl)benzene, 1,3,5-tris(1-phenylethenyl)benzene, 1,3-divinylbenzene, 1,4-divinylbenzene, 1,3,5-trivinylbenzene, also substituted polyvinyl compounds with at least one substituent such as alkyl, alkoxy, cycloalkyl, and cycloalkoxy, and the like. Oligomeric polyvinyl compounds may be used as linking agents with high functionality.

Organometallic compounds of different metals from Groups IIa, IIb and IIIa, including magnesium, zinc and aluminum, may be used as polymerization rate modifiers when mixed with alkyllithium initiators. Specific examples of suitable polymerization rate modifiers are dibutyl magnesium, diethyl zinc, triethyl aluminium and combinations thereof. The polymerization rate modifiers may be used to control the temperature profile of polymerization. The polymerization rate modifiers contribute to control a polymerization step in either isothermal mode for a pre-established residence time or quasi-adiabatic mode up to a peak temperature.

The novel modified diene copolymer compositions of the present invention provide various adhesive, sealant, coating, asphalt, tire and plastic applications with reactive sites susceptible to further modification and cross-linkable moieties that allow photo-, thermal- and chemical-cured crosslinking. The reactive sites susceptible to further modification of the novel modified diene copolymer compositions can be treated by any suitable method known in the art, such as those described in U.S. Pat. Nos. 9,803,034; 5,162,445; 4,704,438; 4,306,049; 4,145,490 and E.U. Patent No. 0,842,201, which are incorporated herein in their entirety by reference. Further modification of substituted vinyl aromatic monomers in the novel modified diene copolymers may be performed by post-polymerization reactions such as metalation, halogenation, sulfonation, alkoxy silane modification, hydrosilylation, and the like. Metalation of alkyl-substituted vinyl aromatic units in novel modified diene copolymers and subsequent grafting from and polymerization of polar monomers may be performed in tetrahydrofuran (THF) as a solvent and secondary butyllithium (sec-BuLi) as an initiator at a temperature of the reactor from about −10° C. to about 10° C. for at least 60 min, or in toluene as a solvent and tertiary butyllithium (tert-BuLi) and 2,6-di-tert-butyl-4-methylphenoxy)diisobutylaluminum (Al(BHT)(iB)2) as an initiator at a temperature of the reactor of about −10° C. for at least 60 min. Metalation of alkyl-substituted vinyl aromatic units in novel modified diene copolymers may be performed with lithium by reaction with an alkyllithium compound activated with N,N,N′,N′-tetramethyl ethylene diamine (TMEDA), and the metalated derivative then converted by reaction with an electrophilic reagent to a variety of functionalized derivatives, metalation occurs at both the primary and tertiary benzylic carbon atoms of a methylated styrene comonomer unit, as well as the aromatic ring carbon atoms thereof. Metalation of alkyl-substituted vinyl aromatic units in novel modified diene copolymers may be performed by combination of an alkyllithium compound with an alkoxide of a heavier alkali metal to form a reagent, which has been referred to as a “superbase,” which is very reactive for performing metalation reactions in organic synthesis and polymer chemistry. The application of a superbase reagent formed from an alkyl lithium and a potassium alkoxide to the metalation of aromatic hydrocarbons like benzene, toluene, ethylbenzene, and cumene to form a metalated species in which the counterion is the heavier alkali metal rather than lithium is well-known. Metalation of alkyl-substituted vinyl aromatic units in novel modified diene copolymers may be performed in solution in a hydrocarbon solvent with a superbase. The superbase formed by the interaction of an alkyl lithium compound with one or more higher atomic weight alkali metal alkoxide to form a metalated species wherein the counterion is the higher atomic weight alkali metal (Na, K, Rb, Cs) which is localized to the para-alkyl carbon site of the styrenic comonomer. The superbase is present in an amount relative to the alkylstyrene content of the copolymer to provide a mole ratio of from 1:1 to 2:1. The metalated copolymer is contacted with an electrophilic reagent to convert the metalated copolymer into a derivative having the functional group carried by the electrophilic reagent covalently bonded to the benzylic carbon atom of the para-alkyl group of the aromatic group pendant to the copolymer backbone, and the alkylstyrene being para-alkyl, meta-alkyl and/or ortho-alkyl can also be employed. Alkyl-substituted vinyl aromatic units in novel modified diene copolymers may be brominated to provide benzylic bromine atoms that are highly reactive under mild conditions in the presence of a nucleophilic reagent. Alkyl-substituted vinyl aromatic units in novel modified diene copolymers may be sulfonated and subjected to other electrophilic substitution reactions such as chlorination and bromination. These reactions on alkyl-substituted vinyl aromatic units in novel modified diene copolymers may occur more readily than with polystyrene. The sulfonation can be continued to a degree such that the resultant sulfonated material is water soluble. The sulfonate groups may, of course, be neutralized by alkalies such as ammonia, sodium hydroxide, potassium hydroxide and the like to give a neutral material. Sulfonating agents such as sulphonyl chloride, chlorosulfonic acid and sulfur trioxide or sulfuric acid (oleum) may be used to make the sulfonation. Halogenation of the methyl side chains can be carried out by using a halogenating agent under free-radical conditions, for example, in the presence of a peroxide or under light or ultra-violet radiation. Organometallic groups can be inserted by reaction of organometallic halides such as tin trimethylchloride, boron dimethyl chloride or lead trimethylchloride in the presence of a Friedel-Crafts catalyst. Alkyl-substituted vinyl aromatic units in novel modified diene copolymers may be melt grafted with alkoxysilanes, most often vinyltrimethoxysilane (VTMS), in processing equipment, usually extruders, in the presence of small amounts of peroxides as radical initiators. Typically, about 2% of silanes are used, and dicumyl peroxide as the initiator is used (5-15 wt %).

In additional embodiments of the present invention, the novel modified diene copolymer compositions may be further chain-end or in-chain functionalized by reacting at least one suitable functionalizing agent to attach at least one functional group or modify at least one block or segment of the modified A-B-C or C-B-A copolymer. The functionalization reaction may be performed during polymerization or post-polymerization. Suitable functional groups include but are not limited to epoxy, amine, hydroxy, carboxy, aldehyde, acrylate, methacrylate, ester, amide, isocyanate, anhydride, hydrosilane, alkoxysilane, alkoxytin, mercaptan, aromatic dithioester, trithiocarbonates, dithiocarbamates, xanthates, mixtures and combinations thereof. Suitable functionalized silicon and tin compounds may be used to attach specific functionalities in the polymer chains of the novel modified diene copolymers including but not limited to chloro-propyl-trialkoxysilanes, trialkyltinchloride and trialkoxytinchloride such as chloro-propyl-triethoxysilane, chloro-propyl-trimethoxy-silane, trimethyltinchloride, trimethoxytinchloride, triethyltinchloride, triethoxytinchloride, trioctyltinchloride, trioctyloxytinchloride, and the like. Suitable functionalization reactions to modify at least one conjugated diene unit and/or at least one unsubstituted vinyl aromatic unit in at least one block or segment of the modified A-B-C or C-B-A copolymer comprise epoxidation, sulfonation, and the like.

In some embodiments of the methods provided here, the novel modified diene copolymer compositions are polymerized in batch, programmed batch and/or semi-batch processes. As one of skill in the art would recognize, the described synthesis of the modified diene copolymer compositions can occur in a reaction setting comprising a process operated at temperatures, solvent ratios and stream flow rates necessary to reach the described residence time and stoichiometry conditions.

Applications

Other aspect of the present invention provides polymer blends and mixtures containing modified diene copolymers, reinforced materials containing either the modified diene copolymer compositions or the polymer blends and mixtures containing the modified diene copolymers, comprising:

polymer blends or mixtures containing the novel modified diene copolymer compositions of the present invention comprise at least one polymer selected from polar plastics, polar engineering plastics and non-polar plastics; suitable polar plastics, polar engineering plastics and non-polar plastics include, but are not limited to polyamides, polyurethanes, polyethers, polysulfones, polyether-ketones, polyetherether ketones, polyimides, polyetherimides polycarbonates, polyesters, and copolymers thereof, and non-polar plastics include, but are not limited to polyolefins (LDPE, LLDPE, HDPE, very low density VLDPE, PE waxes, all kinds of PP), polystyrene, blends and mixtures, and copolymers thereof; in an additional embodiment, the polymer blends or mixtures containing the novel modified diene copolymer compositions of the present invention comprise commercially available elastomers selected from linear, radial, tapered, random, block or multiblock copolymers, such as SIS, SBS, SEBS, SEPS, SIBS, SI/BS, SBR, SIR, or any combinations thereof; in other embodiment of the present invention, the polymer blends or mixtures containing the novel modified diene copolymer compositions of the present invention comprise at least one copolymer selected from EVA, EP and EPDM elastomers and polyisobutene; in another embodiment of the present invention, the polymer blends or mixtures containing the novel modified diene copolymer compositions of the present invention comprise any polymer based on bio-monomers or any copolymer based on bio-monomers and/or bio-degradable monomers, or combinations with oil-based monomers, wherein a mixing step may be necessary to provide intimate contact between other polymers in the blends and mixtures and the novel modified diene copolymer compositions; the mixing step may be performed before or after the novel modified diene copolymer compositions are further modified by post-polymerization reactions; and

reinforced materials containing either the modified diene copolymer compositions or the polymer blends and mixtures containing the modified diene copolymers achieve a tailored compatibility and reactivity, and an improved balance between processability and reinforcement performance for various applications such as adhesives, sealants, coatings, tires, plastic and rubber/elastomer modification, and asphalt/bitumen modification and their emulsions for road paving, roofing, shingles and waterproofing membranes, wherein the novel modified diene copolymer compositions are useful for pressure and non-pressure sensitive, hot melt and solvent based formulations for taping, labeling, packaging, construction and positioning adhesive end-use applications, including solvent-based mastics and sealants, wherein the novel modified diene copolymer compositions are useful for low viscosity and reactive hot-melt adhesive compositions, particularly for sprayable and contact adhesives with high heat resistance, low energy processability, and low emission of volatile organic compounds (VOCs) relative to solvent-based formulations, and wherein more specifically, the novel modified diene copolymer compositions provide the above mentioned applications with: tailored compatibility with formulation ingredients, reactive sites susceptible to modification, and cross-linkable moieties that allow photo-, thermal- and chemical-cured crosslinking; easy processing advantages such as short dispersion time, low mixing temperature, low viscosity, low VOC level, and excellent storage stability; and good reinforcement advantages such as high heat resistance, high cohesive strength and shear resistance, high tack and peel resistance, high elastic response, wide range of performance grade, high ductility and penetration, good compromise between high and low temperature properties, and self-healing behavior.

In another embodiment, the present invention provides a process for mixing other polymers in the blends and mixtures and the novel modified diene copolymer compositions comprising:

mixing a novel modified diene copolymer composition and at least one other polymer, such a blend or mixture is homogeneously blended by using a batch intensive mixer or a continuous intensive mixer or a twin-screw extruder, under mixing conditions of from about 120 to about 200° C. and mixing speed of from about 30 to about 150 rpm to form a masterbatch, and optionally cut into small pieces by using a pelletizer, and then the masterbatch is mixed with the rest of the components/additives of a specific formulation for various applications;

wherein the mixing may be performed under reactive conditions to perform post-polymerization reactions on the substituted vinyl aromatic units of the novel modified diene copolymer compositions.

Other additional aspects of the invention provide compositions and articles made from a novel modified diene copolymer composition, reinforced materials made from a mixture of the novel modified diene copolymer composition or polymer blends and mixtures containing the modified diene copolymers with a material to be reinforced and articles made from the reinforced materials. Other aspects of the invention provide novel modified diene compositions, and their blends with other block copolymers, with enhanced adhesion to specific substrates and articles made from the adhesion enhanced materials. The novel modified diene composition achieves a better balance between compatibility, processability and reinforcement performance for various adhesive, sealant, coating, asphalt, tire and plastic applications. Certain types of modified diene copolymer compositions or the polymer blends and mixtures containing the modified diene copolymers may also be used as reinforcing agents, viscosity modifiers, flow modifiers, processing aids and impact modifiers in rubbers and plastics.

The novel modified diene copolymer compositions provide various adhesive, sealant, coating, asphalt, tire and plastic applications with reactive sites susceptible to modification and cross-linkable moieties that allow photo-, thermal- and chemical-cured crosslinking. The photo-, thermal- and chemical-cured crosslinking of the novel modified diene copolymer compositions, and of polymer blends or mixtures containing novel modified diene copolymer compositions and other suitable polymers, can be made by any suitable method known in the art, such as those described in U.S. Pat. Nos. 8,703,860; 7,799,884; 7,432,037; 6,926,959 and 4,306,049; and E.U. Patent No. 0097307, which are incorporated herein in their entirety by reference. The novel modified diene copolymer compositions of the present invention may be crosslinked by using known methodologies including but not limited to a specific energy source methodology. Suitable energy sources include electron beam radiation, ultraviolet light radiation, and/or heat. A crosslinking promotor may be used for crosslinking the novel modified diene copolymer compositions, details are described in U.S. Pat. No. 6,803,014, which is incorporated herein in their entirety by reference. Examples of suitable crosslinking promotors include, but are not limited to, azo compounds, acrylate or methacrylate compounds, organic peroxides and polyfunctional vinyl or allyl compounds such as, for example, triallyl cyanurate, triallyl isocyanurate, pentaerthritol tetramethacrylate, glutaraldehyde, ethylene glycol dimethacrylate, diallyl maleate, dipro-pargyl maleate, dipropargyl monoallyl cyanurate, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy) hexane, lauryl peroxide, tert-butyl peracetate, azobis isobutyl nitrite and the like and combination thereof. The crosslinking promotor is introduced to the novel modified diene copolymer in amounts from 0.01 to 5 percentage by weight based on the total weight of the total concentration of the modified diene copolymer. Suitable free-radical initiating systems may be used to crosslink the novel modified diene copolymer compositions, and include but are not be limited to azo compounds, alkyl or acyl peroxides or hydroperoxides, ketoperoxides, peroxy esters, peroxy carbonates, and peroxyketals, or mixtures thereof. Examples of suitable alkyl peroxides, dialkyl peroxides, hydroperoxides, acyl peroxides, peroxy esters and peroxy ketals that may used to crosslink the novel modified diene copolymer compositions include, but are not limited to benzoyl peroxide, dibenzoyl peroxide, diacetyl peroxide, di-t-butyl peroxide, cumyl peroxide, dicumyl peroxide, dilaurylperoxide, t-butyl hydroperoxide, methyl ketone peroxide, acetylacetone peroxide, methylethyl ketone peroxide, dibutylperoxyl cyclohexane, di (2,4-dichlorobenzoyl)peroxide, diisobutyl peroxide, t-butyl perbenzoate, and t-butyl peracetate, or mixtures thereof. The free-radical initiator or initiator system may be used in total amounts from about 0.001 to about 2.0 percentage by weight based upon the total weight of the modified diene copolymer composition. The novel modified diene copolymer compositions may be crosslinked by electron beam radiation exposing to a dosage of 186 kilograys. A photopolymerization initiator that may be used to crosslink the novel modified diene composition of the present invention include but are not limited to benzophenone, benzoin, benzoin methyl ether, benzoin ethyl ether, benzoin isopropyl ether, a-methylolbenzoin, a-methylolbenzoin methyl ether, a-methoxybenzoin methyl ether, benzoin phenyl ether, and a-t-butylbenzoin, mixtures or combinations thereof. The photopolymerization initiator or initiator system may be used in an amount of from about 0.1 to about 10 percentage by weight. Additives commonly used in photosensitive compositions may be added to the novel modified diene copolymer composition of the present invention, including but not limited to: heat polymerization inhibitors such as 2,6-di-t-butyl-p-cresol, p-methoxyphenol, pentaerythritol tetrakis[3-(3′,5′-di-t-butyl-4′-hydroxy)phenylpropionate], hydroquinone, t-butyl catechol, t-butyl hydroxyanisole, and 4,4′-butylidene bis(3-methyl-6-t-butyl)phenol; UV absorbents; antihalation agents; and photostabilizers, mixtures or combinations thereof. Suitable active energy ray that may be used to cure or crosslink the novel modified diene copolymer compositions of the present invention may be a particle beam, electromagnetic wave, or a combination thereof. Examples of the particle beam include electron beam (EB) and a-ray, and examples of the electromagnetic wave include ultraviolet ray (UV), visible light, infrared ray, y-ray, and X-ray. Electron beam (EB) and ultraviolet ray (UV) are particularly preferred. The electron beam may be accelerated at a voltage of 0.1 to 10 MeV and irradiated at a dose of 1 to 500 kGy. A lamp with an irradiation wavelength of 200 to 450 nm may be used as the source of ultraviolet ray. Cross-linking of the novel modified diene copolymer compositions of the present invention may be performed by using a chemical cross-linking agent such as dicumyl peroxide in an amount of about 1.5 percentage by weight (based on polymer) at a temperature of about 205° C. for at most 8 min. High temperature initiators useful in this method are those which have a ten hour half-life greater than 110° C. Typically, di-cumyl peroxide, di-t-butyl peroxide, 2,5-dimethyl-2,5-bis(t-butylperoxy) hexane, and 3,3-di(t-butylperoxy) butyrate. Generally, the high temperature initiators are employed in amounts of from 0.5 to 2 percentage by weight. Curing or crosslinking is generally accomplished at from about 1750 to 250° C. for about one to five minutes, preferably from about 2000 to 230° C. for about two to four minutes.

Among the desired commercial applications, some of the novel modified diene copolymer compositions provided herein are well suited for use as adhesives, sealants and coatings, including pressure sensitive adhesives, non-pressure sensitive adhesives, hot melt adhesives, hot melt and solvent-based mastics and sealants. The modified diene copolymer compositions may also be designed for use as compatibilizing or reinforcing agents in asphalt and in polymer blends. Asphalts which may benefit from the compatibilizing or reinforcing agents provided herein include those commonly used for road paving, roofing and sealant applications. Paving applications include reinforcement of asphalt cements/binders used for making asphalt concrete for road construction, as well as modification of materials for road rehabilitation, repair and maintenance, including chip sealing, resealing, resurface and recycling. Roofing applications include reinforcement of roof shingles, as well as modification of materials for roof waterproofing, repair and maintenance. Certain types of modified diene copolymer compositions may also be used as reinforcing agents, viscosity modifiers, flow modifiers, processing aids and impact modifiers in rubbers and plastics. Non-polar plastics are types of plastic that may benefit from the modified diene copolymer compositions. Non-polar plastics include, but are not limited to polyolefins, polystyrene and copolymers thereof.

As one of skill in the art would recognize, the optimal characteristics and properties of the novel modified diene copolymer compositions will depend on the intended application. Several exemplary applications for the modified diene copolymer compositions are provided below. These applications are provided only for illustrative purposes and are not intended to limit the scope of the invention.

Adhesives, Sealants and Coatings

High molecular weight elastomers are typically formulated in blends useful as adhesives, sealants and coatings to provide cohesive strength and adequate balance for each application between adhesive and cohesive properties. Elastomers based on monovinyl aromatic and conjugated diene monomers are extensively used as pressure-sensitive adhesives, spray and contact adhesives, panel and construction mastics, sealants and coatings. Isoprene-containing elastomers are preferred for hot melt pressure sensitive adhesives because they can be readily tackified at low cost. Butadiene-containing elastomers are generally preferred for construction or laminating adhesives because they can provide stiffness and cohesive strength. Hydrogenated versions of these elastomers are preferred for sealants because of their higher weather resistance. Performance properties that are required for successful formulation of adhesives, sealants and coatings products with elastomers are the following: a) tackifying resin compatibility with elastomer; b) continuous elastomer phase morphology for cohesive strength and shear resistance; c) soft and low modulus elastomer for tack development and energy dissipation; d) suitable tackifying resin that raises the glass transition temperature (Tg) of rubbery phase of the elastomer for increasing dissipation of strain energy.

High molecular weight polymers of the prior art adversely affect the processing characteristics of the adhesives, sealants and coatings formulations by significantly increasing the melt and solution viscosity of these blends. Modification of polymer composition and/or structure in prior art has been used to improve processing characteristics and to reduce the cost of formulations for adhesives, sealants and coatings applications, but often performance properties are unfavorably modified. Among the desired commercial applications, some of the novel modified diene copolymer compositions provided herein are well suited for use as adhesives, sealants and coatings, including pressure sensitive adhesives, non-pressure sensitive adhesives, hot melt adhesives, hot melt and solvent-based mastics, sealants and coatings. The development of low melt viscosity and low solution viscosity is particularly important for pressure-sensitive adhesives, hot melt adhesives and solvent-based adhesives. The inventors have discovered that the addition of the novel modified diene copolymer compositions provide outstanding processing characteristics to formulations without significantly affecting the desired performance properties of adhesives, sealants and coatings products. The adhesive, sealant and coatings formulations comprising the novel modified diene copolymer compositions may allow: processing at much lower temperatures without affecting cost efficiency and/or production rates and keeping the reinforcement properties such as cohesive strength; or blending with other polymers of higher vinyl aromatic monomer content and/or higher molecular weight to improve reinforcement properties such as cohesive strength and keeping the typical processing temperature without affecting cost efficiency and/or production rates. Remarkably, hot melt pressure sensitive adhesives prepared with these novel modified diene copolymer compositions show high compatibility with various resins and high cohesive strength and high shear resistance. More remarkably, the compatibility of the novel modified diene copolymer compositions may be adjusted to match the resin and/or other polymer compatibilities to provide high formulation flexibility and better overall performance. In addition, the adhesive, sealant and coatings formulations comprising the novel modified diene copolymer compositions may be cured or crosslinked to provide for better reinforcement properties such as excellent cohesive strength and extremely high shear and temperature resistance. It has also been discovered that the compatibilizing or reinforcing agents provided herein can be encapsulated and blended with commercially available block copolymers to improve phase stability and processing characteristics of the adhesive blends. The adhesive compositions comprising the novel modified diene copolymer can be used in most applications where an adhesive or coating composition is applied to a backing or substrate. The substrate can be in the form of films, tapes, sheets, panels, and the like, and can be made of materials, such as, paper, fabric, plastic, nonwoven fiber (e.g., disposable absorbent garments), metal, foil, natural rubber, synthetic rubber, wood and wood composites. Application of the adhesive, sealant and coating compositions of the invention comprising the novel modified diene copolymer to the substrate may be accomplished using any conventional means, such as, roller, slot orifice, spray or extrusion coating.

In some such applications, about 10 to 70, desirably 15 to 55, and more desirably 18 to 45, percentage by weight of the novel modified diene copolymer compositions, or its mixtures with commercially available copolymers, are mixed with other conventional adhesive formulation components/additives, such as tackifying resins; plasticizers; coupling agents; crosslinking agents; photoinitiators; fillers; processing aids; stabilizers and antioxidants to confer such compositions with improved properties compared to adhesives formulated with prior art elastomers as suitable controls. Examples of suitable tackifiers include resins with high and low softening points which are compatible with the polymer. These include but are not limited to hydrogenated resins, rosin esters, polyterpene resins, terpene phenol resins, indene-coumarone resins and aliphatic hydrocarbon resins. In some illustrative embodiments, the amount of tackifying resins in the composition ranges from about 20 to 70 percentage by weight. Plasticizers, generally known as extending oils, include mineral oils, paraffinic oils, and naphthenic oils. In some illustrative embodiments, the amount of plasticizer in the composition ranges from about 5 to 35 percentage by weight. The antioxidants may be used to inhibit the thermal and UV oxidation processes and are typically added to the adhesive composition in amounts of about 0.05 to 3 percentage by weight. Examples of antioxidants include phenol compounds, phosphites, amines, and thio compounds.

In another embodiment, the novel hot melt adhesive, sealant or coating compositions containing a modified diene copolymer composition may be prepared by a process comprising first mixing a masterbatch of a modified diene copolymer and at least one tackifying resin, wherein the masterbatch is homogeneously blended at room temperature, then mixed by using a batch intensive mixer or a continuous intensive mixer or a twin-screw extruder, under mixing conditions of from about 120 to about 200° C. and mixing speed of from about 30 to about 150 rpm, and optionally cut into small pieces by using a pelletizer, and then the masterbatch is mixed with the rest of the components/additives of the hot melt adhesive, sealant or coating formulations.

Conventional adhesive formulation components/additives, such as tackifying resins; plasticizers; coupling agents; crosslinking agents; photoinitiators; fillers; processing aids; stabilizers and antioxidants may be added to the hot melt adhesive compositions of the present invention to provide a desired fine-tune performance of a full-fledged, complete formulation. Suitable tackifiers include but are not limited to resins with high and low softening points which are compatible with the polymer, such as hydrogenated or hydrocarbon resins, rosin esters, polyterpene resins, terpene phenol resins, indene-coumarone resins and aliphatic hydrocarbon resins. In some illustrative embodiments, the amount of tackifying resins in the hot melt adhesive composition of the present invention ranges from about 20 to 70 percentage by weight. Plasticizers, generally known as extending oils, include mineral oils, paraffinic oils, and naphthenic oils. In some illustrative embodiments, the amount of plasticizer in the composition ranges from about 5 to 35 percentage by weight. The antioxidants may be used to inhibit the thermal and UV oxidation processes and are typically added to the adhesive composition in amounts of about 0.05 to 4 percentage by weight. Examples of antioxidants include phenol, phosphites, amines, and thio compounds. The adhesives of the invention will typically also comprise from about 20 wt % to about 70 wt % of a tackifying resin or a tackifying resin combination, preferably from about 20 wt % to about 65 wt %, more preferably from about 20 wt % to about 60 wt % of a tackifier resin or a tackifying resin combination, which are compatible with the midblock and/or the end-blocks of the block copolymers in the formulation. Preferred are tackifiers having a Ring and Ball softening point above about 25° C. The hot melt adhesive compositions of the present invention may comprise from about 2 wt % to about 25 wt % of: any commercially available block copolymer, multiblock copolymer, tapered block or random copolymer; which may be linear, branched or radial, multiarm, miktoarm, hybrid, assymetric; and may be partially or totally coupled to form blends of diblock/triblock copolymers. Examples include but are not limited to: styrene-b-isoprene-b-styrene (e.g. SIS and SIS/SI and (SI)n-X/SI), styrene-b-butadiene-b-styrene (e.g. SBS and SBS/SB and (SB)n-X/SB), styrene-b-isobutylene-b-styrene (e.g. SIBS and SIBS/SIB and (SIB)n-X/SIB), styrene-b-isoprene/butadiene-b-styrene (e.g. S-I/B-S and S-I/B-S/S-I/B and (S-I/B)n-X/S-I/B), styrene-b-ethylene/butylene-b-styrene (e.g. SEBS and SEBS/SEB and (SEB)n-X/SEB), styrene-b-ethylene/propylene-b-styrene (e.g. SEPS and SEPS/SEP and (SEP)n-X/SEP), styrene-butadiene random copolymer (e.g. SBR and (SBR)n-X), and combinations thereof.

In addition, the various adhesive, sealant or coating compositions of the present invention may include other additives known to those skilled in the art. These additives may include, but are not limited to, pigments, fillers, fluorescent additives, flow and leveling additives, wetting agents, surfactants, antifoaming agents, rheology modifiers, stabilizers, photosensitizers and antioxidants. Preferred additives are those which do not have appreciable absorption in the wavelengths of interest. Examples of pigments and filler materials include, but are not limited to, titanium dioxide, hydrophobic amorphous fumed silica, amorphous precipitated silica, carbon black, and polymer powders. Examples of flow and leveling additives, wetting agents, and antifoaming agents include silicones, hydrocarbons, fluorine-containing compounds, and non-silicone polymers and copolymers such as copolyacrylates.

The novel adhesive, sealant and coating compositions of the present invention may be prepared by conventional methods. As an example, the novel modified diene copolymer, the tackifying resin and other desired components may be blended at an elevated temperature, (e.g. temperature of about 150° C.) using an extruder, a Z-blade mixer or other conventional mixing device. Advantageously, the novel adhesive, sealant and coating compositions prepared with the modified diene copolymer of the present invention may be blended and applied at much lower temperature without sacrificing cost efficiency and/or production rate, and keeping the reinforcement properties such as cohesive strength. In some embodiments, reactive processing techniques may be used to perform post-polymerization reactions and/or crosslinking of the modified diene copolymer in the novel adhesive, sealant and coating compositions of the present invention.

The novel modified diene copolymer compositions provide adhesive, sealant, and coating applications with reactive sites susceptible to modification and cross-linkable moieties that allow photo-, thermal- and chemical-cured crosslinking. The reactive sites may directly perform crosslinking of the novel modified diene copolymer compositions and/or may be amenable to further functionalization that facilitates crosslinking under more suitable mild conditions during the application. The novel reactive adhesive, sealant, and coating compositions comprising the modified diene copolymer compositions of the present invention can be made and cured by any suitable method known in the art, such as those described in U.S. Pat. Nos. 8,703,860; 7,799,884; 7,432,037; 6,926,959, 5,804,663, and 4,306,049; and E.U. Patent No. 0097307, which are incorporated herein in their entirety by reference. Reinforced materials containing either the modified diene copolymer compositions or the polymer blends and mixtures containing the modified diene copolymers achieve a tailored compatibility and reactivity, and an improved balance between processability and reinforcement performance for various applications such as adhesives, sealants, and coatings. The novel modified diene copolymer compositions and their polymer blends and mixtures with other suitable polymers are useful for pressure and non-pressure sensitive, hot melt and solvent based formulations for taping, labeling, packaging, construction and positioning adhesive end-use applications, including solvent-based mastics and sealants. The novel modified diene copolymer compositions are useful for low viscosity and reactive hot-melt adhesive compositions, particularly for sprayable and contact adhesives with high heat resistance, low energy processability, and low emission of volatile organic compounds (VOCs) relative to solvent-based formulations. More specifically, the novel modified diene copolymer compositions provide the adhesives, sealants, and coatings applications with: tailored compatibility with formulation ingredients, reactive sites susceptible to modification, and cross-linkable moieties that allow photo-, thermal- and chemical-cured crosslinking; easy processing advantages such as low mixing temperature and low application temperature; and good reinforcement advantages such as high heat resistance, high cohesive strength and shear resistance, high tack and peel resistance.

The novel adhesive compositions comprising modified diene copolymers of the present invention may be radiation curable, which are amenable to a variety of end-uses including but not limited to pressure sensitive adhesives for high performance tapes and labels such as freezer-grade tapes and labels and automotive adhesives; and adhesive applications to wet surface such as medical applications. The radiation curable adhesive compositions can be formulated to exhibit high heat resistance, high peel values, improved cold temperature properties particularly at temperatures below 0° C., improved adhesion to wet surfaces and/or improved solvent and plasticizer resistance. The novel adhesive composition of the present invention may further comprise at least one second polymer in combination with the modified diene copolymer composition. The second polymer may contribute to adhesive properties such as tack and heat resistance and may be selected from: a second block copolymer; a homogeneous ethylene/alpha-olefin interpolymer, an amorphous polyalphaolefin, an interpolymer of ethylene, or mixtures thereof. Examples of useful commercially available second block copolymers include but are not limited to Solprene®, Calprene® and Calprene® H block copolymers, Kraton® D and G series block copolymers, Europrene® Sol T block copolymers, Vector® block copolymers, as well as others. Examples of suitable interpolymers of ethylene are ethylene/vinyl acetate (EVA), ethylene/methyl acrylate (EMA), ethylene n-butyl acrylate (EnBA), and mixtures thereof. The novel modified diene copolymer compositions and the second block copolymer may have increased vinyl configuration units in at least one conjugated diene homopolymer or copolymer block or segment to be even more radiation sensitive and curable to further contribute to adhesive properties such as high heat resistance and high shear resistance. Preferred second block copolymers for the novel adhesive compositions comprising modified diene copolymers of the present invention comprise at least one styrene-isoprene-styrene (SIS) block copolymer having a styrene content of less than about 25 wt % to improve tack while maintaining high heat resistance such as high shear adhesive failure temperature (SAFT) and/or high Ring and Ball softening point temperature (TRBSP).

In some embodiments, the novel adhesive compositions comprising modified diene copolymers of the present invention may advantageously have a Brookfield viscosity of less than about 10,000 cP at about 160° C., preferably less than about 8,000 cP at about 160° C., more preferably less than about 6,000 cP at about 160° C., and even more preferably less than about 4,000 cP at about 160° C., which allows the adhesive composition to be applied at a lower application temperature, i.e., an application temperature of no greater than about 150° C., preferably no greater than about 140° C., and more preferably no greater than about 130° C. Since the composition may exhibit a low viscosity at even lower temperatures, in the most preferred embodiments, the adhesive composition may be sufficiently fluid at about 120° C., which is amenable for coating to heat sensitive substrates and aids in preventing thermal degradation of the adhesive composition and extends the processing time window. The novel adhesive compositions of the invention comprising modified diene copolymer compositions can be formulated in such a way that the compositions exhibit good tack, improved heat resistance such as high shear adhesive failure temperature (SAFT) and/or high Ring and Ball softening point temperature (RBSPT), and improved plasticizer resistance. Preferably, the shear adhesion failure temperature (SAFT) and/or the Ring and Ball softening point temperature (RBSPT) is no less than about 150° C., and more preferably, no less than about 177° C., and the static shear is no less than about 24 hours after curing of the adhesive composition. The Loop Tack is typically at least about 2.0 lb/in, preferably about 3.0 lb/in or greater, and more preferably, about 4.5 lb/in or greater. For permanent grade presure sensitive adhesives, the 180° Peel value is typically at least about 2.5 lbs/linear inch (pli), preferably at least about 3.0 lbs/linear inch (pli), and more preferably at least about 4.0 lbs/linear inch (pli) or greater. The novel adhesive compositions of the invention comprising modified diene copolymer compositions may be bonded to a variety of substrates such as various films, nonwovens, paperstock, paperboard, plastics, metals, painted substrates, glass, leather, rubber, etc. The adhesive compositions of the invention are low in odor and can be used for various applications including for use as pressure sensitive adhesives for high performance tapes and labels, and particularly for automotive applications such as window labels and license plate tabs, sterilizable medical applications, freezer-grade labels, shrinkable label for contoured containers, hook and loop tapes, abrasive products, road marking tapes, foam bonding, bonding rubber gaskets to air filters and positioning adhesives. Further, both pressure sensitive as well as non-pressure sensitive adhesive compositions can be employed for film laminating and nonwoven construction applications such as disposable diaper construction as well as for wood flooring adhesives.

In some embodiments, the novel adhesive compositions of the invention comprising modified diene copolymer compositions may use modified diene copolymers that are low molecular weight liquid polymers at room temperature, which may be hydrogenated and may have any suitable terminal chain-end and/or in-chain functional groups such as epoxy, amine, hydroxy, acrylate, methacrylate, silane, mercaptan, and the like, that allow for additional chemical reactions to occur such as crosslinking, derivatization, and the like. They may be formulated and applied as liquids, in the absence of solvents for low VOC emissions, and develop molecular weight upon curing process that can be achieved by UV cure. Simple formulations consisting of mixtures of the hydrogenated liquid modified diene copolymer compositions containing epoxy and hydroxyl functionality, hydrogenated tackifying resins, and a small amount of photoinitiator may exhibit excellent pressure sensitive adhesive properties. Pressure sensitive adhesive formulations can be modified and enhanced with certain high molecular weight solid polymers to increase green strength, tensile strength, and convenient handling and coating of hot melt adhesives. Not only low styrene SEBS polymer and SEPS polymer may be used as the solid modifier, but also linear, low density copolymers of ethylene and higher alpha olefins. The novel adhesive compositions of the invention comprising liquid modified diene copolymer compositions and low styrene SEBS polymer may melt completely at about 120° C. The cured adhesives provide a range of tack, peel, shear values, and exhibit a minimal increase in peel adhesion with time or temperature. Suitable tackifying resins that may be used with hydrogenated modified diene copolymer compositions of the present invention include but are not limited to Regalite™ R-9100, Regalite™ R-125, and Arkon™ P-90. Regalite™ R-9100 and R-125 are fully hydrogenated tackifying resins produced by Eastman. Arkon™ P-90 is a fully hydrogenated tackifying resin produced by Arakawa.

In general, useful tackifiers or tackifying resins are either derived from renewable resources such as rosin derivatives including but not limited to wood rosin, tall oil, gum rosin as well as rosin esters and natural and synthetic terpenes, and derivatives of such; or are petroleum based resins such as hydrocarbon resins. Examples of useful hydrocarbon resins includes but are not limited to alpha-methyl styrene and other styrenic monomer based resins, branched and unbranched C5 resins, C9 resins, dicyclopentadiene (DCPD) based resins, as well as styrenic and hydrogenated modifications of such. Useful tackifiers typically range from being a liquid at about 25° C. to having a ring and ball softening point of up to about 150° C. Preferably, the adhesive compositions of the present invention comprise at least one tackifier that is compatible with the polydiene block. In some embodiments of the invention, the tackifiers are preferably rosin derivatives, particularly hydrogenated rosin based tackifiers and hydrogenated styrenated terpene resins. Useful commercially available tackifiers include but are not limited to, for example, Regalite® R 91, Regalite® R R101, Regalite® R S100, Regalite® R S260, Regalrez® 1018, Regalrez® Regalrez® 3102, Regalrez® 6108, Regalrez® 5095, Zonatac® Lite series such as Zonatac® 105 Lite, Escorez® 5300 series, Foral® AX, Foral® 85 and Foral® 105.

More specific examples of suitable conventional tackifiers or tackifying resins that may be added to the hot melt adhesive, sealant and coating compositions of the present invention include but are not limited to any compatible resins or mixtures thereof such as: (a) natural or modified rosins, for example, gum rosin, wood rosin, tall-oil rosin, distilled rosin, hydrogenated rosin, dimerized rosin, and polymerized rosin; (b) glycerol and pentaerythritol esters of natural or modified rosins, for example, glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (c) copolymers and terpolymers of natural terpenes, e.g., styrene-terpene and alpha methyl styrene-terpene; (d) polyterpene resins having a softening point of from about 80° to 150° C., also the hydrogenated polyterpene resins; (e) phenolic modified terpene resins and hydrogenated derivatives thereof; (f) aliphatic petroleum hydrocarbon resins having a softening point of from about 70° to 135° C., also the hydrogenated aliphatic petroleum hydrocarbon resins; (g) alicyclic petroleum hydrocarbon resins and the hydrogenated derivatives thereof; (h) aliphatic/aromatic or cycloaliphatic/aromatic copolymers and their hydrogenated derivatives; and (i) aliphatic/aromatic or cycloaliphatic/aromatic polyester polyols and their hydrogenated derivatives. Tackifiers for use herein include polyterpenes, aliphatic resins, cycloaliphatic resins, and aliphatic/aromatic or cycloaliphatic/aromatic. Also, aliphatic/aromatic or cycloaliphatic/aromatic copolymers and their hydrogenated derivatives. Additionally, it may be desirable to incorporate in the hot melt adhesive compositions of the present invention up to about 30 wt % of at least one end-block tackifier or tackifying resin, which may be a suitable polyester polyol tackifying resin. End-block tackifier or tackifying resins are primarily aromatic resins based on mixed C9 petroleum distillation streams such as materials commercially available from Eastman Chemical Company, or resins based on pure or mixed monomer streams of aromatic monomers such as homo or copolymers of vinyl toluene, styrene, alpha-methyl-styrene, coumarone or indene. Also, those based on alpha-methyl styrene available from Eastman Chemical Company under the Kristalex and Plastolyn trade names. If present, the at least one end-block tackifier or tackifying resin is generally used in an amount of from about 1 to about 30 wt %, preferably less than about 25 wt %. In some embodiments, preferred examples of conventional tackifiers or tackifying resins that may be added to the hot melt adhesive compositions of the present invention include but are not limited to Piccotac™ 9095, Piccotac™ 8095, Piccotac™ 1095-N, Foral® 85, Regalite™ R1100 Hydrocarbon resin and Kristalex™ 1120 Hydrocarbon resin from Eastman Chemical Company.

Additional specific examples of suitable conventional tackifiers or tackifying resins that may be added to the hot melt adhesive, sealant and coating compositions of the present invention include but are not limited to high performance polyester polyol tackifying resins such as aliphatic/aromatic or cycloaliphatic/aromatic polyester polyols and their hydrogenated derivatives. The high performance polyester polyol tackifying resins may be made from: virgin and/or recycled thermoplastic polyesters; recycled glycols and/or aliphatic diols; and dimer fatty acids and/or aliphatic dicarboxylic acids and/or aromatic dicarboxylic acids. The high performance polyester polyol tackifying resins may have from about 60 to 100% Green content. The high performance polyester polyol tackifying resins may have a hydroxyl number within the range of 25 to 800 mg KOH/g, preferably within the range of 14 to 112 mg KOH/g. The high performance polyester polyol tackifying resins may have from about 50 to 200° C. Ring and Ball softening point temperature. High performance polyester polyol tackifying resins may be prepared by the process described in published US patent application 2015/0344622 A1 and may be of the composition described in published US patent application 2017/0066950 A1. The entire disclosures of published US patent application 2015/0344622 A1 and published US patent application 2017/0066950 A1 are incorporated herein by reference. High performance polyester polyol tackifying resins are commercially available from Resinate Materials Group, Inc.

In preferred embodiments, the novel adhesives, sealants, and coatings compositions of the present invention comprising modified diene copolymer compositions alone or the polymer blends and mixtures containing the modified diene copolymers may use at least one suitable conventional tackifier or tackifying resin including but not limited to aliphatic resins, aromatic modified hydrocarbon resins, rosin ester resins, mixtures and combinations thereof. The novel modified diene copolymer compositions of the present invention may: not only be useful to prepare reinforced materials containing either the modified diene copolymer compositions alone or the polymer blends and mixtures containing the modified diene copolymers to achieve a tailored compatibility and reactivity for various applications such as adhesives, sealants, and coatings; but also be amenable to adjust compatibility for each block or segment in the modified A-B-C or C-B-A copolymer to provide either full-, partial-, limited-compatibility or incompatibility with either a suitable conventional tackifier or tackifying resin, or mixtures and combinations of suitable conventional tackifiers or tackifying resins including but not limited to aliphatic resins, aromatic modified hydrocarbon resins, and rosin ester resins. In more preferred embodiments, the novel adhesive, sealant and coating compositions of the present invention comprising modified diene copolymer compositions alone or the polymer blends and mixtures containing the modified diene copolymers, wherein the compatibility for each block or segment in the modified A-B-C or C-B-A copolymer is adjusted to provide either full-, partial-, limited-compatibility or incompatibility with at least one first suitable conventional tackifier or tackifying resin, wherein at least one second suitable conventional tackifier or tackifying resin provides either full-, partial-, limited-compatibility or incompatibility with each block or segment in the polymer that is blended or mixed with the modified diene copolymer composition, wherein the at least one first and at least one second suitable conventional tackifiers or tackifying resins include but are not limited to aliphatic resins, aromatic modified hydrocarbon resins, and rosin ester resins. In most preferred embodiments, the novel adhesive, sealant and coating compositions of the present invention comprising modified diene copolymer compositions alone or the polymer blends and mixtures containing the modified diene copolymers, wherein the compatibility for each block or segment in the modified A-B-C or C-B-A copolymer is adjusted to provide either full-, partial-, limited-compatibility or incompatibility with at least one first suitable conventional tackifier or tackifying resin, wherein the at least one first suitable conventional tackifier or tackifying resin also provides either full-, partial-, limited-compatibility or incompatibility with each block or segment in the polymer that is blended or mixed with the modified diene copolymer composition, wherein the at least one first suitable conventional tackifier or tackifying resin include but are not limited to aliphatic resins, aromatic modified hydrocarbon resins, and rosin ester resins.

Full-compatibility provides the reinforced materials with modifying effect on specific blocks or segments in the whole application temperature range of the the novel adhesive, sealant and coating compositions of the present invention comprising the modified diene copolymer compositions alone or the polymer blends and mixtures containing the modified diene copolymers. Partial-compatibility provides the reinforced materials with modifying effect on specific blocks or segments at high temperature but not at low temperature for the application of the novel adhesive, sealant and coating compositions of the present invention comprising the modified diene copolymer compositions alone or the polymer blends and mixtures containing the modified diene copolymers. Limited-compatibility provides the reinforced materials with modifying effect on specific blocks or segments up to a maximum concentration and/or partition in the blocks or segments in the modified A-B-C or C-B-A copolymers and/or in the blocks or segments in the polymer that may be blended or mixed with the modified diene copolymer composition. Incompatibility provides the reinforced materials with no modifying effect on specific blocks or segments in the whole application temperature range of the novel adhesive, sealant and coating compositions of the present invention comprising the modified diene copolymer compositions alone or the polymer blends and mixtures containing the modified diene copolymers. The novel modified diene copolymer compositions provide the adhesive, sealant and coating compositions of the present invention: with tailored and/or adjusted compatibility with at least one suitable tackifier or tackifying resin and/or with at least one suitable polymer in the blends or mixtures; and with the design tool for manipulating the properties and obtain the surprising and unexpected effects on processability and reinforcement performance. In some embodiments, preferred examples of useful commercially available polymers that may be added to the adhesive, sealant and coating compositions of the present invention include but are not limited to Solprene®, Calprene® and Calprene® H block copolymers, Kraton® D and G series block copolymers, Europrene® Sol T block copolymers, Vector® block copolymers, as well as others. In some embodiments, preferred examples of useful conventional tackifiers or tackifying resins that may be added to the adhesive, sealant and coating compositions of the present invention include but are not limited to Piccotac™ 9095, Piccotac™ 8095, Piccotac™ 1095-N, Foral® 85, Regalite™ R1100 Hydrocarbon resin and Kristalex™ 1120 Hydrocarbon resin from Eastman Chemical Company.

The hot melt adhesive, sealant and coating compositions of the present invention may optionally include a conventional oil and/or other liquid diluent which is primarily aliphatic in character and is compatible with the midblock of the block copolymer that may optionally be included in the formulation, and may be compatible with the less aromatic block or segment in the modified A-B-C or C-B-A copolymer. When present, the compositions of the invention will typically comprise the liquid plasticizer in amounts of less than about 35 wt %. When liquid plasticizer is present, the adhesive, sealant or coating composition will comprise at least about 5 wt %, more typically at least about 15 wt % of a liquid plasticizer. Examples of conventional oils that may be used in the hot melt adhesive, sealant and coating compositions of the present invention include plasticizers such as paraffinic and naphthenic petroleum oils, highly refined aromatic-free paraffinic and naphthenic food and technical grade white petroleum mineral oils, and liquid tackifiers such as the synthetic liquid oligomers of polybutene, polypropene, polyterpene, polymyrcene, polyfarnesene, and the like. The synthetic series process oils are high viscosity oligomers which are permanently fluid liquid monolefins, isoparaffins or paraffins of moderate to high molecular weight. Also, there may be present a wax such as the polyethylene waxes. The wax is generally present in an amount of at least about 2 wt %, up to about 5%. Preferred examples of conventional oils or liquid plasticizers that may be added to the hot melt adhesive, sealant and coating compositions of the present invention include highly refined, high viscosity naphthenic process oil grades such as Nyflex 223, which are commercially available naphthenic process oils from Nynas. In some additional embodiments, suitable plasticizing or extending oils include olefin oligomers and low molecular weight polymers as well as vegetable and animal oil and their derivatives. The petroleum derived oils which may be employed are relatively high boiling materials containing only a minor proportion of aromatic hydrocarbons. Alternatively, the oil may be totally non-aromatic. Suitable conventional oligomers include polypropylenes, polybutenes, hydrogenated polyisoprene, hydrogenated polybutadiene, or the like having average molecular weights between about 0.35 kg/mol and about 10 kg/mol. Examples include but are not limited to Luminol T350 a mineral oil available from Petrocanada and Kaydol oil available from Witco Corporation. Other commercially available preferred plasticizers include but are not limited to Isolene@, Isolene® 75, and Isolene® 400 from Elementis Specialty. In other additional embodiments, novel adhesive, selant and coating compositions of the present invention that can be applied at low application temperatures and exhibit good cold temperature performance and good adhesion to wet surfaces, comprise at least one plasticizer that is compatible with the vinyl aromatic block. Useful commercially available vinyl aromatic block plasticizers include but are not limited to Piccolastic® A5 from Hercules and Kristalex® 3070.

The novel adhesive compositions comprising the modified diene copolymers of the present invention useful for bottle-labeling, laminating, bookbinding, and packaging adhesives, wherein pressure sensitivity is undesirable, may include waxes in the formulations that may be employed in the radiation curable adhesive compositions of the invention. Waxes are commonly used to modify the viscosity and reduce tack at concentrations of up to about 40 wt %, and preferably from about 10 wt % to about 40 wt %, based on the total weight of the composition. Preferred waxes are those having a minimum amount of unsaturation and include but are not limited to Paraffin 45 wax and Paraffin 155F, which exhibit a sufficiently low amount of UV absorbing components. Other waxes may also be useful provided the adhesive composition is cured at a temperature above the cloud point of the wax.

The novel adhesive, sealant and coating compositions comprising modified diene copolymers of the present invention that may be radiation curable can be formulated with suitable coupling or crosslinking agents that include but are not limited to polyfunctional acrylates and methacrylates; polyfunctional epoxides; reactive additives such as the synthetic liquid epoxidized oligomers of polyterpene, polyisoprene, polymyrcene, polyfarnesene, and the like. In some embodiments of the present invention, carbofunctional silanes may be used as coupling and functionalizing agents with a general formula XnSi(R′Y)4-n, where: R′ is an alkylene chain, Y is a functional group such as: Cl, NH2, NR2, OH, OCOR, NCO, CH2=CH, SH, and X is a functional group sensitive to hydrolysis (Cl, OR, OCOR). Alkylene chain R′ is usually built of three methylene groups. Suitable examples of carbofunctional silanes include but are not limited to (methacryloxypropyl)-silanes, (aminoalkyl)-silanes and (3-aminopropyl)-silanes, and other types of silanes, including aliphatic or aromatic silanes, amino silanes, epoxy silanes, and other functionalized silanes. In additional embodiments of the present invention, suitable silane coupling agents that may be used as coupling and functionalizing agents in the adhesive, sealant and coating compositions of the present invention include but are not limited to 3-mercaptopropyl trialkoxy silane, bis-(3-trialkoxysilylpropyl)-disulfide, bis-(3-trialkoxysilylpropyl)-tetrasulfide, 3-mercaptopropyl triethoxy silane (MPTES), bis-(3-triethoxysilylpropyl)-disulfide (TESPD), bis-(3-triethoxysilylpropyl)-tetrasulfide, 3-mercaptopropyl trimethoxysilane (MPTMS), bis-(3-trimethoxysilylpropyl)-disulfide (TMSPD), bis-(3-trimethoxysilylpropyl)-tetrasulfide (TMSPT), mixtures and combinations thereof. Examples of preferred silane coupling agents are mercaptopropyltriethoxysilane (MPTES), bis-(3-triethoxysilylpropyl)-disulfide (TESPD), bis-(3-trimethoxysilylpropyl)-disulfide (TMSPD), bis-(3-trimethoxysilylpropyl)-tetrasulfide (TMSPT), 3-mercaptopropyl trimethoxy silane (MPTMS), and their derivatives of ethoxysilanes and chlorosilanes. Other suitable silane coupling agents include but are not limited to silane functionalized silicon compounds that can be used to perform crosslinking by in-chain hydrosilylation reactions on the polymer chain of the modified diene copolymer compositions, and attach either functional groups and/or other polymer side chains to the main chain. Specific examples of suitable functionalized silicon and tin compounds, and silane coupling agents such as the ones listed in U.S. Pat. Nos. 6,229,036, 8,053,512 and PCT Patent Application WO 2018/091955. The entire disclosures of U.S. Pat. Nos. 6,229,036, 8,053,512 and PCT Patent Application WO 2018/091955 are incorporated herein by reference. Examples of sulfanylsilanes are: (EtO)3-Si-(CH2)3-S-Si(CH3)3, [(EtO)3-Si-(CH2)3-S]2-Si(CH3)2, [(EtO)3-Si-(CH2)3-S]3-Si(CH3), [(EtO)3-Si-(CH2)3-S]2-Si(OEt)2, [(EtO)3-Si-(CH2)3-S]4-Si, (EtO)3-Si-(CH2)3-S-Si(OEt)3, (MeO)3-Si-(CH2)3-S-Si(C2H5)3, (MeO)3-Si-(CH2)3-S-Si(CH3)3, [(MeO)3-Si-(CH2)3-S]2-Si(CH3)2, [(MeO)3-Si-(CH2)3-S]2-Si(OMe)2, [(MeO)3-Si-(CH2)3-S]4-Si, [(MeO)3-Si-(CH2)3-S]3-Si(OMe), and similar C1-C100 linear or branched, alkyl or alkoxy or cycloalkyl or cycloalkoxy or phenyl or benzyl substituted sulfanylsilanes compounds, including but not limited to silicon sulfide modifiers and tin sulfide modifiers, and functionalized and modified versions such as nitrile, amine, NO, alkoxy, thioalkyl, mercaptan, monosulfide, disulfide and tetrasulfide compounds.

The adhesive, sealant and coating compositions of the present invention may comprise photo-cured formulations that include but are not limited to rubber, thiol-ene, maleimide and acrylate base resins. Photo-curable formulations include but are not limited to thiol-ene compositions comprising a multifunctional thiol, a multifunctional olefin, and the photoinitiators. Suitable crosslinking agents that may be used in the photo-curable compositions include but are not limited to polythiol or poly(maleimide) crosslinking agents. For UV-curable compositions, the polythiol may be present in a concentration of up to about 10 percentage by weight, preferably from 0.3 to about 6 percentage by weight, and more preferably from about 0.3 to about 1 percentage by weight based on total weight of rubber and polythiol in the formulation. The most reactive primary thiols are preferred, followed by secondary thiols, and then the least reactive tertiary thiols. Suitable polythiols include but are not limited to 3-mercaptopropionic acid, pentaerythritol tetrathiolglycolate, pentaerythritol tetrakis(3-mercaptopropionate), trimethylolethane trimercaptopropionate, trimethylolpropane trithioglycolate, trimethylolpropane tris(3-mercaptopropionate), ethyleneglycol bis(thioglycolate), ethyleneglycol bis(3-mercaptopropionate), trimethylolpropane tris(thioglycolate), pentaerythritol tetrakis(thioglycolate), combinations and mixtures thereof.

The novel adhesive, sealant and coating compositions comprising modified diene copolymers of the present invention that may be radiation curable can be formulated with suitable photoinitiators to generate crosslinking and/or polymerization initiating radicals when the photoinitiator is irradiated with a source of light. The suitable photoinitiators include but are not limited to photoinitiators classified into photo-cleavage photoinitiators and H-abstraction photoinitiators according with the pathways by which the effective initiating radicals are generated. Hydrogen-donor sources for H-abstraction photoinitiators include amines, thiols, unsaturated rubbers such as polybutadiene or polyisoprene, and alcohols. In radiation-curable compositions, crosslinking occurs by exposure to ultraviolet radiation and/or ionizing radiation created by the emission of electrons or highly accelerated nuclear particles such as neutrons, alpha-particles, and the like. The light absorbing chromophores used in the photoinitiator system are chosen to match as closely as possible the emission bands of the light source. The chromophores present in the photoinitiators renders them sensitive to ultraviolet and/or visible irradiation and thus capable of initiating and/or participating in crosslinking upon exposure to such a source of light. Suitable photoinitiators containing chromophores compounds that undergo H-abstraction photochemistry include but are not limited to benzophenone and related aromatic ketones such as xanthone, thioxanthone, 4,4′-bis(N,N′-dimethylamino)benzophenone, benzil, quinones, quinoline, anthroquinone, fluorene, acetophenone, xanthone, phenanthrene and fluorenone. Suitable photoinitiators may typically be used in amounts of from about 0.05 wt % to about 10 wt % of the formulated composition, preferably in amounts ranging from about 0.2 wt % to about 3 wt %, more preferably from about 0.5 wt % to about 1.5 wt %. The specific amount of the suitable photoinitiator useful in the formulation is dependent on the polymeric composition, as well as the source of radiation, the amount of radiation received, the production line speed, and the thickness of the adhesive, sealant or coating composition on the substrate.

In additional embodiments, the adhesive, sealant or coating composition compositions of the present invention may be crosslinked by ultraviolet (UV) or electron beam (EB) radiation in air or nitrogen atmospheres by exposing to ultraviolet radiation having a wavelength within the range of 180 to 400 nm, preferably 200 to 390 nm, for a time sufficient to accomplish the desired amount of crosslinking. It is important to match the UV light emission wavelength to the adsorption wavelength of the photoinitiator. The exposure time is dependent upon the nature and intensity of the radiation, the specific ultraviolet photoinitiator and amount used, the polymer system, the thickness of the film, environmental factors, and the distance between the radiation source and the adhesive film. Irradiation may be carried out at any temperature, and most suitably is carried out at room temperature. For UV curing compositions, one or more photoactive initiators and/or photoactive coupling agents may be added to the adhesive, sealant or coating compositions of the present invention. To cure the adhesive, sealant or coating composition of the present invention, a source of actinic radiation of sufficient energy may be used to generate free radicals when incident upon the specific photoinitiator selected for use in the composition. The preferred wavelength ranges for the photoinitiators is 400 to 250 nm. Suitable photocure processes are disclosed in U.S. Pat. Nos. 4,181,752 and 4,329,384, which are incorporated herein by reference. Suitable photoinitiator examples include but are not limited to aldehydes, benzaldehyde, acetaldehyde, and their substituted derivatives; ketones such as acetophenone, benzophenone, and their substituted derivatives, particularly the 4-alkylbenzophenones wherein the alkyl group has 1 to 18 carbon atoms; quinones such as benzoquinone, anthraquinone, and their substitutes derivatives; thioxanthones, such as 2-isopropylthioxanthone and 2-dodecylthioxanthone; and certain chromophore-substituted halomethyl-sym-triazines, such as 2,4-bis (trichloromethyl)-6-(3′,4′-dimethoxyphenyl)-sym-triazine. Alpha-cleavage type photoinitiators are known in the art. Commercial examples include but are not limited to Irgacure 184 and Darocur 1173, both available from Ciba-Giegy. Preferred radical type photoinitiators include but are not limited to acylphosphine oxides, bisacrylphosphine oxides, combinations and mixtures thereof. Useful commercially available examples include but are not limited to Irgacure® 819, Irgacure® 1800, and Irgacure® 1850 from Ciba; and Lucirin TPO from BASF. For electron-beam (EB) radiation curing, photoactive coupling agents may not be needed to crosslink the adhesive, sealant or coating compositions comprising the modified diene copolymer of the present invention. The compositions of the invention may also be cured by means of electron-beam (EB) radiation without using photoinitiators. The dosage needed to crosslink the compositions may vary depending on the specific composition but generally ranges from about 1 to about 20 Mrads, preferably from about 2 to about 10 Mrads. Suitable processes for electron-beam (EB) curing can be found in U.S. Pat. No. 4,533,566, which is incorporated herein by reference. The radiant energy density and thus, the line speed for sufficient curing is dependent on the composition and more importantly the thickness of the adhesive film being cured.

The radiation curable hot melt adhesive, sealant and coating compositions of the present invention comprising a novel modified diene copolymer composition and/or a second block copolymer with increased vinyl configuration units in at least one conjugated diene homopolymer or copolymer block or segment to be even more radiation sensitive and curable to further contribute to reinforcement performance properties such as high heat resistance and high shear resistance, further comprising at least one of the conventional ingredients in a typical formulation such as tackifying resin, extender oil and/or plasticizer, petroleum derived waxes, antioxidant, photosensitizer (in case of UV irradiation curing), and optionally a resin which is compatible with the vinyl aromatic block or segment, may be cured by exposure to high energy ionizing radiation such as electron beam radiation or by UV radiation. The crosslinking reaction is conveniently effected at room temperature, but it can be conducted at depressed or elevated temperatures, under an inert atmosphere to prevent interference in the block copolymer crosslinking at an exposed surface, or by irradiation through the release paper or the substrate to protect the exposed surface. Suitable dosages of electron beam irradiation are in the range from 0.5 to 8 Mrad, preferably about 4 Mrad to about 8 Mrad, and more preferably about 6 Mrad to about 8 Mrad. When ultraviolet light is contemplated, the adhesive composition will be formulated with from 0.2 to 30 parts by weight of an ultraviolet sensitising component (photoinitiator) per 100 parts by the weight of the block copolymer. The length of the exposure required is dependent on the intensity of the radiation, the amount and specific type of the ultraviolet sensitizing compound employed, the thickness of the adhesive layer, etc. The exposure to UV irradiation may be performed by any known method. A suitable method is exposing a sample either in a layer obtained from a hot melt or in a layer obtained by solvent coating to UV irradiation by passing said sample at a certain speed underneath the UV source. The photoinitiators may preferably be included in an amount in the range of from 1 to 10 parts by weight per 100 parts by weight of block copolymer, and more preferably in an amount in the range of from 1 to 5 parts by weight. Examples of suitable compounds include but are not limited to benzophenone, 2,4,6-trimethylbenzophenone, 4-methylbenzophenone and an eutactic mixture of 2,4,6-trimethylbenzophenone and 4-methylbenzophenone (Esacure TZT) and 2,2-dimethoxy-1,2-diphenylethan-1-one (Irgacure 651). These compounds may be employed in combination with tertiary amines (Uvecryl 7100). Additional suitable compound that may be used 2-methyl-1-4-(methylthio)-phenyl-2-morpholinopropanone-1 (Irgacure 907) and Uvecryl P115. An example of suitable mixtures is a mixture of 15% by weight of a mixture of 2-isopropylthioxanthone and 4-isopropylthioxanthone and 4-isopropylthioxanthone, and 85% by weight of a mixture of 2,4,6-trimethylbenzophenone and 4-methyl-benzophenone (Esacure X15). The photoinitiator may be selected from the group consisting of (i) benzophenone, (ii) a mixture of benzophenone and a tertiary amine containing a carbonyl group which is directly bonded to at least one aromatic ring, (iii) 2-methyl-1-4-(methylthio) phenyl)-2-morpholinopropanone-1 (Irgacure 907), and (iv) 2,2-dimethoxy-1,2-diphenylethan-1-one (Irgacure 651). Preferred uses of the present formulation are in the preparation of pressure-sensitive adhesive tapes and in the manufacture of labels. The backing sheets may be a plastic film, paper, or any other suitable materials and the tape may include various other layers or coatings, such as primers, release coatings, and the like, which are used in the manufacture of pressure-sensitive adhesive tapes.

In another aspect of the invention, the novel modified diene copolymer compositions may be useful for radiation cured hot melt pressure sensitive adhesive, radiation cured sealant and radiation cured coating compositions, and to articles of manufacture comprising the cured adhesive, sealant and/or coating compositions. Suitable photoinitiators may be used to prepare pressure sensitive hot melt adhesives, sealant and coating compositions that include but are not limited to decorative and abrasion resistant coatings, lacquers, fiber reinforced composites, microelectronic encapsulations, die-attach, fiber optic coatings, molding compounds, UV-set structural resins and the like. Suitable base resins for use in formulating the adhesives, sealants and coating compositions of the present invention are well known to those skilled in the art. Useful polymers include amorphous polyolefins, ethylene-containing polymers and rubbery block copolymers, as well as blends and mixtures thereof. Suitable base resins may be based on acrylate, epoxide, siloxane, styryloxy, vinyl ether and other monomers, oligomers, prepolymers and/or polymers and hybrids, mixtures and combinations thereof. The adhesives, sealants and coating compositions of the present invention may be formulated with liquid or solid olefinically unsaturated systems, such as acrylates, methacrylates, maleimides, styrenics, maleate esters, fumarate esters, unsaturated polyester resins, alkyl resins, polyisoprene, polybutadiene and thiol-ene compositions.

The hot melt adhesive, sealant and coating compositions of the present invention may optionally also include a conventional antioxidant, which may be present in an amount of up to about 4 wt %. Examples of useful stabilizers or antioxidants utilized herein include but are not limited to high molecular weight hindered phenols and multifunctional phenols such as sulfur and phosphorous-containing phenols. Hindered phenols are well known to those skilled in the art and may be characterized as phenolic compounds which also contain sterically bulky radicals in close-proximity to the phenolic hydroxyl group thereof. Some representative examples of hindered phenols include: 1,3,5-trimethyl 2,4,6-tris(3,5-di-tert-butyl-4-hydroxybenzyl)benzene:pentaerythrityl-tetrakis-3(3,5-di-tert-butyl-4-hydroxyphenyl)-propionate; 4,4′-methylenebis(2,6-tert-butylphenol); 4,4′-thiobis(6-tert-butyl-o-cresol); 2,6-di-tert-butylphenol; 6-(4-hydroxyphenoxy)-2,4-bis(n-octylthio)-1,2,5-triazine; di-n-octadecyl3,5-di-tert-butyl-4-hydroxybenzylphosphonate: 2-(n-octylthio)ethyl3,5-di-tert-butyl-4-hydroxybenzoate: and sorbitol hexa3-(3,5-di-tert-butyl-4-hydroxyphenyl)-propionate. Preferred examples of conventional antioxidants that may be added to the compositions of the present invention include Irganox 1010 from BASF.

Other aspects of the invention provide reinforced materials compositions comprising the novel hot melt adhesive, sealant or coating compositions containing the modified diene copolymers of the present invention, and articles made from the reinforced materials compositions. In one embodiment, the article comprises the novel hot melt adhesive, sealant or coating composition and a substrate. In another embodiment, the substrate comprises a plastic film, an elastomeric fiber, a nonwoven material, a packaging material, or a construction material such as: shoesole material, furniture material and bookbinding material. Articles of the invention include but are not limited to disposable nonwoven such as femine pads and disposable elastic articles such as diapers, and pressure sensitive adhesive articles such as repositionable/removable tapes and labels, low/freezing temperature tapes and labels, and automotive protector films. In another embodiment, the novel hot melt adhesives of the invention are also useful as construction adhesives, e.g., for the manufacture of disposable goods, are particularly well suited for use in elastic attachment applications, and may advantageously be used in pressure sensitive end-use applications such as label and tape applications, particularly at low/freezing temperature. The novel hot melt adhesives of the invention are thus particularly useful in making elastic nonwovens and in the fabrication of baby diapers, training pants, adult incontinence briefs or undergarments, and the like. Nonwovens are used commercially for disposable articles such as diapers, adult incontinent products and sanitary napkins.

Asphalt or Bitumen Reinforcement

Asphalt or bitumen modification with high molecular weight elastomers is typically used to prepare modified asphalt binders with improved performance over unmodified asphalt binders. Performance properties of asphaltic products that are improved with the addition of polymers are: a) flexibility at low temperatures; b) resistance to flow and deformation at high temperatures; c) temperature susceptibility; d) tensile strength; e) stiffness modulus at high temperatures; f) asphalt-aggregate adhesion; g) resistance to surface abrasion. Asphaltic products that benefit from modification with polymers are pavement binders, seal coats, highway joint sealants, waterproofing membranes, coatings, pipeline mastics, pipeline wrapping tapes, and others.

Since high molecular weight polymers have the tendency to be immiscible with asphalt, asphalt modification with elastomers based on vinyl aromatic and conjugated diene monomers is complicated by limited phase stability, which results in asphalt-polymer separation that negatively affects the performance properties of the asphaltic products. Phase stability has been typically improved either by crosslinking the asphalt-polymer blend or by increasing the compatibility of the polymer with asphalt, or by both. High molecular weight polymers also adversely affect the processing characteristics of the modified asphalt binders by significantly increasing the melt viscosity of the asphalt-polymer blends. Modification of polymer composition and/or structure in prior art has been used to improve processing characteristics and reduce the cost of asphalt-polymer blends, but often performance properties are unfavorably modified.

The inventors have discovered that the addition of modified diene copolymer compositions provided herein into asphalt improves the processing characteristics without diminishing the performance properties of the modified asphalt as compared with the modified asphalt formulated with prior art copolymers. The modified diene copolymer compositions of the present invention provide the asphalt blends with lower melt viscosity and high flow; increased dispersibility and compatibility; higher blend stability; and good elastomeric and thermoplastic properties. The present invention provides polymer modified asphalt or bitumen compositions (PMA or PMB) comprising the modified diene copolymers that exhibit easy processing advantages such as short dispersion time, low mixing temperature, low viscosity, and excellent storage stability; and good reinforcement advantages such as high elastic response, wide range of performance grade, high ductility and penetration, good compromise between high and low temperature properties, and self-healing behavior. It has also been discovered that the modified diene copolymer compositions of the present invention can be used as compatibilizing or reinforcing agents in the novel polymer modified asphalt compositions of the present invention. The present invention provides polymer modified asphalt or bitumen compositions (PMA or PMB) comprising the modified diene copolymers that may benefit from the compatibilizing or reinforcing agent effect for applications that include but are not limited to those commonly used for road paving, roofing and sealant applications. It has also been discovered that the compatibilizing or reinforcing agents provided herein can be encapsulated and blended with commercially available block copolymers to improve phase stability and processing characteristics of the modified asphalt or bitumen blend. Paving applications include but are not limited to reinforcement of asphalt or bitumen cements/binders used for making asphalt or bitumen concrete for road construction, as well as modification of materials for road rehabilitation, repair and maintenance, including chip sealing, resealing, resurface and recycling. Roofing applications include but are not limited to reinforcement of roof shingles, as well as modification of materials for roof waterproofing, repair and maintenance.

The present invention provides polymer modified asphalt or bitumen emulsion compositions (PME or PMAE or PMBE) comprising the modified diene copolymers that also exhibit easy processing advantages such as short dispersion time, low mixing temperature, low viscosity, and excellent storage stability; and good reinforcement advantages such as high elastic response, wide range of performance grade, high ductility and penetration, and good compromise between high and low temperature properties. The inventors have also discovered that emulsions of asphalt or bitumen previously modified with the modified diene copolymer compositions of the present invention improve asphalt adherence to aggregate particles when used for road rehabilitation, repair and maintenance.

The novel asphalt or bituminous composition comprising at least one modified diene copolymer of the present invention useful for paving and/or roofing applications may comprise at least one asphalt or bitumen; and at least one additive selected from the group consisting of: plasticizers; fillers; coupling agents; crosslinking agents; photoinitiators; flow resins; tackifying resins; processing aids; antiozonants; and antioxidants, wherein the asphalt or bituminous composition includes from about 0.5 to about 25 percentage by weight of the at least one modified diene copolymer composition. The novel asphalt or bituminous composition comprising the at least one modified diene copolymer of the present invention may further comprise at least one commercially available polymer. The novel asphalt or bituminous composition comprising the at least one modified diene copolymer of the present invention, wherein the conjugated diene units in the modified diene copolymer composition are selectively-, partially- or fully-hydrogenated. The novel asphalt or bituminous composition comprising the at least one modified diene copolymer of the present invention, wherein any of the homopolymer or copolymer blocks or segments in the modified diene copolymer composition is chain-end, in-chain, or both chain-end and in-chain functionalized. Both, the at least one modified diene copolymer composition and the at least one commercially available polymer may be fully- partially- or selectively-hydrogenated version of the precursor unhydrogenated copolymer. Both, the at least one modified diene copolymer composition and the at least one commercially available polymer may be chain-end, in-chain, or both chain-end and in-chain functionalized version of the precursor unfunctionalized copolymer.

The novel asphalt or bituminous composition comprising at least one modified diene copolymer of the present invention useful for sealant and/or coating applications may comprise at least one asphalt or bitumen; and at least one additive selected from the group consisting of: plasticizers; fillers; coupling agents; crosslinking agents; photoinitiators; flow resins; tackifying resins; processing aids; antiozonants; and antioxidants, wherein the asphalt or bituminous composition includes from about 0.5 to about 50 percentage by weight of the modified diene copolymer composition. The novel asphalt or bituminous composition comprising the at least one modified diene copolymer of the present invention may further comprise at least one commercially available polymer. The novel asphalt or bituminous composition comprising the at least one modified diene copolymer of the present invention, wherein the conjugated diene units in the modified diene copolymer composition are selectively-, partially- or fully-hydrogenated. The novel asphalt or bituminous composition comprising the at least one modified diene copolymer of the present invention, wherein any of the homopolymer or copolymer blocks or segments in the modified diene copolymer composition is chain-end, in-chain, or both chain-end and in-chain functionalized. Both, the at least one modified diene copolymer composition and the at least one commercially available polymer may be fully- partially- or selectively-hydrogenated version of the precursor unhydrogenated copolymer. Both, the at least one modified diene copolymer composition and the at least one commercially available polymer may be chain-end, in-chain, or both chain-end and in-chain functionalized version of the precursor unfunctionalized copolymer.

The novel asphalt or bituminous composition comprising at least one modified diene copolymer of the present invention useful for paving, roofing, sealant and/or coating applications, wherein the novel asphalt or bituminous composition comprise at least one asphalt or bitumen, and wherein the at least one modified diene copolymer composition comprises a total vinyl aromatic monomer content between 10 and 55 wt % and a total conjugated diene monomer content between 45 and 90 wt %.

The present invention also provides a process for making polymer modified asphalt or bitumen (PMA or PMB) compositions, comprising: heating an asphalt to soften the asphalt, wherein the asphalt is agitated while being heated; and

adding and dispersing at least one novel modified diene copolymer composition in the asphalt or bitumen, thereby forming the PMA or PMB compositions; wherein the PMA or PMB composition may optionally be crosslinked by thermal treatment such as exposure to high temperature while mixing during long period of time; and wherein the PMA or PMB thermal crosslinking may be promoted by the presence of at least one conventional crosslinking agent and/or at least one silane or tin coupling agent and/or at least one functionalized silane or tin coupling agent.

The present invention also provides a process for making polymer modified asphalt or bitumen emulsion (PME or PMAE or PMBE) compositions, comprising: heating an asphalt to soften the asphalt, wherein the asphalt is agitated while being heated; adding and dispersing at least one novel modified diene copolymer composition in the asphalt or bitumen, thereby first forming a PMA or PMB compositions; further comprising at least one emulsifying agent, then heating water in a vessel; mixing the at least one emulsifying agent into the water in the vessel; adding an acid into the vessel, thereby forming an aqueous emulsifier solution; and mixing the aqueous emulsifier solution with the PMA or PMB composition, wherein the PMA or PMB composition is emulsified in water; thereby forming the polymer modified asphalt or bitumen emulsion (PME or PMAE or PMBE); wherein a PMA or PMB residual may be recovered to test and/or deposited on a surface after application of the polymer modified asphalt or bitumen emulsion on the surface and complete evaporation of water; wherein before emulsifying, the PMA or PMB composition may optionally be crosslinked by thermal treatment such as exposure to high temperature while mixing during long period of time; and wherein the PMA or PMB thermal crosslinking may be promoted by the presence of at least one conventional crosslinking agent and/or at least one silane or tin coupling agent and/or at least one functionalized silane or tin coupling agent.

The novel modified diene copolymer compositions provide polymer modified asphalt or bitumen (PMA or PMB) and/or polymer modified asphalt or bitumen emulsions (PME or PMAE or PMBE) applications with reactive sites susceptible to modification and cross-linkable moieties that allow photo-, thermal- and chemical-cured crosslinking. The reactive sites may directly perform crosslinking of the novel modified diene copolymer compositions and/or may be amenable to further functionalization that facilitates crosslinking under suitable mild conditions. The novel reactive polymer modified asphalt or bitumen (PMA or PMB) and/or polymer modified asphalt or bitumen emulsions (PME or PMAE or PMBE) compositions can be made and cured by any suitable method known in the art, such as those described in U.S. Pat. Nos. 9,115,296; 8,703,860; 7,432,037; and 4,306,049; U.S. Patent Application No. 2012/0123028 and E.U. Patents No. 2,459,621, and 0,097,307, which are incorporated herein in their entirety by reference. Reinforced materials containing either the modified diene copolymer compositions or the polymer blends and mixtures containing the modified diene copolymers achieve a tailored compatibility and reactivity, and an improved balance between processability and reinforcement performance for various applications such as asphalt/bitumen modification and their emulsions for road paving, roofing, shingles and waterproofing membranes, and wherein more specifically, the novel modified diene copolymer compositions provide the above mentioned applications with: tailored compatibility with formulation ingredients, reactive sites susceptible to modification, and cross-linkable moieties that allow photo-, thermal- and chemical-cured crosslinking; easy processing advantages such as short dispersion time, low mixing temperature, low viscosity, and excellent storage stability; and good reinforcement advantages such as high elastic response, wide range of performance grade, high ductility and penetration, good compromise between high and low temperature properties, and self-healing behavior.

The novel asphalt or bitumen compositions comprising at least one modified diene copolymer of the present invention may be curable, which are amenable to a variety of end-uses including but not limited to polymer modified asphalt or bitumen (PMA or PMB) for high performance road paving, roofing and coating applications; and polymer modified asphalt or bitumen applications for premium performance applications. The curable PMA or PMB compositions can be formulated to exhibit at least one of the following performance properties: high heat resistance, improved cold temperature properties particularly at temperatures below 0° C., improved adhesion to wet surfaces, improved solvent and plasticizer resistance, and the like. The novel asphalt or bitumen composition of the present invention may further comprise at least one second polymer in combination with the at least one modified diene copolymer composition. The at least one second polymer may contribute to any of the performance properties listed above and/or improve different processing or reinforcement performance properties of the formulation. The at least one second polymer may include but is not limited to be selected from: a second block copolymer; a homogeneous ethylene/alpha-olefin interpolymer, an amorphous polyalphaolefin, an interpolymer of ethylene, an interpolymer of alkylacrylate or alkylmethacylate, combinations or mixtures thereof; functionalized and/or hydrogenated versions thereof. Examples of useful commercially available second block copolymers and interpolymers include but are not limited to Solprene®, Calprene® and Calprene® H block copolymers, Kraton® D and G series block copolymers, Europrene® Sol T block copolymers, Vector® block copolymers, Elvaloy® reactive elastomeric terpolymers (RET), as well as others. Examples of suitable interpolymers of ethylene include but are not limited to ethylene/vinyl acetate (EVA), ethylene/methyl acrylate (EMA), ethylene/n-butyl acrylate (EnBA), combinations and mixtures thereof. Examples of suitable functionalized block copolymers include but are not limited to chain-end, in-chain or both chain-end and in-chain functionalized block copolymers, wherein the functionalized block copolymer comprises at least one suitable functional group. Suitable functional groups include but are not limited to epoxy, amine, hydroxy, carboxy, aldehyde, acrylate, methacrylate, ester, amide, isocyanate, anhydride, hydrosilane, alkoxysilane, alkoxytin, mercaptan, aromatic dithioester, trithiocarbonates, dithiocarbamates, xanthates, mixtures and combinations thereof. Suitable functionalized silicon and tin compounds may be used to attach specific functionalities in the polymer chains of the novel modified diene copolymers including but not limited to chloro-propyl-trialkoxysilanes, trialkyltinchloride and trialkoxytinchloride such as chloro-propyl-triethoxysilane, chloro-propyl-trimethoxysilane, trimethyltinchloride, trimethoxytinchloride, triethyltinchloride, triethoxytinchloride, trioctyltinchloride, trioctyloxytinchloride, and the like. Suitable functionalization reactions to modify at least one conjugated diene unit and/or at least one unsubstituted vinyl aromatic unit in at least one block or segment of the modified A-B-C or C-B-A copolymer comprise epoxidation, sulfonation, and the like. Examples of suitable functionalized interpolymers of ethylene include but are not limited to ethylene/glycidyl methacrylate; ethylene/glycidylacrylate; ethylene/vinyl acetate (EVA)/glycidyl methacrylate, ethylene/methyl acrylate (EMA)/glycidyl methacrylate, ethylene/n-butyl acrylate (EnBA)/glycidyl methacrylate, combinations and mixtures thereof. Examples of suitable functionalized interpolymer of Cl-Cl8 alkylacrylate or C1-C18 alkylmethacylate include but are not limited to C1-C18 alkylacrylate or Cl-C18 alkylmethacylate/vinyl acetate (EVA)/glycidyl methacrylate, C1-C18 alkylacrylate or C1-C18 alkylmethacylate/methyl acrylate (EMA)/glycidyl methacrylate, C1-C18 alkylacrylate or C1-C18 alkylmethacylate/n-butyl acrylate (EnBA)/glycidyl methacrylate, combinations and mixtures thereof. The novel modified diene copolymer compositions and the second block copolymer may have increased vinyl configuration units in at least one conjugated diene homopolymer or conjugated diene copolymer block or segment to be even more curable and/or radiation sensitive to further contribute to reinforcement performance properties such as high heat resistance and/or high temperature properties. Preferred second block copolymers for the novel asphalt or bitumen compositions comprising modified diene copolymers of the present invention comprise at least one styrene-butadiene-styrene (linear SBS or radial/multiarm SBn, including hybrid and assymetric bock copolymers, and the like) block copolymer having a styrene content of at least about 25 wt % to improve processability while maintaining high heat resistance such as high Ring and Ball softening point temperature (TRBSP).

The novel polymer modified asphalt or bitumen compositions comprising modified diene copolymers of the present invention that may be curable can be formulated with suitable coupling or crosslinking agents that include but are not limited to polyfunctional acrylates and methacrylates; polyfunctional epoxides; reactive additives such as the synthetic liquid epoxidized oligomers of polyterpene, polyisoprene, polymyrcene, polyfarnesene, and the like. In some embodiments of the present invention, carbofunctional silanes may be used as coupling and functionalizing agents with a general formula XnSi(R′Y)4-n, where: R′ is an alkylene chain, Y is a functional group such as: Cl, NH2, NR2, OH, OCOR, NCO, CH2=CH, SH, and X is a functional group sensitive to hydrolysis (Cl, OR, OCOR). Alkylene chain R′ is usually built of three methylene groups. Suitable examples of carbofunctional silanes include but are not limited to (methacryloxypropyl)-silanes, (aminoalkyl)-silanes and (3-aminopropyl)-silanes, and other types of silanes, including aliphatic or aromatic silanes, amino silanes, epoxy silanes, and other functionalized silanes. In additional embodiments of the present invention, suitable silane coupling agents that may be used as coupling and functionalizing agents in the polymer modified asphalt or bitumen compositions of the present invention include but are not limited to 3-mercaptopropyl trialkoxy silane, bis-(3-trialkoxysilylpropyl)-disulfide, bis-(3-trialkoxysilylpropyl)-tetrasulfide, 3-mercaptopropyl triethoxy silane (MPTES), bis-(3-triethoxysilylpropyl)-disulfide (TESPD), bis-(3-triethoxysilylpropyl)-tetrasulfide, 3-mercaptopropyl trimethoxysilane (MPTMS), bis-(3-trimethoxysilylpropyl)-disulfide (TMSPD), bis-(3-trimethoxysilylpropyl)-tetrasulfide (TMSPT), mixtures and combinations thereof. Examples of preferred silane coupling agents are mercaptopropyltriethoxysilane (MPTES), bis-(3-triethoxysilylpropyl)-disulfide (TESPD), bis-(3-trimethoxysilylpropyl)-disulfide (TMSPD), bis-(3-trimethoxysilylpropyl)-tetrasulfide (TMSPT), 3-mercaptopropyl trimethoxy silane (MPTMS), and their derivatives of ethoxysilanes and chlorosilanes. Other suitable silane coupling agents include but are not limited to silane functionalized silicon compounds that can be used to perform crosslinking by in-chain hydrosilylation reactions on the polymer chain of the modified diene copolymer compositions, and attach either functional groups and/or other polymer side chains to the main chain. Specific examples of suitable functionalized silicon and tin compounds, and silane coupling agents such as the ones listed in U.S. Pat. Nos. 6,229,036, 8,053,512 and PCT Patent Application WO 2018/091955. The entire disclosures of U.S. Pat. Nos. 6,229,036, 8,053,512 and PCT Patent Application WO 2018/091955 are incorporated herein by reference. Examples of sulfanylsilanes are: (EtO)3-Si-(CH2)3-S-Si(CH3)3, [(EtO)3-Si-(CH2)3-S]2-Si(CH3)2, [(EtO)3-Si-(CH2)3-S]3-Si(CH3), [(EtO)3-Si-(CH2)3-S]2-Si(OEt)2, [(EtO)3-Si-(CH2)3-S]4-Si, (EtO)3-Si-(CIH2)3-S-Si(OEt)3, (MeO)3-Si-(CH2)3-S-Si(C2H5)3, (MeO)3-Si-(CH2)3-S-Si(CH3)3, [(MeO)3-Si-(CH2)3-S]2-Si(CH3)2, [(MeO)3-Si-(CH2)3-S]2-Si(OMe)2, [(MeO)3-Si-(CH2)3-S]4-Si, [(MeO)3-Si-(CH2)3-S]3-Si(OMe), and similar C1-C100 linear or branched, alkyl or alkoxy or cycloalkyl or cycloalkoxy or phenyl or benzyl substituted sulfanylsilanes compounds, including but not limited to silicon sulfide modifiers and tin sulfide modifiers, and functionalized and modified versions such as nitrile, amine, NO, alkoxy, thioalkyl, mercaptan, monosulfide, disulfide and tetrasulfide compounds.

The novel polymer modified asphalt and bitumen compositions comprising at least one modified diene copolymer of the present invention may comprise photo-cured formulations that include but are not limited to rubber, thiol-ene, maleimide and acrylate base resins. Photo-curable formulations include but are not limited to thiol-ene compositions comprising a multifunctional thiol, a multifunctional olefin, and at least one suitable photoinitiator. Suitable crosslinking agents that may be used in the photo-curable compositions include but are not limited to polythiol or poly(maleimide) crosslinking agents. For UV-curable compositions, the polythiol may be present in a concentration of up to about 10 percentage by weight, preferably from 0.3 to about 6 percentage by weight, and more preferably from about 0.3 to about 1 percentage by weight based on total weight of rubber and polythiol in the formulation. The most reactive primary thiols are preferred, followed by secondary thiols, and then the least reactive tertiary thiols. Suitable polythiols include but are not limited to 3-mercaptopropionic acid, pentaerythritol tetrathiolglycolate, pentaerythritol tetrakis(3-mercaptopropionate), trimethylolethane trimercaptopropionate, trimethylolpropane trithioglycolate, trimethylolpropane tris(3-mercaptopropionate), ethyleneglycol bis(thioglycolate), ethyleneglycol bis(3-mercaptopropionate), trimethylolpropane tris(thioglycolate), pentaerythritol tetrakis(thioglycolate), combinations and mixtures thereof.

The novel reinforced asphalt or bitumen compositions of the present invention may be used for two specific applications such as road paving applications and roofing/waterproof coating applications. In some embodiments, when the reinforced asphalt or bitumen is used for road paving applications, 0.5 to 8 parts of at least one modified diene copolymer composition of the present invention, preferably 2 to 5 parts, may be mixed with 99.5 to 92 parts, preferably 98 to 95 parts, of at least one asphalt or bitumen to improve processing and/or reinforcement performance. In other embodiments, when the reinforced asphalt or bitumen is used for roofing or waterproof coating applications, 3 to 25 parts of at least one modified diene copolymer composition of the present invention, preferably 6 to 16 parts, may be mixed with 97 to 75 parts, preferably 94 to 84 parts, of at least one asphalt or bitumen to improve processing and/or reinforcement performance. Suitable asphalts or bitumens for use with the modified diene copolymer compositions of the present invention include but are not limited to EKBE PG 70-22 asphalt, EKBE PG 64-22 asphalt or other asphalt widely used for road paving and roofing applications such as native rock asphalts, lake asphalts, petroleum asphalts, air-blown asphalts, cracked asphalts, and residual asphalts.

In certain embodiments of the invention, the much lower viscosity of asphalt or bitumen formulations prepared with modified diene copolymer compositions provided herein, besides contributing to improve the dispersion into the asphalt or bitumen, also facilitates the processing, handling and application of polymer modified asphalt or bitumen blends (PMA or PMB) by improving pumping capacity and/or decreasing the energy required to apply PMA or PMB on a treatmet surface including but not limited to surfaces such as pavements, roads, roofs, and the like. In certain other embodiments of the invention, the much lower viscosity of asphalt or bitumen formulations prepared with modified diene copolymer compositions provided herein, also facilitates the processing, handling and application of polymer modified asphalt or bitumen blends (PMA or PMB) for the emulsification process by improving pumping capacity and/or decreasing the energy required and/or decreasing the amount of emulsifying agent required to emulsify the PMA or PMB into water and apply the polymer modified asphalt or bitumen emulsions (PME or PMAE or PMBE) on a treatmet surface including but not limited to surfaces such as pavements, roads, roofs, and the like. This also means an important cost reduction and a more environmental-friendly process. The softening point temperature of the asphalt modified with the modified diene copolymer compositions of the present invention should provide a better resistance to flow and deformation at high temperature. Surprisingly, some of the asphalt or bitumen modified with the modified diene copolymer compositions of the present invention and formulated with low polymer content, provide similar performance properties (TRBSP) and lower viscosity than the asphalt or bitumen modified with prior art commercially available polymers. This also means an important cost reduction and an energy-saving process.

In certain additional embodiments of the invention, the novel modified diene copolymer compositions may provide polymer modified asphalt or bitumen compositions (PMA or PMB) with one or more of the following properties: a) maximum application or use temperature of about 50 to 100° C. measured as the temperature at which the Rutting Factor or Dynamic Shear Stiffness (G*/sin δ) takes a value of 1.0 KPa (measured as per AASHTO TP5); b) TRBSP (measured as per ASTM D36) of about 40 to 130° C.; c) asphalt penetration at 25° C. (as per ASTM D5) of about 30 to 75 dmm for road paving applications or about 50 to 100 for roofing and waterproof coating applications; and d) dynamic viscosity at 135° C. of about 500 to 3000 cP and desirably 1000 to 2000 cP for road paving applications or at 190° C. of about 1000 to 6000 cP and desirably 1500 to 4000 cP (as per ASTM D4402) for roofing and waterproof coating applications.

The invention will be further described by reference to the following examples which are presented for illustration purposes only and are not intended to limit the scope of the invention.

### EXAMPLES

Preparation of Modified Diene Copolymer Compositions (MDC)

A novel modified diene copolymer composition (MDC A) was prepared in accordance to the process claimed in the present invention. The novel modified diene copolymer composition MDC A formed a modified C-B-A copolymer comprising reacting at least one conjugated diene monomer and at least one unsubstituted vinyl aromatic monomer and at least one substituted vinyl aromatic monomer under alkyllithium-initiated living polymerization conditions, wherein each block or segment in the modified C-B-A copolymer is a copolymer comprising at least one conjugated diene monomer and/or at least one unsubstituted vinyl aromatic monomer and/or at least one substituted vinyl aromatic monomer, wherein the copolymers have a distribution configuration that is tapered, and wherein any of the copolymers comprising at least one conjugated diene monomer and/or at least one unsubstituted vinyl aromatic monomer is modified with at least one unit of at least one substituted vinyl aromatic monomer.

The novel modified diene copolymer composition MDC A was characterized by GPC and 1H NMR, methodologies to determine: molecular weight and molecular weight distribution characteristics such as peak molecular weight (Mp), weight average molecular weight (Mw) and polydispersity (Mw/Mn) for linear C-B-A copolymers; microstructural characteristics such as Total Styrene content, Total p-MethylStyrene content, Block Vinyl Aromatic copolymer content, and Vinyl C-B blocks content. The following describes the general procedure used to prepare the novel modified diene copolymer composition MDC A and to control the anionic copolymerization of 1,3-butadiene (B), styrene (S) and p-methylstyrene (pMS).

The novel modified diene copolymer composition MDC A of the present invention was prepared in a 2 Liter reactor system operated under inert nitrogen atmosphere in batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the polymerization step, an appropriate amount of purified solvent (i.e., cyclohexane) was charged into the reactor and heated to a target initial reaction temperature (Ti) of about 60° C. Once Ti was reached, first the addition of unsubstituted vinyl aromatic monomer (STY) of about 15 wt % of total monomer mixture, followed by the addition of substituted vinyl aromatic monomer (pMS) of about 15 wt % of total monomer mixture, so the total amount of unsubstituted and substituted vinyl aromatic monomer was kept constant at about 30 wt % of total monomer mixture, and then the addition of conjugated diene monomer (BD) of about 70 wt % of total monomer mixture. The reaction mixture was stabilized at Ti of about 60.5° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically to a peak temperature (Tp) of about 70.4° C. and then to complete conversion for a polymerization time of about 110 min, thereby forming the living modified C-B-A copolymer of the present invention with peak molecular weight Mp of about 108.6 kg/mol (target of about 110 kg/mol). Finally, the remaining living polymer chains were terminated by adding a 10 mol % excess over the stoichiometric amount of a suitable alcohol to the final reaction mixture, and thus obtaining the novel modified diene copolymer MDC A.

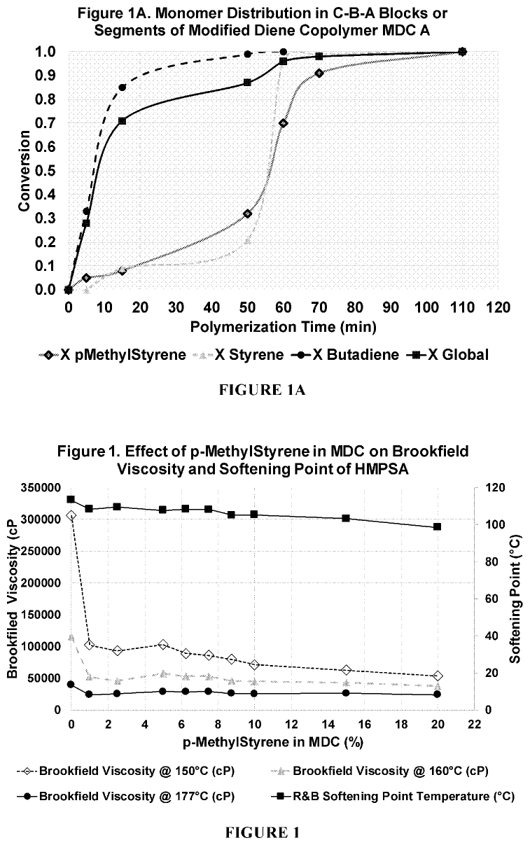

FIG. 1A depicts the monomer distributions [pMS], [S], and [B] along the modified C-B-A copolymer chain for each copolymer block or segment of inventive modified diene copolymer MDC A, which was enabled by taking aliquots throughout the copolymerization, and then performing NMR and GPC characterization. Global and individual monomer conversions are shown against polymerization time, which were calculated based on NMR composition and GPC molecular weight.

The present invention provides novel modified diene copolymer compositions based on an unexpected and surprising kinetic behavior of the alkyllithium-initiated polymerization comprising reacting at least one conjugated diene monomer and at least one unsubstituted vinyl aromatic monomer and at least one substituted vinyl aromatic monomer; wherein in a preferred embodiment of the present invention, relative monomer reactivity ratios for polymerization of butadiene (1), styrene (2) and p-methylstyrene (3) in hydrocarbon solvent and the absence of polar modifiers were calculated to be r1=18.8, r2=0.5 y r3=0.07; wherein based on the relative monomer reactivity ratios, a tapered (butadiene/styrene/p-methylstyrene) gradual block structure with small, sharp and steep interphases first between -(butadiene/styrene)- and then between -(styrene/p-methylstyrene)- was expected; wherein the unexpected and surprising kinetic behavior is that p-methylstyrene (pMS) begins incorporation into the polymer chain from the start of the polymerization and copolymerizes only with butadiene (BD or B) to form a first C block or segment, [butadiene/p-methylstyrene] or [BD/pMS] or [B/pMS], even before styrene (STY or S) begins incorporation into the copolymer chain, then a very broad and enlarged interphase forms a second B block or segment, -[butadiene/p-methylstyrene/styrene]- or -[BD/pMS/STY]- or -[B/pMS/S]-, that is a terpolymer composition not only rich in butadiene but also with higher p-methylstyrene than styrene incorporation, after butadiene monomer is depleted then incorporation of styrene increases and a styrene-rich copolymer with p-methylstyrene forms a third A block or segment, [styrene/p-methylstyrene-p-methylstyrene] or [STY/pMS-pMS] or [S/pMS-pMS], with a small number of terminal p-methylstyrene monomer units that slowly incorporates into the polymer chain after styrene monomer is exhausted, wherein the copolymer blocks or segments in the modified C-B-A copolymer have a distribution configuration that is tapered.

C-B-A

or

[BD/pMS]-[BD/pMS/STY]-[STY/pMS-pMS]

or

[B/pMS]-[B/pMS/S]-[S/pMS-pMS]

### Example 1

Preparation of Modified Diene Copolymer Compositions (MDC)

In Example 1, several novel modified diene copolymer compositions MDC 1-9 were prepared in accordance to the process claimed in the present invention. The novel modified diene copolymer compositions MDC 1-9 formed a modified C-B-A copolymer comprising reacting at least one conjugated diene monomer and at least one unsubstituted vinyl aromatic monomer and at least one substituted vinyl aromatic monomer under alkyllithium-initiated living polymerization conditions, wherein each block or segment in the modified C-B-A copolymer is a copolymer comprising at least one conjugated diene monomer and/or at least one unsubstituted vinyl aromatic monomer and/or at least one substituted vinyl aromatic monomer, wherein the copolymers have a distribution configuration that is tapered, and wherein any of the copolymers comprising at least one conjugated diene monomer and/or at least one unsubstituted vinyl aromatic monomer is modified with at least one unit of at least one substituted vinyl aromatic monomer.

The novel modified diene copolymer compositions MDC 1-9 were characterized by GPC, 1H NMR, Block Vinyl Aromatic copolymer via Degradative Oxidation, 5 and 25 wt % Styrene Solution Viscosities @ 25° C., and Mooney Viscosities @ 100° C. methodologies to determine: molecular weight and molecular weight distribution characteristics such as peak molecular weight (Mp), weight average molecular weight (Mw) and polydispersity (Mw/Mn) for linear C-B-A copolymers and block vinyl aromatic copolymer degradation product; microstructural characteristics such as Total Styrene content, Total p-MethylStyrene content, Block Vinyl Aromatic copolymer content, and Vinyl C-B blocks content. In addition, calculations of the peak molecular weight (Mp) of p-MethylStyrene and number of p-MethylStyrene monomer units in the linear C-B-A copolymers were performed based on calculated absolute molecular weight, mass fraction of p-MethylStyrene and molecular weight of p-MethylStyrene monomer. Table 1 enlist the analytical characterization results and Table 2 the polymerization conditions for MDC 1-9. The following describes the general procedure used to prepare these novel modified diene copolymer compositions MDC 1-9 and to control the anionic copolymerization of 1,3-butadiene (B), styrene (S) and p-methylstyrene (pMS). The abbreviations used in Table 2 below for the polymerization conditions are defined as follows: STY=styrene; BD=1,3-butadiene; and p-MS=p-methylstyrene.

The novel modified diene copolymer compositions MDC 1-9 of the present invention were prepared in a 7.6 Liter reactor system operated under inert nitrogen atmosphere in batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the polymerization step, an appropriate amount of purified solvent (i.e., cyclohexane) was charged into the reactor and heated to a target initial reaction temperature (Ti) of about 55° C. Once Ti was reached, first the addition of unsubstituted vinyl aromatic monomer (STY) of from about 5 to about 24 wt % of total monomer mixture, followed by the addition of substituted vinyl aromatic monomer (pMS) of from about 1 to about 20 wt % of total monomer mixture, so the total amount of unsubstituted and substituted vinyl aromatic monomer was kept constant at about 25 wt % of total monomer mixture, and then the addition of conjugated diene monomer (BD) of about 75 wt % of total monomer mixture. The reaction mixture was stabilized at Ti from about 53.5 to about 56.1° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for polymerization times from about 10 to about 14 min, up to complete conversion and the final peak temperature (Tp) was then allowed to increase to from about 105.0 to about 117.4° C., thereby forming the living modified C-B-A copolymer of the present invention with peak molecular weight Mp about a target of about 120 kg/mol. Finally, the remaining living polymer chains were terminated by adding a 10 mol % excess over the stoichiometric amount of a suitable alcohol to the final reaction mixture, and thus obtaining the novel modified diene copolymers MDC 1-9.

Table 1 list the analytical characterization results for the novel modified diene copolymer compositions MDC 1-9. All the molecular weights (Mp and Mw) are given in units of 1000 (k) (i.e., kg/mol) and calculated relative to polystyrene standards by GPC. The MDC 1-9 molecular weights and molecular weight distributions for the modified C-B-A copolymer or [B/pMS]-[B/pMS/S]-[S/pMS-pMS] are: peak molecular weights Mp range from about 114 to about 123 kg/mol; weight average molecular weights Mw range from about 118 to about 125 kg/mol; and the polydispersities Mw/Mn range from about 1.03 to about 1.04. The MDC 1-9 characterization results estimated by NMR are: total contents of unsubstituted vinyl aromatic monomer (Total Styrene) range from about 5.0 to about 24.5 wt % based on total modified C-B-A diene copolymer; total contents of substituted vinyl aromatic monomer (Total p-MethylStyrene) range from about 1.0 to about 20.0 wt % based on total modified C-B-A diene copolymer; and vinyl C-B blocks contents range from about 9.1 to about 9.5 wt % based on total conjugated diene monomer (BD) units in the modified C-B-A diene copolymer. The MDC 1-9 calculated peak molecular weights Mp of p-MethylStyrene range from about 0.67 to about 13.5 kg/mol in the linear C-B-A copolymers; and calculated numbers of p-MethylStyrene monomer units range from about 6 to about 114 units in the linear C-B-A copolymers. The MDC 1-9 molecular weights and molecular weight distributions for the block of vinyl aromatic copolymer obtained via degradative oxidation of the modified C-B-A diene copolymers are: peak molecular weights Mp range from about 13.2 to about 16.4 kg/mol; and the polydispersities Mw/Mn range are from about 1.13 to about 1.22; and block vinyl aromatic copolymer contents via degradative oxidation (Block Vinyl Aromatic) range from about 16.2 to about 18.7 wt % based on total modified C-B-A diene copolymer. MDC 1-9 Mooney viscosities ML1+4 @ 100° C. range from about 37.3 to about 46.9 MU. MDC 1-9 styrene solution viscosities at 5 wt % and 25° C. range from about 7.81 to about 9.44 cP. MDC 1-9 styrene solution viscosities at 25 wt % and 25° C. range from about 1,188 to about 1,689 cP.

TABLE 1
Modified Diene Copolymer Compositions

| | | MDC | MDC | MDC | MDC | MDC | MDC | MDC | MDC | MDC |
|---|---|---|---|---|---|---|---|---|---|---|
| Polymer Name | Control | 1 | 2 | 3 | 4 | 5 | 6 | 7 | 8 | 9 |
| Mp C-B-A (kg/mol) | 124 | 114 | 114 | 123 | 122 | 122 | 119 | 119 | 123 | 119 |
| Mw C-B-A (kg/mol) | 126 | 118 | 119 | 124 | 123 | 124 | 122 | 120 | 125 | 120 |
| Mw/Mn C-B-A | 1.03 | | 1.04 | 1.03 | 1.03 | 1.03 | 1.03 | 1.03 | 1.03 | 1.03 |
| Total Styrene (wt %) | 25.0 | 24.5 | 24.5 | 20.0 | 18.8 | 17.5 | 16.3 | 15.0 | 10.0 | 5.0 |
| Total p-MethylStyrene (wt %) | 0.0 | 1.0 | 2.5 | 5.0 | 6.3 | 7.5 | 8.8 | 10.0 | 15.0 | 20.0 |
| Mp p-MethylStyrene calcd. (kg/mol) | | 0.67 | 1.68 | 3.50 | 4.37 | 5.25 | 6.06 | 6.82 | 10.6 | 13.5 |
| Monomer Units p-MethylStyrene calcd. | | 6 | 14 | 30 | 37 | 44 | 51 | 58 | 90 | 114 |
| Block Vinyl Aromatic (wt %) | 17.0 | 16.5 | 17.2 | 18.3 | 17.0 | 16.8 | 17.5 | 17.7 | 18.7 | 16.2 |
| Mp Block Vinyl Aromatic (kg/mol) | 14.7 | | 13.2 | 14.8 | | | | 15.8 | 16.4 | 15.9 |
| Mw/Mn Block Vinyl Aromatic | 1.15 | | 1.13 | 1.19 | | | | 1.14 | 1.22 | 1.22 |
| Vinyl C-B (wt %) | 9.3 | 9.2 | 9.5 | 9.2 | 9.1 | 9.1 | 9.4 | 9.4 | 9.1 | 9.3 |
| Mooney Viscosity M₁₊₄@100° C. (MU) | | 37.9 | 37.3 | 43.9 | 42.7 | 43.9 | 44.8 | 42.4 | 46.9 | 42.3 |
| Styrene Solution Viscosity @ 25° C., 5% (cP) | 9.61 | 8.18 | 7.81 | 9.08 | 8.39 | 8.68 | 8.44 | 9.44 | 8.67 | 8.00 |
| Styrene Solution Viscosity @ 25° C., 25% (cP) | 1674 | 1459 | 1459 | 1194 | 1348 | 1612 | 1689 | 1188 | 1272 | 1428 |

^{a} Molecular Weight averages by GPC relative to PS standards;
^{b} Vinyl in wt % based on total butadiene units by RMN 1H 300 MHz;
^{c} Block Vinyl Aromatic in wt % by OsO4 degradative oxidation.

TABLE 2
Modified Diene Copolymer Compositions

| | | MDC | MDC | MDC | MDC | MDC | MDC | MDC | MDC | MDC |
|---|---|---|---|---|---|---|---|---|---|---|
| Polymer Name | Control | 1 | 2 | 3 | 4 | 5 | 6 | 7 | 8 | 9 |
| BD (wt %)a | 75.0 | 75.0 | 75.0 | 75.0 | 75.0 | 75.0 | 75.0 | 75.0 | 75.0 | 75.0 |
| STY (wt %)^{a} | 25.0 | 24.0 | 22.5 | 20.0 | 18.8 | 17.5 | 16.3 | 15.0 | 10.0 | 5.0 |
| p-MS (wt %)^{a} | 0.0 | 1.0 | 2.5 | 5.0 | 6.3 | 7.5 | 8.8 | 10.0 | 15.0 | 20.0 |
| Reactor Volume (L) | 7.6 | 7.6 | 7.6 | 7.6 | 7.6 | 7.6 | 7.6 | 7.6 | 7.6 | 7.6 |
| Initial Temperature Ti (° C.) | 58.7 | 53.5 | 55.5 | 56.1 | 55.4 | 55.4 | 55.6 | 55.0 | 55.0 | 54.5 |
| Final Peak Temperature Tp (° C.) | 111.3 | 117.4 | 117.2 | 111.9 | 108.6 | 111.8 | 112.7 | 106.8 | 107.5 | 105.0 |
| Polymerization Time (min) | 11.0 | 11.0 | 10.0 | 11.0 | 13.0 | 12.0 | 11.0 | 13.0 | 13.0 | 14.0 |

^{a}wt % of Total Monomer Mixture

### Example 2

Preparation of Modified Diene Copolymer Compositions (MDC)

In Example 2, several novel modified diene copolymer compositions MDC 10-13 were prepared in accordance to the process claimed in the present invention. The novel modified diene copolymer compositions MDC 10-13 formed a modified C-B-A copolymer comprising reacting at least one conjugated diene monomer and at least one unsubstituted vinyl aromatic monomer and at least one substituted vinyl aromatic monomer under alkyllithium-initiated living polymerization conditions, and wherein each block or segment in the modified C-B-A copolymer is either a homopolymer or a copolymer comprising at least one conjugated diene monomer and/or at least one unsubstituted vinyl aromatic monomer and/or at least one substituted vinyl aromatic monomer, wherein the copolymers have a distribution configuration that is tapered.

The novel modified diene copolymer compositions MDC 10-13 were characterized by GPC, 1H NMR, Block Vinyl Aromatic copolymer via Degradative Oxidation, 5 and 25 wt % Styrene Solution Viscosities a 25° C., and Mooney Viscosities @ 100° C. methodologies to determine: molecular weight and molecular weight distribution characteristics such as peak molecular weight (Mp), weight average molecular weight (Mw) and polydispersity (Mw/Mn) for linear C-B-A copolymers and block vinyl aromatic copolymer degradation product; microstructural characteristics such as Total Styrene content, Total p-MethylStyrene content, Block Vinyl Aromatic copolymer content, and Vinyl C-B blocks content. In addition, calculations of the peak molecular weight (Mp) of p-MethylStyrene and number of p-MethylStyrene monomer units in the linear C-B-A copolymers were performed based on calculated absolute molecular weight, mass fraction of p-MethylStyrene and molecular weight of p-MethylStyrene monomer. Table 3 enlist the analytical characterization results and Table 4 the polymerization conditions for MDC 10-13. The following describes the general procedure used to prepare these novel modified diene copolymer compositions MDC 10-13 and to control the anionic copolymerization of 1,3-butadiene (B), styrene (S) and p-methylstyrene (pMS). The abbreviations used in Table 4 below for the polymerization conditions are defined as follows: STY=styrene; BD=1,3-butadiene; and p-MS=p-methylstyrene.

The novel modified diene copolymer compositions MDC 10-13 of the present invention were prepared in a 7.6 Liter reactor system operated under inert nitrogen atmosphere in batch and/or semi-batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the first polymerization step, an appropriate amount of purified solvent (i.e., cyclohexane) was charged into the reactor and heated to a target initial reaction temperature (Ti) of about 55° C. Once Ti was reached, a suitable polar modifier such as ditetrahydrofurylpropane (DTHFP) or tetrahydrofuran (THF) was added into the reactor to promote efficient initiation, and then the addition of substituted or unsubstituted vinyl aromatic monomer (pMS or STY) of from about 5 to about 10 wt % of total monomer mixture. The reaction mixture was stabilized at Ti from about 54.2 to about 58.7° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for first polymerization time from about 6 to about 11 min, up to complete conversion and the first peak temperature (Tp1) was then allowed to increase to from about 55.6 to about 59.6° C., thereby forming the living modified C block or segment of the present invention with peak molecular weight Mp about a target of about 3.83 to about 7.35 kg/mol.

For the second polymerization step, the monomer additions were carried out in a programmed batch and/or semi-batch mode. The addition of all the monomers was simultaneously initiated for MDC 10-13, a substituted vinyl aromatic monomer (pMS) addition of about 0 to about 5 wt % of total monomer mixture and/or a unsubstituted vinyl aromatic monomer (STY) addition of from about 25 to about 30 wt % of total monomer mixture was rapidly charged into the reactor at a specified dose rate of about 130 g/min during a predetermined dosification time of about 2 min, and a conjugated diene monomer (BD) addition of about 65 wt % of total monomer mixture was slowly charged into the reactor at a specified dose rate of from about 60 g/min for a predetermined dosification time of from about 4 to about 5 min. The amount of polar modifier (i.e., ditetrahydrofurfurylpropane) was adjusted from about 0.001 to about 0.003 wt % of total reaction mixture to promote the formation of vinyl microstructure (1,2-addition) along the copolymer chain. This second polymerization step was then allowed to proceed adiabatically for final polymerization time from about 28 to about 34 min up to complete conversion, and the final peak temperature (Tp2) was then allowed to increase to from about 88.5 to about 108.9° C., thereby forming the modified B-A block and thus obtaining the living modified C-B-A diene copolymer with target peak molecular weight Mp of about 120 kg/mol. Finally, the remaining living polymer chains were terminated by adding a 10 mol % excess over the stoichiometric amount of a suitable alcohol to the final reaction mixture, and thus obtaining the novel modified diene copolymers MDC 10-13.

Table 3 list the analytical characterization results for the novel modified diene copolymer compositions MDC 10-13. All the molecular weights (Mp and Mw) are given in units of 1000 (k) (i.e., kg/mol) and calculated relative to polystyrene standards by GPC. The MDC 10-13 molecular weights and molecular weight distributions for the modified C-B-A copolymer or [pMS]-[B/pMS]-[B/pMS/S]-[S/pMS-pMS] or [pMS]-[B/S]-[S] are: peak molecular weights Mp range from about 119 to about 126 kg/mol; weight average molecular weights Mw range from about 122 to about 127 kg/mol; and the polydispersities Mw/Mn range from about 1.02 to about 1.04. The MDC 10-13 characterization results estimated by NMR are: total contents of unsubstituted vinyl aromatic monomer (Total Styrene) range from about 25.0 to about 35.0 wt % based on total modified C-B-A diene copolymer; total contents of substituted vinyl aromatic monomer (Total p-MethylStyrene) range from about 0 to about 10.0 wt % based on total modified C-B-A diene copolymer; and vinyl B blocks contents range from about 12.0 to about 18.2 wt % based on total conjugated diene monomer (BD) units in the modified C-B-A diene copolymer. The MDC 10-13 calculated peak molecular weights Mp of p-MethylStyrene range from about 7.35 to about 7.66 (i.e., 3.83+3.83) kg/mol in the linear modified C-B-A diene copolymers; and calculated numbers of p-MethylStyrene monomer units range from about 62 to about 64 (i.e., 32+32) units in the linear modified C-B-A diene copolymers. The MDC 10-13 molecular weights and molecular weight distributions for the block of vinyl aromatic copolymer obtained via degradative oxidation of the modified C-B-A diene copolymers are: peak molecular weights Mp range from about 9.2 to about 16.4 kg/mol; and the polydispersities Mw/Mn range are from about 1.12 to about 1.30; and block vinyl aromatic copolymer contents via degradative oxidation (Block Vinyl Aromatic) range from about 21.9 to about 24.0 wt % based on total modified C-B-A diene copolymer. MDC 10-13 Mooney viscosities ML1+4 @ 100° C. range from about 74.1 to about 97.6 MU. MDC 10-13 styrene solution viscosities at 5 wt % and 25° C. range from about 7.55 to about 8.39 cP. MDC 10-13 styrene solution viscosities at 25 wt % and 25° C. range from about 956 to about 1,648 cP.

### Example 3

Preparation of Modified Diene Copolymer Compositions (MDC)

In Example 3, several novel modified diene copolymer compositions MDC 14-15 were prepared in accordance to the process claimed in the present invention. The novel modified diene copolymer compositions MDC 14-15 formed a modified A-B-C copolymer comprising reacting at least one conjugated diene monomer and at least one unsubstituted vinyl aromatic monomer and at least one substituted vinyl aromatic monomer under alkyllithium-initiated living polymerization conditions, and wherein each block or segment in the modified A-B-C copolymer is either a homopolymer or a copolymer comprising at least one conjugated diene monomer and/or at least one unsubstituted vinyl aromatic monomer and/or at least one substituted vinyl aromatic monomer; and a block copolymer made from the modified A-B copolymer with a coupling agent after the complete polymerization of the B block and before polymerizing the C block, and wherein the block copolymer comprises at least two of the modified A-B copolymers.

TABLE 3
Modified Diene Copolymer Compositions

| | | MDC | MDC | MDC | MDC |
|---|---|---|---|---|---|
| Polymer Name | Control | 10 | 11 | 12 | 13 |
| Mp C-B-A (kg/mol) | 124 | 119 | 120 | 121 | 126 |
| Mw C-B-A (kg/mol) | 126 | 123 | 122 | 124 | 127 |
| Mw/Mn C-B-A | 1.03 | 1.04 | 1.02 | 1.04 | 1.02 |
| Total Styrene (wt %) | 25.0 | 35.0 | 25.0 | 35.0 | 25.0 |
| Total p-MethylStyrene (wt %) | 0.0 | 0.0 | 10.0 | 0.0 | 10.0 |
| Mp p-MethylStyrene calcd. (kg/mol) | | | 3.83/3.83 | | 7.35 |
| Monomer Units p-MethylStyrene calcd. | | | 32/32 | | 62 |
| Block Vinyl Aromatic (wt %) | 17.0 | 21.9 | 22.3 | 24.0 | 22.5 |
| Mp Block Vinyl Aromatic (kg/mol) | 14.7 | 16.4 | 9.2 | 12.8 | 11.0 |
| Mw/Mn Block Vinyl Aromatic | 1.15 | 1.29 | 1.12 | 1.30 | 1.16 |
| Vinyl C-B (wt %) | 9.3 | 12.0 | 17.7 | 13.7 | 18.2 |
| Mooney Viscosity ML₁₊₄@100° C. (MU) | | 74.1 | | 97.6 | |
| Styrene Solution Viscosity @ | 9.61 | 7.73 | 7.55 | 7.85 | 8.39 |
| 25° C., 5% (cP) | | | | | |
| Styrene Solution Viscosity @ | 1674 | 1534 | 956 | 1648 | 977 |
| 25° C., 25% (cP) | | | | | |

^{a} Molecular Weight averages by GPC relative to PS standards;
^{b} Vinyl in wt % based on total butadiene units by RMN 1 H 300 MHz;
^{c} Block Vinyl Aromatic in wt % by OsO4 degradative oxidation.

TABLE 4
Modified Diene Copolymer Compositions

| | | MDC | MDC | MDC | MDC |
|---|---|---|---|---|---|
| Polymer Name | Control | 10 | 11 | 12 | 13 |
| BD (wt %)^{a} | 75.0 | 65.0 | 65.0 | 65.0 | 65.0 |
| STY (wt %)^{a} | 25.0 | 35.0 | 25.0 | 35.0 | 25.0 |
| p-MS (wt %)^{a} | 0.0 | 0.0 | 10.0 | 0.0 | 10.0 |
| Reactor Volume (L) | 7.6 | 7.6 | 7.6 | 7.6 | 7.6 |
| Initial Temperature Ti (° C.) | 58.7 | 54.5 | 58.7 | 54.2 | 54.2 |
| First Peak Temperature Tp1 (° C.) | | 57.5 | 59.6 | 58.7 | 55.6 |
| First Polymerization Time (min) | | 11.0 | 6.0 | 9.0 | 7.0 |
| Final Peak Temperature Tp2 (° C.) | 111.3 | 108.9 | 100.0 | 105.4 | 88.5 |
| Final Polymerization Time (min) | 11.0 | 34.0 | 28.0 | 33.0 | 34.0 |

^{a}wt % of Total Monomer Mixture

The novel modified diene copolymer compositions MDC 14-15 were characterized by GPC, 1H NMR, Block Vinyl Aromatic copolymer via Degradative Oxidation, and 5.23 wt % Toluene Solution Viscosities @ 25° C. methodologies to determine: molecular weight and molecular weight distribution characteristics such as peak molecular weight (Mp Linear A-B-C and Mp Coupled (A-B)n-X), coupled (A-B)n-X content, coupled degree (Mp Coupled/Mp Linear), weight average molecular weight (Mw) and polydispersity (Mw/Mn) for linear modified A-B-C and coupled (A-B)n-X copolymers and block vinyl aromatic copolymer degradation product; microstructural characteristics such as Total Styrene content, Total p-MethylStyrene content, Block Vinyl Aromatic copolymer content, and Vinyl B blocks content. In addition, calculations of the peak molecular weight (Mp) of p-MethylStyrene and number of p-MethylStyrene monomer units in the terminal C block homopolymers were performed based on calculated absolute molecular weight, mass fraction of p-MethylStyrene and molecular weight of p-MethylStyrene monomer. Table 5 enlist the analytical characterization results and Table 6 the polymerization conditions for MDC 14-15. The following describes the general procedure used to prepare these novel modified diene copolymer compositions MDC 14-15 and to control the anionic copolymerization of 1,3-butadiene (B), styrene (S) and p-methylstyrene (pMS). The abbreviations used in Table 6 below for the polymerization conditions are defined as follows: STY=styrene; BD=1,3-butadiene; and p-MS=p-methylstyrene.

The novel modified diene copolymer compositions MDC 14-15 of the present invention were prepared in a 7.6 Liter reactor system operated under inert nitrogen atmosphere in batch and/or semi-batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the first polymerization step, an appropriate amount of purified solvent (i.e., cyclohexane) was charged into the reactor and heated to a target initial reaction temperature (Ti) of about 60° C. Once Ti was reached, a suitable polar modifier such as ditetrahydrofurylpropane (DTHFP) or tetrahydrofuran (THF) was added into the reactor to promote efficient initiation, and then the addition of unsubstituted vinyl aromatic monomer (STY) of about 17.5 wt % of total monomer mixture. The reaction mixture was stabilized at Ti from about 59.6 to about 61.1° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for first polymerization time from about 6 to about 7 min, up to complete conversion and the first peak temperature (Tp1) was then allowed to increase to from about 69.1 to about 71.4° C., thereby forming the living modified A block or segment of the present invention with peak molecular weight Mp about a target of about 10.0 kg/mol.

For the second polymerization step, the monomer additions were carried out in a programmed batch and/or semi-batch mode. The addition of all the monomers was simultaneously initiated for MDC 14-15, a second unsubstituted vinyl aromatic monomer (STY) addition of about 7.5 wt % of total monomer mixture was rapidly charged into the reactor at a specified dose rate of about 130 g/min during a predetermined dosification time of about 1 min, and a conjugated diene monomer (BD) addition of from about 65 to about 70 wt % of total monomer mixture was slowly charged into the reactor at a specified dose rate of from about 60 g/min for a predetermined dosification time of from about 4 to about 5 min. These monomer additions were carried out in a programmed batch and/or semi-batch mode, and the amount of polar modifier (i.e., ditetrahydrofurfurylpropane) was adjusted to about 0.017 wt % of total reaction mixture to promote the formation of a statistically distributed counter tapered [S/B] copolymer block with gradual decrease in composition and vinyl microstructure (1,2-addition) along the copolymer chain. This second polymerization step was then allowed to proceed adiabatically for final polymerization time from about 24 to about 25 min up to complete conversion, and the final peak temperature (Tp2) was then allowed to increase to from about 104.3 to about 106.8° C., thereby forming the counter tapered B block and thus obtaining the living modified A-B diene copolymer with target peak molecular weight Mp of from about 100 to about 105 kg/mol.

For the third step, a suitable coupling agent such as silicon tetrachloride (SiCl4) in a sufficient amount of from about 0.003 to about 0.004 wt % of total reaction mixture was added to the reactor to partially couple the living modified A-B diene copolymer to obtain the desired ratios of living linear A-B diene copolymer to coupled radial (A-B)n-X compositions of the present invention, wherein X is the residual moiety from the coupling reaction process.

Finally, the remaining living linear A-B diene copolymer was modified with the addition of substituted vinyl aromatic monomer (pMS) of from about 5.0 to about 10.0 wt % of total monomer mixture. The final polymerization step proceeded adiabatically for a polymerization time from about 10 to about 30 min up to complete conversion, thereby forming the living modified A-B-C diene copolymer of the present invention with peak molecular weight Mp about a target of about 111 kg/mol. Finally, the remaining living polymer chains were terminated by adding a 10 mol % excess over the stoichiometric amount of a suitable alcohol to the final reaction mixture, and thus obtaining the novel modified diene copolymers MDC 14-15.

Table 5 list the analytical characterization results for the novel modified diene copolymer compositions MDC 14-15. All the molecular weights (Mp and Mw) are given in units of 1000 (k) (i.e., kg/mol) and calculated relative to polystyrene standards by GPC. The MDC 14-15 molecular weights and molecular weight distributions for the linear modified A-B-C diene copolymer or [S]-[S/B]-[pMS] and coupled (A-B)n-X or [S-S/B]n-X are: peak molecular weights Mp linear modified A-B-C diene copolymer range from about 115 to about 119 kg/mol and Mp coupled radial (A-B)n-X range from about 357 to about 390 kg/mol; coupled degrees Mp coupled/Mp linear range from about 3.10 to about 3.30; coupled contents (A-B)n-X ranges from 35.7 to about 36.5%; weight average molecular weights Mw linear modified A-B-C diene copolymer and coupled radial (A-B)n-X range from about 198 to about 210 kg/mol; and the polydispersities Mw/Mn Mw linear modified A-B-C diene copolymer and coupled radial (A-B)n-X range from about 1.36 to about 1.41. The MDC 14-15 characterization results estimated by NMR are: total contents of unsubstituted vinyl aromatic monomer (Total Styrene) of about 25.0 wt % based on total modified diene copolymer; total contents of substituted vinyl aromatic monomer (Total p-MethylStyrene) range from about 4.6 to about 8.8 wt % based on total modified diene copolymer; and vinyl B blocks contents range from about 27.8 to about 33.1 wt % based on total conjugated diene monomer (BD) units in the modified diene copolymer. The MDC 14-15 calculated peak molecular weights Mp of p-MethylStyrene range from about 3.25 to about 6.20 kg/mol in the linear modified A-B-C diene copolymers; and calculated numbers of p-MethylStyrene monomer units range from about 27 to about 52 units in the linear modified A-B-C diene copolymers. The MDC 14-15 molecular weights and molecular weight distributions for the block of vinyl aromatic copolymer obtained via degradative oxidation of the modified diene copolymers are: peak molecular weights Mp range from about 11.8 to about 14.1 kg/mol; and the polydispersities Mw/Mn range are from about 1.11 to about 1.25; and block vinyl aromatic copolymer contents via degradative oxidation (Block Vinyl Aromatic) range from about 21.2 to about 27.6 wt % based on total modified diene copolymer. MDC 14-15 toluene solution viscosities at 5.23 wt % and 25° C. range from about 8.95 to about 9.92 cP.

### Example 4

Preparation of Modified Diene Copolymer Compositions (MDC)

In Example 4, several novel modified diene copolymer compositions MDC 16-22 were prepared in accordance to the process claimed in the present invention. The novel modified diene copolymer compositions MDC 16-22 formed a modified A-B-C copolymer comprising reacting at least one conjugated diene monomer and at least one unsubstituted vinyl aromatic monomer and at least one substituted vinyl aromatic monomer under alkyllithium-initiated living polymerization conditions, and wherein each block or segment in the modified A-B-C copolymer is either a homopolymer or a copolymer comprising at least one conjugated diene monomer and/or at least one unsubstituted vinyl aromatic monomer and/or at least one substituted vinyl aromatic monomer; and a block copolymer made from the modified A-B copolymer with a coupling agent after the complete polymerization of the B block and before polymerizing the C block, and wherein the block copolymer comprises at least two of the modified A-B copolymers.

TABLE 5
Modified Diene Copolymer Compositions

| | | MDC | MDC |
|---|---|---|---|
| Polymer Name | Control | 14 | 15 |
| Mp Linear A-B (kg/mol) | 112 | 115 | 118 |
| Mp Coupled (A-B)n-X (kg/mol) | 386 | 357 | 390 |
| Mp Coupled/Mp Linear (kg/mol) | 3.46 | 3.10 | 3.30 |
| Coupled (A-B)n-X (%) | 38.1 | 36.5 | 35.7 |
| Mw A-B-C + (A-B)n-X (kg/mol) | 213 | 198 | 210 |
| Mw/Mn A-B-C + (A-B)n-X | 1.45 | 1.36 | 1.41 |
| Total Styrene (wt %) | 25.2 | 25.0 | 25.0 |
| Total p-MethylStyrene (wt %) | 0.0 | 8.8 | 4.6 |
| Mp p-MethylStyrene calcd. (kg/mol) | | 6.20 | 3.25 |
| Monomer Units p-MethylStyrene calcd. | | 52 | 27 |
| Block Vinyl Aromatic (wt %) | 25.7 | 27.6 | 21.2 |
| Mp Block Vinyl Aromatic (kg/mol) | 11.2 | 14.1 | 11.8 |
| Mw/Mn Block Vinyl Aromatic | 1.06 | 1.25 | 1.11 |
| Vinyl B (wt %) | 29.8 | 27.8 | 33.1 |
| Toluene Solution Viscosity @ 5.23%, | 10.62 | 8.95 | 9.92 |
| 25° C. (Cp) | | | |

^{a} Molecular Weight averages by GPC relative to PS standards; Coupling Efficiency based on % cumulative GPC areas;
^{b} Vinyl in wt % based on total butadiene units by RMN 1 H 300 MHz;
^{c} Block Vinyl Aromatic in wt % by OsO4 degradative oxidation.

The novel modified diene copolymer compositions MDC 16-22 were characterized by GPC, 1H NMR, Block Vinyl Aromatic copolymer via Degradative Oxidation, Toluene Solution Viscosities 5.23 and 25 wt % @ 25° C. and Melt Flow Index 5 kg @q. 190 and 200° C. methodologies to determine: molecular weight and molecular weight distribution characteristics such as peak molecular weight (Mp Linear A-B-C and Mp Coupled (A-B)n-X), coupled (A-B)n-X content, coupled degree (Mp Coupled/Mp Linear), weight average molecular weight (Mw) and polydispersity (Mw/Mn) for linear modified A-B-C and coupled (A-B)n-X copolymers and block vinyl aromatic copolymer degradation product; microstructural characteristics such as Total Styrene content, Total p-MethylStyrene content, Block Vinyl Aromatic copolymer content, and Vinyl B blocks content. In addition, calculations of the peak molecular weight (Mp) of p-MethylStyrene and number of p-MethylStyrene monomer units in the terminal C block homopolymers were performed based on calculated absolute molecular weight, mass fraction of p-MethylStyrene and molecular weight of p-MethylStyrene monomer. Table 7 enlist the analytical characterization results and Table 8 the polymerization conditions for MDC 16-22. The following describes the general procedure used to prepare these novel modified diene copolymer compositions MDC 16-22 and to control the anionic copolymerization of 1,3-butadiene (B), styrene (S) and p-methylstyrene (pMS). The abbreviations used in Table 8 below for the polymerization conditions are defined as follows: STY=styrene; BD=1,3-butadiene; and p-MS=p-methylstyrene.

TABLE 6
Modified Diene Copolymer Compositions

| Polymer Name | Control | MDC 14 | MDC 15 |
|---|---|---|---|
| BD (wt %)^{a} | 75.0 | 65.0 | 70.0 |
| STY (wt %)^{a} | 25.0 | 25.0 | 25.0 |
| p-MS (wt %)^{a} | 0.0 | 10.0 | 5.0 |
| Reactor Volume (L) | 7.6 | 7.6 | 7.6 |
| Initial Temperature Ti (° C.) | 60.1 | 59.6 | 61.1 |
| First Peak Temperature Tp1 (° C.) | 66.6 | 71.4 | 69.1 |
| First Polymerization Time (min) | 4.0 | 7.0 | 6.0 |
| Final Peak Temperature Tp2 (° C.) | 110.9 | 106.8 | 104.3 |
| Final Polymerization Time (min) | 21.0 | 25.0 | 24.0 |

^{a}wt % of Total Monomer Mixture

The novel modified diene copolymer compositions MDC 16-22 of the present invention were prepared in a 7.6 Liter reactor system operated under inert nitrogen atmosphere in batch and/or semi-batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the first polymerization step, an appropriate amount of purified solvent (i.e., cyclohexane) was charged into the reactor and heated to a target initial reaction temperature (Ti) of about 50° C. Once Ti was reached, a suitable polar modifier such as ditetrahydrofurylpropane (DTHFP) or tetrahydrofuran (THF) was added into the reactor to promote efficient initiation, and then the addition of unsubstituted vinyl aromatic monomer (STY) of about 22.0 wt % of total monomer mixture. The reaction mixture was stabilized at Ti from about 49.6 to about 50.8° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for first polymerization time from about 3 to about 4 min, up to complete conversion and the first peak temperature (Tp1) was then allowed to increase to from about 55.8 to about 60.0° C., thereby forming the living A homopolymer block or segment of the present invention with peak molecular weight Mp about a target of about 11.5 to about 14.5 kg/mol.

For the second polymerization step, the monomer addition was carried out in a programmed batch and/or semi-batch mode. The addition of conjugated diene monomer (BD) of about 68 wt % of total monomer mixture was slowly charged into the reactor at a specified dose rate of from about 60 g/min for a predetermined dosification time of from about 4 to about 5 min. The amount of polar modifier (i.e., ditetrahydrofurfurylpropane) was adjusted from about 0.023 to about 0.029 wt % of total reaction mixture to promote the formation of vinyl microstructure (1,2-addition) along the copolymer chain. This second polymerization step was then allowed to proceed adiabatically for final polymerization time from about 23 to about 28 min up to complete conversion, and the final peak temperature (Tp2) was then allowed to increase to from about 81.7 to about 88.3° C., thereby forming the B block or segment and thus obtaining the living modified A-B diene copolymer with target peak molecular weight Mp of from about 85 to about 110 kg/mol.

For the third step, a suitable coupling agent such as dimethyldichlorosilane ((CH3)2SiCl2) in a sufficient amount of from about 0.0034 to about 0.0043 wt % of total reaction mixture was added to the reactor to partially couple the living modified A-B diene copolymer to obtain the desired ratios of living linear A-B diene copolymer to coupled radial (A-B)n-X compositions of the present invention, wherein X is the residual moiety from the coupling reaction process.

Finally, the remaining living linear A-B diene copolymer was modified with the addition of substituted vinyl aromatic monomer or unsubstituted vinyl aromatic monomer (pMS or STY) of about 10.0 wt % of total monomer mixture. The final polymerization step proceeded adiabatically for a polymerization time from about 10 to about 30 min up to complete conversion to form the terminal C block or segment, thereby forming the living modified A-B-C diene copolymer of the present invention with target peak molecular weights Mp from about 85 to about 110 kg/mol. Finally, the remaining living polymer chains were terminated by adding a 10 mol % excess over the stoichiometric amount of a suitable alcohol to the final reaction mixture, and thus obtaining the novel modified diene copolymers MDC 16-22.

Table 7 list the analytical characterization results for the novel modified diene copolymer compositions MDC 16-22. All the molecular weights (Mp and Mw) are given in units of 1000 (k) (i.e., kg/mol) and calculated relative to polystyrene standards by GPC. The MDC 16-22 molecular weights and molecular weight distributions for the linear modified A-B-C diene copolymer or [S]-[B]-[pMS] and coupled (A-B)n-X or [S-B]n-X are: peak molecular weights Mp linear modified A-B-C diene copolymer range from about 81 to about 114 kg/mol and Mp coupled (A-B)n-X range from about 156 to about 217 kg/mol; coupled degrees Mp coupled/Mp linear range from about 1.79 to about 1.99; coupled contents (A-B)n-X ranges from 20.7 to about 24.4%; weight average molecular weights Mw linear modified A-B-C diene copolymer and coupled (A-B)n-X range from about 99 to about 137 kg/mol; and the polydispersities Mw/Mn Mw linear modified A-B-C diene copolymer and coupled (A-B)n-X range from about 1.07 to about 1.10. The MDC 14-15 characterization results estimated by NMR are: total contents of unsubstituted vinyl aromatic monomer (Total Styrene) of from about 22.0 to about 31.7 wt % based on total modified diene copolymer; total contents of substituted vinyl aromatic monomer (Total p-MethylStyrene) range from about 7.1 to about 7.3 wt % based on total modified diene copolymer; and vinyl B blocks contents range from about 38.2 to about 49.6 wt % based on total conjugated diene monomer (BD) units in the modified diene copolymer. The MDC 16-22 calculated peak molecular weights Mp of p-MethylStyrene range from about 3.65 to about 4.97 kg/mol in the linear modified A-B-C diene copolymers; and calculated numbers of p-MethylStyrene monomer units range from about 31 to about 42 units in the linear modified A-B-C diene copolymers. The MDC 16-22 molecular weights and molecular weight distributions for the block of vinyl aromatic copolymer obtained via degradative oxidation of the modified diene copolymers are: peak molecular weights Mp range from about 11.4 to about 21.5 kg/mol; and the polydispersities Mw/Mn range are from about 1.00 to about 1.06; and block vinyl aromatic copolymer contents via degradative oxidation (Block Vinyl Aromatic) range from about 28.0 to about 33.6 wt % based on total modified diene copolymer. MDC 16-22 toluene solution viscosities at 5.23 wt % and 25° C. range from about 4.45 to about 6.91 cP. MDC 16-22 toluene solution viscosities at 25 wt % and 25° C. range from about 312 to about 1,056 cP. MDC 16-22 melt flow index at 5 kg and 200° C. range from about 4.5 to about 51.3 g/10 min. MDC 16-22 melt flow index at 5 kg and 190° C. range from about 1.2 to about 35.8 g/10 min.

### Example 5

Preparation of Modified Diene Copolymer Compositions (MDC)

In Example 5, several novel modified diene copolymer compositions MDC 23-26 were prepared in accordance to the process claimed in the present invention. The novel modified diene copolymer compositions MDC 23-26 formed a modified A-B-C copolymer comprising reacting at least one conjugated diene monomer and at least one unsubstituted vinyl aromatic monomer and at least one substituted vinyl aromatic monomer under alkyllithium-initiated living polymerization conditions, and wherein each block or segment in the modified A-B-C copolymer is either a homopolymer or a copolymer comprising at least one conjugated diene monomer and/or at least one unsubstituted vinyl aromatic monomer and/or at least one substituted vinyl aromatic monomer; and a block copolymer made from the modified A-B copolymer with a coupling agent after the complete polymerization of the B block and before polymerizing the C block, and wherein the block copolymer comprises at least two of the modified A-B copolymers.

TABLE 7
Modified Diene Copolymer Compositions

| | MDC | MDC | MDC | MDC | MDC | MDC | MDC |
|---|---|---|---|---|---|---|---|
| Polymer Name | 16 | 17 | 18 | 19 | 20 | 21 | 22 |
| Mp Linear A-B (kg/mol) | 84 | 86 | 81 | 85 | 111 | 114 | 109 |
| Mp Coupled (A-B)n-X (kg/mol) | 167 | 156 | 160 | 156 | 217 | 204 | 197 |
| Mp Coupled/Mp Linear (kg/mol) | 1.98 | 1.81 | 1.99 | 1.84 | 1.96 | 1.79 | 1.80 |
| Coupled (A-B)n-X (%) | 23.5 | 20.7 | 22.9 | 20.7 | 24.4 | 22.6 | 22.3 |
| Mw A-B-C + (A-B)n-X (kg/mol) | 104 | 101 | 99 | 101 | 137 | 135 | 129 |
| Mw/Mn A-B-C + (A-B)n-X | 1.09 | 1.08 | 1.09 | 1.07 | 1.10 | 1.08 | 1.08 |
| Total Styrene (wt %) | 31.5 | 22.0 | 31.7 | 22.0 | 31.4 | 22.0 | 22.0 |
| Total p-MethylStyrene (wt %) | 0.0 | 7.3 | 0.0 | 7.2 | 0.0 | 7.3 | 7.1 |
| Mp p-MethylStyrene calcd. (kg/mol) | | 3.75 | | 3.65 | | 4.97 | 4.62 |
| Monomer Units p-MethylStyrene calcd. | | 32 | | 31 | | 42 | 39 |
| Block Vinyl Aromatic (wt %) | 32.2 | 28.7 | 33.6 | 31.1 | 31.4 | 28.0 | 28.6 |
| Mp Block Vinyl Aromatic (kg/mol) | 16.6 | 11.4 | 16.4 | 11.5 | 21.5 | 15.0 | 14.2 |
| Mw/Mn Block Vinyl Aromatic | 1.01 | 1.04 | 1.02 | 1.04 | 1.01 | 1.06 | 1.05 |
| Vinyl B (wt %) | 43.8 | 44.9 | 49.6 | 49.1 | 40.5 | 38.2 | 49.2 |
| Toluene Solution Viscosity @ 5.23%, 25° C. (Cp) | 4.78 | 5.08 | 4.45 | 4.64 | 6.74 | 6.91 | 6.15 |
| Toluene Solution Viscosity @ 25%, 25° C. (Cp) | 386 | 401 | 312 | 405 | 1056 | 906 | 734 |
| Melt Flow Index @ 200° C., 5 kg (g/10 min) | 20.6 | 45.2 | 30.7 | 51.3 | 1.5 | 4.5 | 7.3 |
| Melt Flow Index @ 190° C., 5 kg (g/10 min) | 14.5 | 31.7 | 22.3 | 35.8 | 1.2 | 3.0 | 5.1 |

^{a} Molecular Weight averages by GPC relative to PS standards;
Coupling Efficiency based on % cumulative GPC areas;
^{b} Vinyl in wt % based on total butadiene units by RMN 1H 300 MHz;
^{c} Block Vinyl Aromatic in wt % by OsO4 degradative oxidation.

TABLE 8
Modified Diene Copolymer Compositions

| | MDC | MDC | MDC | MDC | MDC | MDC | MDC |
|---|---|---|---|---|---|---|---|
| Polymer Name | 16 | 17 | 18 | 19 | 20 | 21 | 22 |
| BD (wt %)^{a} | 68.0 | 68.0 | 68.0 | 68.0 | 68.0 | 68.0 | 68.0 |
| STY (wt %)^{a} | 32.0 | 22.0 | 32.0 | 22.0 | 32.0 | 22.0 | 22.0 |
| p-MS (wt %)^{a} | 0.0 | 10.0 | 0.0 | 10.0 | 0.0 | 10.0 | 10.0 |
| Reactor Volume (L) | 7.6 | 7.6 | 7.6 | 7.6 | 7.6 | 7.6 | 7.6 |
| Initial Temperature Ti (° C.) | 49.8 | 49.7 | 49.6 | 50.8 | 50.5 | 50.5 | 50.3 |
| First Peak Temperature Tp1 (° C.) | 58.1 | 55.8 | 58.6 | 58.8 | 60.0 | 57.9 | 57.5 |
| First Polymerization Time (min) | 3.0 | 3.0 | 3.0 | 3.0 | 4.0 | 3.0 | 3.0 |
| Final Peak Temperature Tp2 (° C.) | 81.7 | 82.0 | 84.0 | 86.6 | 84.5 | 88.3 | 87.1 |
| Final Polymerization Time (min) | 25.0 | 26.0 | 23.0 | 23.0 | 28.0 | 26.0 | 24.0 |

^{a}wt % of Total Monomer Mixture

The novel modified diene copolymer compositions MDC 23-26 were characterized by GPC, 1H NMR, Block Vinyl Aromatic copolymer via Degradative Oxidation, and Toluene Solution Viscosities 5.23 @ 25° C. methodologies to determine: molecular weight and molecular weight distribution characteristics such as peak molecular weight (Mp Linear A-B-C and Mp Coupled (A-B)n-X), coupled (A-B)n-X content, coupled degree (Mp Coupled/Mp Linear), weight average molecular weight (Mw) and polydispersity (Mw/Mn) for linear modified A-B-C and coupled (A-B)n-X copolymers, and block vinyl aromatic copolymer degradation product; composition and microstructure characteristics such as Total Styrene content, Total p-MethylStyrene content, Block Vinyl Aromatic copolymer content, and Vinyl B blocks content. In addition, calculations of the peak molecular weight (Mp) of p-MethylStyrene and number of p-MethylStyrene monomer units in the terminal C block homopolymers were performed based on calculated absolute molecular weight, mass fraction of p-MethylStyrene and molecular weight of p-MethylStyrene monomer. Table 9 enlist the analytical characterization results and Table 10 the polymerization conditions for MDC 23-26. The following describes the general procedure used to prepare these novel modified diene copolymer compositions MDC 23-26 and to control the anionic copolymerization of 1,3-butadiene (B), styrene (S) and p-methylstyrene (pMS). The abbreviations used in Table 10 below for the polymerization conditions are defined as follows: STY=styrene; BD=1,3-butadiene; and p-MS=p-methylstyrene.

The novel modified diene copolymer compositions MDC 23-26 of the present invention were prepared in a 7.6 Liter reactor system operated under inert nitrogen atmosphere in batch and/or semi-batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the first polymerization step, an appropriate amount of purified solvent (i.e., cyclohexane) was charged into the reactor and heated to a target initial reaction temperature (Ti) of about 60° C. Once Ti was reached, a suitable polar modifier such as ditetrahydrofurylpropane (DTHFP) or tetrahydrofuran (THF) was added into the reactor to promote efficient initiation, and then the addition of unsubstituted vinyl aromatic monomer (STY) of about 40.0 wt % of total monomer mixture. The reaction mixture was stabilized at Ti from about 61.0 to about 66.4° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for first polymerization time from about 3 to about 4 min, up to complete conversion and the first peak temperature (Tp1) was then allowed to increase to from about 72.3 to about 80.0° C., thereby forming the living A homopolymer block or segment of the present invention with target peak molecular weight Mp of about 12.0 kg/mol.

For the second polymerization step, the monomer addition was carried out in a programmed batch and/or semi-batch mode. The addition of conjugated diene monomer (BD) of about 50 wt % of total monomer mixture was slowly charged into the reactor at a specified dose rate of from about 60 g/min for a predetermined dosification time of from about 4 to about 5 min. The amount of polar modifier (i.e., ditetrahydrofurfurylpropane) was adjusted to about 0.0017 wt % of total reaction mixture to promote efficient imitation without significant formation of vinyl microstructure (1,2-addition) along the copolymer chain. This second polymerization step was then allowed to proceed adiabatically for final polymerization time from about 20 to about 22 min up to complete conversion, and the final peak temperature (Tp2) was then allowed to increase to from about 95.4 to about 100.3° C., thereby forming the B block or segment and thus obtaining the living modified A-B diene copolymer with target peak molecular weight Mp of about 48.0 kg/mol.

For the third step, a suitable coupling agent such as silicon tetrachloride (SiCl4) in a sufficient amount of from about 0.0105 to about 0.0141 wt % of total reaction mixture was added to the reactor to partially couple the living modified A-B diene copolymer to obtain the desired ratios of living linear A-B diene copolymer to coupled radial (A-B)n-X compositions of the present invention, wherein X is the residual moiety from the coupling reaction process.

Finally, the remaining living linear A-B diene copolymer was modified with the addition of substituted vinyl aromatic monomer (pMS) of about 10.0 wt % of total monomer mixture. The final polymerization step proceeded adiabatically for a polymerization time from about 10 to about 30 min up to complete conversion to form the terminal C block or segment, thereby forming the living modified A-B-C diene copolymer of the present invention with target peak molecular weights Mp of about 52.5 kg/mol. Finally, the remaining living polymer chains were terminated by adding a 10 mol % excess over the stoichiometric amount of a suitable alcohol to the final reaction mixture, and thus obtaining the novel modified diene copolymers MDC 23-26.

Table 9 list the analytical characterization results for the novel modified diene copolymer compositions MDC 23-26. All the molecular weights (Mp and Mw) are given in units of 1000 (k) (i.e., kg/mol) and calculated relative to polystyrene standards by GPC. The MDC 23-26 molecular weights and molecular weight distributions for the linear modified A-B-C diene copolymer or [S]-[B]-[pMS] and coupled (A-B)n-X or [S-B]n-X are: peak molecular weights Mp linear modified A-B-C diene copolymer range from about 47.5 to about 57.1 kg/mol and Mp coupled radial (A-B)n-X range from about 116 to about 134 kg/mol; coupled degrees Mp coupled/Mp linear range from about 2.29 to about 2.64; coupled contents (A-B)n-X ranges from 60.2 to about 71.4%; weight average molecular weights Mw of linear modified A-B-C diene copolymer and coupled radial (A-B)n-X range from about 93.8 to about 109 kg/mol; and the polydispersities Mw/Mn of linear modified A-B-C diene copolymer and coupled radial (A-B)n-X range from about 1.20 to about 1.45. The MDC 23-26 characterization results estimated by NMR are: total contents of unsubstituted vinyl aromatic monomer (Total Styrene) of from about 36.2 to about 40.0 wt % based on total modified diene copolymer; total contents of substituted vinyl aromatic monomer (Total p-MethylStyrene) range from about 1.9 to about 8.4 wt % based on total modified diene copolymer; and vinyl B blocks contents range from about 11.7 to about 13.5 wt % based on total conjugated diene monomer (BD) units in the modified diene copolymer. The MDC 23-26 calculated peak molecular weights Mp of p-MethylStyrene range from about 0.66 to about 2.69 kg/mol in the linear modified A-B-C diene copolymers; and calculated numbers of p-MethylStyrene monomer units range from about 6 to about 23 units in the linear modified A-B-C diene copolymers. The MDC 23-26 molecular weights and molecular weight distributions for the block of vinyl aromatic copolymer obtained via degradative oxidation of the modified diene copolymers are: peak molecular weights Mp range from about 7.70 to about 10.3 kg/mol; and the polydispersities Mw/Mn range are from about 1.06 to about 1.15; and block vinyl aromatic copolymer contents via degradative oxidation (Block Vinyl Aromatic) range from about 37.5 to about 46.6 wt % based on total modified diene copolymer. MDC 23-26 toluene solution viscosities at 5.23 wt % and 25° C. range from about 3.56 to about 4.30 cP.

### Example 6

Preparation of Modified Diene Copolymer Compositions (MDC)

In Example 6, several novel modified diene copolymer compositions MDC 27-28 were prepared in accordance to the process claimed in the present invention. The novel modified diene copolymer compositions MDC 27-28 formed a modified A-B-C copolymer comprising reacting at least one conjugated diene monomer and at least one unsubstituted vinyl aromatic monomer and at least one substituted vinyl aromatic monomer under alkyllithium-initiated living polymerization conditions, and wherein each block or segment in the modified A-B-C copolymer is either a homopolymer or a copolymer comprising at least one conjugated diene monomer and/or at least one unsubstituted vinyl aromatic monomer and/or at least one substituted vinyl aromatic monomer.

TABLE 9
Modified Diene Copolymer Compositions

| | | MDC | MDC | MDC | MDC |
|---|---|---|---|---|---|
| Polymer Name | Control | 23 | 24 | 25 | 26 |
| Mp Linear A-B (kg/mol) | 42.6 | 55.5 | 57.1 | 50.2 | 47.5 |
| Mp Coupled (A-B)n-X (kg/mol) | 146 | 134 | 130 | 116 | 125 |
| Mp Coupled/Mp Linear (kg/mol) | 3.43 | 2.41 | 2.29 | 2.32 | 2.64 |
| Coupled (A-B)n-X (%) | 64.8 | 66.6 | 69.0 | 71.4 | 60.2 |
| Mw A-B-C + (A-B)n-X (kg/mol) | 110 | 109 | 108 | 96.7 | 93.8 |
| Mw/Mn A-B-C + (A-B)n-X | 1.65 | 1.25 | 1.23 | 1.20 | 1.45 |
| Total Styrene (wt %) | 39.7 | 36.2 | 40.0 | 40.0 | 40.0 |
| Total p-MethylStyrene (wt %) | 0.0 | 1.9 | 7.1 | 7.5 | 8.4 |
| Mp p-MethylStyrene calcd. (kg/mol) | | 0.66 | 2.69 | 2.51 | 2.67 |
| Monomer Units p-MethylStyrene calcd. | | 6 | 23 | 21 | 23 |
| Block Vinyl Aromatic (wt %) | 38.7 | 37.5 | 46.2 | 46.6 | 46.4 |
| Mp Block Vinyl Aromatic (kg/mol) | 10.9 | 7.7 | 10.2 | 9.3 | 10.3 |
| Mw/Mn Block Vinyl Aromatic | 1.03 | 1.15 | 1.12 | 1.10 | 1.06 |
| Vinyl B (wt %) | 12.5 | 13.2 | 13.5 | 13.3 | 11.7 |
| Toluene Solution Viscosity @ 5.23%, | 4.89 | 4.30 | 3.91 | 3.56 | 3.69 |
| 25° C. (Cp) | | | | | |

^{a} Molecular Weight averages by GPC relative to PS standards; Coupling Efficiency based on % cumulative GPC areas;
^{b} Vinyl in wt % based on total butadiene units by RMN 1 H 300 MHz;
^{c} Block Vinyl Aromatic in wt % by OsO4 degradative oxidation.

TABLE 10
Modified Diene Copolymer Compositions

| | | MDC | MDC | MDC | MDC |
|---|---|---|---|---|---|
| Polymer Name | Control | 23 | 24 | 25 | 26 |
| BD (wt %)^{a} | 60.0 | 60.0 | 60.0 | 60.0 | 60.0 |
| STY (wt %)^{a} | 40.0 | 40.0 | 40.0 | 40.0 | 40.0 |
| p-MS (wt %)^{a} | 0.0 | 10.0 | 10.0 | 10.0 | 10.0 |
| Reactor Volume (L) | 7.6 | 7.6 | 7.6 | 7.6 | 7.6 |
| Initial Temperature Ti (° C.) | 62.0 | 61.3 | 61.0 | 61.8 | 66.4 |
| First Peak Temperature Tp1 (° C.) | 78.0 | 72.3 | 74.6 | 74.5 | 80.0 |
| First Polymerization Time (min) | 4.0 | 4.0 | 4.0 | 3.0 | 3.0 |
| Final Peak Temperature Tp2 (° C.) | 105.8 | 100.3 | 95.5 | 95.4 | 98.6 |
| Final Polymerization Time (min) | 21.0 | 21.0 | 22.0 | 20.0 | 22.0 |

^{a}wt % of Total Monomer Mixture

The novel modified diene copolymer compositions MDC 27-28 were characterized by GPC, 1H NMR, Block Vinyl Aromatic copolymer via Degradative Oxidation, Toluene Solution Viscosities 5.23 @q. 25° C. and Melt Flow Index 5 kg @ 190° C. methodologies to determine: molecular weight and molecular weight distribution characteristics such as peak molecular weight (Mp Linear A-B-C), weight average molecular weight (Mw) and polydispersity (Mw/Mn) for linear modified A-B-C; composition and microstructure characteristics such as Total Styrene content, Total p-MethylStyrene content, Block Vinyl Aromatic copolymer content, and Vinyl B blocks content. In addition, calculations of the peak molecular weight (Mp) of p-MethylStyrene and number of p-MethylStyrene monomer units in the modified A-B-C diene copolymers were performed based on calculated absolute molecular weight, mass fraction of p-MethylStyrene and molecular weight of p-MethylStyrene monomer. Table 11 enlist the analytical characterization results and Table 12 the polymerization conditions for MDC 27-28. The following describes the general procedure used to prepare these novel modified diene copolymer compositions MDC 27-28 and to control the anionic copolymerization of 1,3-butadiene (B), styrene (S) and p-methylstyrene (pMS). The abbreviations used in Table 12 below for the polymerization conditions are defined as follows: STY=styrene; BD=1,3-butadiene; and p-MS=p-methylstyrene.

The novel modified diene copolymer compositions MDC 27-28 of the present invention were prepared in a 7.6 Liter reactor system operated under inert nitrogen atmosphere in batch and/or semi-batch mode in accordance to the teachings of the present invention. Immediately before addition to the reactor system, solvent and monomers were thoroughly purified to decrease their moisture content to a maximum of 5 ppm by flowing through a set of columns packed with alumina and molecular sieves. For the first polymerization step, an appropriate amount of purified solvent (i.e., cyclohexane) was charged into the reactor and heated to a target initial reaction temperature (Ti) of about 60° C. Once Ti was reached, a suitable polar modifier such as ditetrahydrofurylpropane (DTHFP) or tetrahydrofuran (THF) was added into the reactor to promote efficient initiation, and then the addition of unsubstituted vinyl aromatic monomer (STY) of about 30.0 wt % of total monomer mixture. The reaction mixture was stabilized at Ti from about 59.5 to about 63.1° C., and then n-butyllithium was added directly into the reactor mixture to efficiently initiate the anionic polymerization of the monomer mixture and formed the living polymer. The amount of initiator was stoichiometrically calculated as described in the literature to form blocks or segments with the desired molecular weight and to compensate for residual impurities. The polymerization step proceeded adiabatically for first polymerization time from about 4 to about 5 min, up to complete conversion and the first peak temperature (Tp1) was then allowed to increase to from about 65.8 to about 72.4° C., thereby forming the living A homopolymer block or segment of the present invention with target peak molecular weight Mp of about 25.0 kg/mol.

For the second polymerization step, the monomer additions were carried out in a programmed batch and/or semi-batch mode. The addition of all the monomers was simultaneously initiated for MDC 27-28, a substituted vinyl aromatic monomer (pMS) addition of about 0 to about 5 wt % of total monomer mixture was rapidly charged into the reactor at a specified dose rate of about 130 g/min during a predetermined dosification time of about 2 min, and the addition of conjugated diene monomer (BD) of about 60 wt % of total monomer mixture was slowly charged into the reactor at a specified dose rate of from about 60 g/min for a predetermined dosification time of from about 4 to about 5 min. The amount of polar modifier (i.e., ditetrahydrofurfurylpropane) was adjusted to about 0.0017 wt % of total reaction mixture to promote efficient imitation without significant formation of vinyl microstructure (1,2-addition) along the copolymer chain. This second polymerization step was then allowed to proceed adiabatically for final polymerization time from about 24 to about 25 min up to complete conversion, and the final peak temperature (Tp2) was then allowed to increase to from about 95.5 to about 104.0° C., thereby forming the modified B block or segment and thus obtaining the living modified A-B diene copolymer with target peak molecular weight Mp of from about 122.0 to about 126.0 kg/mol.

Finally, the living modified A-B diene copolymer was further modified with the addition of substituted vinyl aromatic monomer (pMS) of from about 5.0 to about 10.0 wt % of total monomer mixture. The final polymerization step proceeded adiabatically for a polymerization time from about 10 to about 30 min up to complete conversion to form the terminal C block or segment, thereby forming the living modified A-B-C diene copolymer of the present invention with target peak molecular weights Mp of about 130.0 kg/mol. Finally, the remaining living polymer chains were terminated by adding a 10 mol % excess over the stoichiometric amount of a suitable alcohol to the final reaction mixture, and thus obtaining the novel modified diene copolymers MDC 27-28.

Table 11 list the analytical characterization results for the novel modified diene copolymer compositions MDC 27-28. All the molecular weights (Mp and Mw) are given in units of 1000 (k) (i.e., kg/mol) and calculated relative to polystyrene standards by GPC. The MDC 27-28 molecular weights and molecular weight distributions for the linear modified A-B-C diene copolymer or [S]-[B/pMS]-[pMS] or [S]-[B]-[pMS] are: peak molecular weights Mp linear modified A-B-C diene copolymer range from about 127 to about 131 kg/mol; weight average molecular weights Mw of linear modified A-B-C diene copolymer range from about 128 to about 133 kg/mol; and the polydispersities Mw/Mn of linear modified A-B-C diene copolymer range from about 1.02 to about 1.10. The MDC 27-28 characterization results estimated by NMR are: total contents of unsubstituted vinyl aromatic monomer (Total Styrene) of from about 27.5 to about 27.7 wt % based on total modified diene copolymer; total contents of substituted vinyl aromatic monomer (Total p-MethylStyrene) range of about 10.0 wt % based on total modified diene copolymer; and vinyl B blocks contents range from about 14.7 to about 16.6 wt % based on total conjugated diene monomer (BD) units in the modified diene copolymer. The MDC 27-28 calculated peak molecular weights Mp of p-MethylStyrene range from about 7.96 to about 8.22 (i.e., 4.11/4.11) kg/mol in the linear modified A-B-C diene copolymers; and calculated numbers of p-MethylStyrene monomer units range from about 67 to about 70 (i.e., 35/35) units in the linear modified A-B-C diene copolymers. The MDC 27-28 block vinyl aromatic copolymer contents via degradative oxidation (Block Vinyl Aromatic) range from about 33.8 to about 36.8 wt % based on total modified diene copolymer. MDC 27-28 toluene solution viscosities at 5.23 wt % and 25° C. range from about 4.70 to about 6.83 cP. Melt Flow Index 5 kg @ 25° C. range from about 1.3 to about 1.5 g/10 min.

### Example 7

Applications in Adhesives for Tapes and Labels

Test Procedures for Hot Melt Adhesive Performance

Dynamic mechanical analysis (DMA) methodology was performed to study the rheological properties of the hot melt adhesive (prior to coating and with no backing) by using a TA Instruments ARG2 Rheometer in a parallel-plate geometry and auto strain mode. The diameter of the plates was 8 mm and the gap was 1.704 mm. The frequency was 10 rad/s and the heating rate was 3° C./min. The maximum strain was set at 1.0%. Rheology data were very repeatable and the uncertainty in the glass transition was approximately +0.5° C. The rheology experiments allow to predict structure-property relationships and ultimately adhesive performance. These include the first tan delta maximum (tan δ max) temperature, which is a measure of the Tg of the rubbery matrix. In addition, the tan delta maximum (tan δ max) peak height indicates how much energy the adhesive can dissipate. The storage modulus G′ at room temperature (25° C.) was also noted, to quantify how compliant the adhesive was at the application temperature. Further, the temperature at which the G′ modulus meets the Dahlquist criterion of 300,000 Pa for measurable quick tack (i.e., Dahlquist temperature TD) was analyzed. Lastly, the third crossover temperature was measured. The third crossover temperature (tan δ=1), is the temperature near the Tg of the glassy polystyrene domains at which the storage and loss moduli are equal (e.g. same magnitude), and therefore, tan delta is equal to 1. The third crossover temperature (tan δ=1) is the temperature (T3C) where the adhesive begins to flow and loses its cohesive strength, which can be correlated with Ring and Ball softening point temperature (RBSPT) and/or shear adhesion failure temperature (SAFT).

TABLE 11
Modified Diene Copolymer Compositions

| | | MDC | MDC |
|---|---|---|---|
| Polymer Name | Control | 27 | 28 |
| Mp Linear A-B-C (kg/mol) | 129 | 131 | 127 |
| Mw Linear A-B-C (kg/mol) | 130 | 133 | 128 |
| Mw/Mn Linear A-B-C | 1.02 | 1.02 | 1.10 |
| Total Styrene (wt %) | 29.5 | 27.7 | 27.5 |
| Total p-MethylStyrene (wt %) | 0.0 | 10.0 | 10.0 |
| Mp p-MethylStyrene calcd. (kg/mol) | | 8.22 | 7.96 |
| Monomer Units p-MethylStyrene calcd. | | 70 | 67 |
| Block Vinyl Aromatic (wt %) | 29.3 | 33.8 | 36.8 |
| Vinyl B (wt %) | 15.2 | 16.6 | 14.7 |
| Toluene Solution Viscosity @ 5.23%, | 5.77 | 4.70 | 6.83 |
| 25° C. (Cp) | | | |
| Melt Flow Index @ 190° C., | 2.6 | 1.5 | 1.3 |
| 5 kg (g/10 min) | | | |

^{a} Molecular Weight averages by GPC relative to PS standards;
^{b} Vinyl in wt % based on total butadiene units by RMN 1 H 300 MHz;
^{c} Block Vinyl Aromatic in wt % by OsO4 degradative oxidation.

TABLE 12
Modified Diene Copolymer Compositions

| Polymer Name | Control | MDC 27 | MDC 28 |
|---|---|---|---|
| BD (wt %)^{a} | 70.0 | 60.0 | 60.0 |
| STY (wt %)^{a} | 30.0 | 30.0 | 30.0 |
| p-MS (wt %)^{a} | 0.0 | 10.0 | 10.0 |
| Reactor Volume (L) | 7.6 | 7.6 | 7.6 |
| Initial Temperature Ti (° C.) | 65.0 | 59.5 | 63.1 |
| First Peak Temperature Tp1 (° C.) | 72.9 | 65.8 | 72.4 |
| First Polymerization Time (min) | 4.0 | 4.0 | 5.0 |
| Final Peak Temperature Tp2 (° C.) | 107.7 | 95.5 | 104.0 |
| Final Polymerization Time (min) | 22.0 | 25.0 | 24.0 |

^{a}wt % of Total Monomer Mixture

Hot melt adhesive processability and reinforcement performance was measured by following standardized methodologies: a) Rolling ball tack experiments were performed in accordance with PSTC-6. In this experiment, an 11.1 mm diameter generic steel ball is rolled down a bench top ramp on to a 2 in×15 in strip of tape. The distance the ball travels along the tape is recorded. The less the ball rolls down the tape, the tackier the adhesive. The ramp was a Cheminstruments Rolling Ball Tack Tester; b) Loop tack tests were performed on a Cheminstruments Loop Tack Tester in accordance with PSTC-16. The cross-head displacement rate was 5 mm/s. A 1 in×5 in loop of tape was used in the experiments. The free loop of tape, unrestricted by the grips, was 75 mm long. The maximum force per unit width of the specimen was recorded. The initial height, measured from the bottom of the grips to the substrate surface, was 50 mm. The maximum displacement was 44 mm and the dwell time at maximum displacement was 1 s; c) 180° peel test to determine the peel energy or peel force per unit width was measured in accordance with PSTC 101: Peel Adhesion of Pressure Sensitive Tape Test Method A—Single Coated Tapes, Peel Adhesion at 180° Angle. Rectangular strips of 1 in×12 in dimensions were tested using a Universal Testing Machine (UTM) at 5 mm/s cross-head displacement rate; d) Lap shear strength measurements were performed at 23° C. and at −25° C. in accordance with PSTC method. These experiments were conducted to measure room temperature and low/freezing temperature cohesive or shear properties of the adhesive after coating two wood testing specimens and joined them by pressing together with a standard force for a predetermined time at room temperature. Rectangular specimens of 1 in×3 in dimensions were tested using a Universal Testing Machine (UTM) at 5 mm/s cross-head displacement rate; e) Holding power measurements were made in accordance with PSTC-107 method. 180° Shear Adhesion of Pressure Sensitive Tapes using a Cheminstruments Bank Shear Tester. These experiments were conducted to measure the room temperature cohesive or shear properties of the adhesive tape. Instead of the 25 mm×25 mm contact area described in PSTC-107, a 0.5 in×6 in area of PSAT was utilized. The PSAT was adhered to stainless steel coupons with a standard 2 kg roller and a mass of 1 kg was suspended from the tape. The time (min) at which the adhesive failed was recorded as the holding power; f) Tensile performance of the hot melt adhesives was determined on 0.125 in thick, 2.5 in long dogbone shaped portions with 1 in times 1 in end tabs and a 0.5 in times 0.5 in central gage portion. These were pulled on an Instron Testing Machine with pneumatic grips at a speed of 12 in/min. The tensile stress at break and the strain at break of the adhesives were then recorded; g) Melt viscosities of the hot melt adhesives were determined on a Brookfield Model RVT Thermosel viscometer using a number 27 spindle; h) Ring and Ball softening point temperatures were measured by using a Mettler FP83 prop Point Apparatus.

Hot Melt Adhesives of Modified Diene Copolymer Compositions (MDC)

Several hot melt adhesive formulations containing modified diene copolymer compositions of the present invention MDC 1-9 were prepared in accordance to the following procedure. The modified diene copolymer compositions MDC 1-9, described in Tables 1 and 2 of Example 1, were mixed with the materials and amounts described below. Each modified diene copolymer composition MDC was mixed with the rest of the components/additives of the hot melt adhesive formulation by first placing compatible tackifying resin such as Piccotac 8095 aromatic modified C5 hydrocarbon resin, oil such as Nyflex 223 and antioxidant such as Irganox 1010 in a jacketed mixing kettle equipped with a 3-blade propeller shear agitator Eurostar Power Control-Vic IKA, and there upon the temperature was raised to a range of from about 165° C. up to about 177° C. for about 30 minutes or until the mixture was melted. After the mixture was melted, the temperature was lowered to from about 1500 to 165° C., the mixture was initially stirred at about 250 rpm, and then a modified diene copolymer composition MDC was slowly added into the mixture for about 5 to 10 minutes during which the stirring speed was increased to about 400 rpm and finally up to about 750 rpm while promoting the incorporation of the polymer into the increasingly viscous mixture and avoiding clumping of unmelted polymer particles. Then, mixing at about 750 rpm and heating at about 170° C. was continued for a period of about 120 minutes or until a smooth and homogeneous mass was observed, thereby obtaining the novel hot melt adhesive composition of the present invention containing the modified diene copolymer MDC and the rest of the components/additives of the hot melt adhesive formulation. Immediately after mixing was finished, the novel hot melt adhesive composition was applied to a substrate such as Mylar at a temperature range of from about 160° C. to about 170° C. to obtain an adhesive coating layer within specifications for testing protocols.

The hot melt adhesive formulations of modified diene copolymer compositions MDC 1-9 consisted of the following amounts in parts per hundred of rubber (phr): 120.00 phr tackifying resin Piccotac 8095; 20.00 phr Nyflex 223 oil, and 4.00 phr Irganox 1010, based on the total amount (i.e., 100.00 phr) of modified diene copolymer composition in the hot melt adhesive formulation.

The novel hot melt adhesive compositions MDC 1-9 containing a modified diene copolymer of the present invention were characterized by dynamic mechanical analysis (DMA) according with the testing procedure and methodology described in Example 7, as shown in Table 13. Dynamic mechanical analysis (DMA) methodology at 10 rad/s and 3° C./min was performed to predict structure-property relationships and ultimately adhesive performance. The first tan delta maximum (tan δ max) temperature, which is a measure of the Tg of the rubbery matrix, gradually increases with increasing replacement of unsubstituted vinyl aromatic monomer (S) by substituted vinyl aromatic monomer (pMS) in the modified diene copolymer composition: Control without pMS shows Tg of about −27.6° C.; and MDC 1-9 increase from Tg of about −28.5° C. for MDC 1 with 1 wt % pMS to Tg of about −19.2° C. for MDC 9 with 20 wt % pMS. In addition, the tan delta maximum (tan δ max) peak height indicates how much energy the adhesive can dissipate. All the novel hot melt adhesive compositions MDC 1-9 containing a modified diene copolymer composition show good energy dissipation capability: tan δ max peak height from about 1.130 for MDC 4 with 6.25 wt % pMS to about 1.199 for MDC 9 with 20 wt % pMS in the modified diene copolymer composition, which includes tan δ max peak height of about 1.144 for the Control without pMS. The storage modulus G′ at room temperature (25° C.) was also noted, to quantify how compliant the adhesive was at the application temperature. All the novel hot melt adhesive compositions MDC 1-9 containing a modified diene copolymer composition show low storage modulus G′ at 25° C. of from about 91,300 to about 281,000 Pa, which is well below the Dahlquist criterion: G′ at 25° C.≤300,000 Pa for measurable quick tack. The storage modulus G′ at 25° C. decreases with increasing replacement of unsubstituted vinyl aromatic monomer (S) by substituted vinyl aromatic monomer (pMS) in the modified diene copolymer composition: Control without pMS shows G′ at 25° C. of about 281,000 Pa; and MDC 1-9 decrease from G′ at 25° C. of about 281,000 Pa for MDC 3 with 5 wt % pMS to G′ at 25° C. of about 231,000 Pa for MDC 9 with 20 wt % pMS. The temperature at which the G′ modulus meets the Dahlquist criterion maximum: G′ at 25° C.≈300,000 Pa for measurable quick tack (i.e., Dahlquist temperature TD) of the novel hot melt adhesive compositions of the present invention apparently decreases with increasing replacement of unsubstituted vinyl aromatic monomer (S) by substituted vinyl aromatic monomer (pMS) in the modified diene copolymer composition: Control without pMS shows TD of about 24.7° C. and TD decreases to about 19.2° C. for MDC 9 with 20 wt % pMS. Lastly, the third crossover temperature was measured. The third crossover temperature (tan δ=1), is the temperature near the Tg of the glassy polystyrene domains at which the storage and loss moduli are equal (e.g. same magnitude), and therefore, tan delta is equal to 1. The third crossover temperature (tan δ=1) is the temperature where the adhesive begins to flow and loses its cohesive strength, which can be correlated with Ring and Ball softening point temperature (RBSPT) and/or shear adhesion failure temperature (SAFT). The third crossover temperature (T3C) of the novel hot melt adhesive compositions MDC 1-9 containing a modified diene copolymer of the present invention decreases with increasing replacement of unsubstituted vinyl aromatic monomer (S) by substituted vinyl aromatic monomer (pMS) in the modified diene copolymer composition: Control without pMS shows T3C of about 72.3° C.; and MDC 1-9 decrease from T3C of about 69.2° C. for MDC 3 with 5 wt % pMS to T3C of about 66.4° C. for MDC 9 with 20 wt % pMS. Surprisingly, the viscoelastic spectra (G′ and Tan delta vs. Temperature) of the novel hot melt adhesive compositions MDC 1-9 predict that, with increasing replacement of unsubstituted vinyl aromatic monomer (S) by substituted vinyl aromatic monomer (pMS) in the modified diene copolymer composition of the present invention, the adhesive performance may show not only an increasingly narrower (i.e., 14° C.) temperature performance application window but also an increasingly more compliant adhesive with measurable quick tack and good energy dissipation capability.

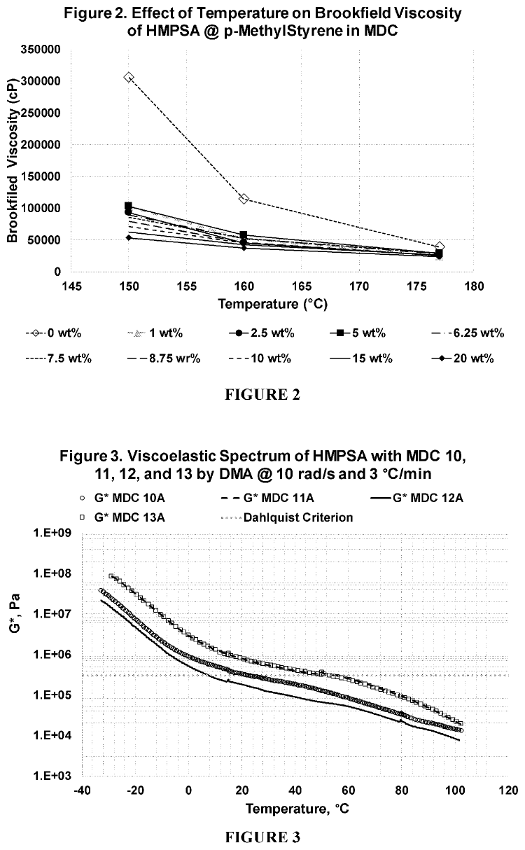

The performance of the novel hot melt adhesive compositions MDC 1-9 containing a modified diene copolymer of the present invention was characterized according with the testing procedures described in Example 7, as shown in Table 13 and FIGS. 1 and 2. Brookfield melt viscosities of the hot melt adhesives MDC 1-9 were determined at 150, 160 and 177° C. Brookfield melt viscosities decrease with increasing replacement of unsubstituted vinyl aromatic monomer (S) by substituted vinyl aromatic monomer (pMS) in the modified diene copolymer composition: Control without pMS shows Brookfield melt viscosities of about 306,000 cP at 150° C., 115,000 cP at 160° C. and 39,500 cP at 177° C.; and MDC 1-9 decrease from Brookfield melt viscosities of about 103,000 cP at 150° C., 57,813 cP at 160° C. and 29,133 cP at 177° C. for MDC 3 with 5 wt % pMS to Brookfield melt viscosities of about 53,812 cP at 150° C., 37,500 cP at 160° C. and 24,063 cP at 177° C. for MDC 9 with 20 wt % pMS. FIGS. 1 and 2 show that Brookfield melt viscosities decrease with increasing replacement of unsubstituted vinyl aromatic monomer (S) by substituted vinyl aromatic monomer (pMS) in the modified diene copolymer compositions MDC 1-9. The decreasing effect of Brookfield melt viscosities at 150, 160 and 177° C. (i.e., Δη≥−40%) is very significant for MDC 1 with only 1 wt % pMS when compared with Control without pMS, and even more significant for MDC 9 with 20 wt % pMS in the modified diene copolymer composition. The Brookfield melt viscosities at 150° C. decrease from about 306,000 cP for Control without pMS to about 102,000 cP for MDC 1 with 1 wt % pMS and to about 53,812 cP for MDC 9 with 20 wt % pMS, which is a very significant decrease at the lowest measurement temperature (i.e., 150° C.) of about 66% for MDC 1 and about 85% for MDC 9. The Brookfield melt viscosities at 160° C. decrease from about 115,000 cP for Control without pMS to about 52,438 cP for MDC 1 with 1 wt % pMS and to about 37,500 cP for MDC 9 with 20 wt % pMS, which is a very significant decrease at the intermediate measurement temperature (i.e., 160° C.) of about 55% for MDC 1 and about 70% for MDC 9. The Brookfield melt viscosities at 177° C. decrease from about 39,500 cP for Control without pMS to about 23,969 cP for MDC 1 with 1 wt % pMS and to about 24,063 cP for MDC 9 with 20 wt % pMS, which is a significant decrease at the highest measurement temperature (i.e., 177° C.) of about 40% for both MDC 1 and MDC 9. All the novel hot melt adhesives MDC 1-9 showed improved processing during application on the substrate for testing procedures. Surprisingly, the decreasing effect of Brookfield melt viscosities is much more substantial at the lowest measurement temperature (150° C.) when compared with Control without pMS. The reduced Brookfield melt viscosity is not only an important processability performance advantage of the novel hot melt adhesives MDC 1-9 over prior art, given that allow for higher production rates and cost efficiencies under the same processing conditions, but also a low energy processability performance advantage, given that allow for lower processing temperatures for the same production rates and cost efficiencies, which is a more environmental-friendly process.

Table 13 and FIG. 1 also show the following characterization of the performance of the novel hot melt adhesive compositions MDC 1-9 containing a modified diene copolymer of the present invention. In FIG. 1, Ring and Ball softening point temperature (TRBSP) slightly decreases with increasing replacement of unsubstituted vinyl aromatic monomer (S) by substituted vinyl aromatic monomer (pMS) in the modified diene copolymer composition: Control without pMS shows TRBSP of about 113.3° C.; and MDC 1-9 decrease from TRBSP of about 108.3° C. for MDC 1 with 1 wt % pMS to TRBSP of about 98.5° C. for MDC 9 with 20 wt % pMS, which show TRBSP decreases from about 5 to about 15% (i.e., 5.0-14.8° C.) that is consistent with the decreasing third crossover temperature (T3C) shown by DMA results. The hot melt adhesive compositions MDC 1-9 180° peel test, which determines the peel energy or peel force (lbf) per unit width in accordance with PSTC-101 method, shows low peel force for most of MDC that is comparable to the hot melt adhesive composition with the Control without pMS. The hot melt adhesive compositions MDC 1-9 loop tack test, which determines the maximum force (lbf) per unit width in accordance with PSTC-16 method, shows low loop tack force for most of MDC that is comparable to the hot melt adhesive composition with the Control without pMS. The hot melt adhesive compositions MDC 1-9 holding power measurement, which determines the time (min) at which the adhesive failed in accordance with PSTC-107 method and correlates to the room temperature cohesive or shear properties, shows very short holding power time for most of MDC that is comparable to the hot melt adhesive composition with the Control without pMS. The hot melt adhesive compositions MDC 1-9 tensile performance, which determines the tensile stress (kgf) at break and the strain (%) at break with universal equipment testing method and correlates to the room temperature cohesive or shear properties, shows low tensile stress for most of MDC that is comparable to the hot melt adhesive composition with the Control without pMS, and also shows strain ranges from about 700 to about 933% for most of MDC that is comparable to the hot melt adhesive composition with the Control without pMS.

The performance of the novel hot melt adhesive compositions MDC 1-9 containing a modified diene copolymer of the present invention provides a very significant improvement in processability (i.e., 40-85% much lower melt viscosity) that is much more substantial at lower temperature (i.e., 150° C.) with slight decrease in high temperature properties (i.e., 5-15% lower TRBSP), compared with prior art compositions.

TABLE 13
Performance of Modified Diene Copolymers in Hot Melt Pressure Sensitive Adhesive Compositions

| | | MDC | MDC | MDC | MDC |
|---|---|---|---|---|---|
| | | 1 | 2 | 3 | 4 |
| Hot Melt Pressure Sensitive Adhesives | Control | HMPSA | HMPSA | HMPSA | HMPSA |
| Brookfield Viscosity @ 150° C. (cP) | 306,000 | 102,000 | 93,250 | 103,000 | 89,300 |
| Brookfield Viscosity @ 160° C. (cP) | 115,000 | 52,438 | 45,450 | 57,813 | 52,813 |
| Brookfield Viscosity @ 177° C. (cP) | 39,500 | 23,969 | 25,250 | 29,133 | 28,500 |
| R&B Softening Point Temperature (° C.) | 113.3 | 108.3 | 109.4 | 107.7 | 108.4 |
| Peel 180° (lb_{f}) | 0.60 | 2.92 | 3.22 | 0.44 | 0.72 |
| Loop Tack (lb_{f}/in2) | 0.17 | 0.02 | 0.00 | 0.17 | 0.15 |
| Holding Power (min-1000 g) | 20.2 | 28.7 | 24.3 | 21.8 | 0.7 |
| Tensile Stress @ Break (kg_{f}) | 0.57 | 0.30 | 0.40 | 0.31 | 0.32 |
| Strain @ Break (%) | 850 | 69 | 94 | 827 | 700 |
| Tan Delta Maximum Tg (° C.) | −27.6 | −28.5 | −27.5 | −22.5 | −22.1 |
| G′ @ 25° C. (Pa) | 2.81 × 105 | 1.57 × 105 | 9.13 × 104 | 2.81 × 105 | 2.62 × 105 |
| G″ @ 25° C. (Pa) | 1.35 × 105 | 9.98 × 104 | 4.7 × 104 | 1.27 × 105 | 1.25 × 105 |
| Crossover Temperature (° C.) | 72.3 | 62.8 | 61.9 | 69.2 | 67.9 |
| | MDC | MDC | MDC | MDC | MDC |
| | 5 | 6 | 7 | 8 | 9 |
| Hot Melt Pressure Sensitive Adhesives | HMPSA | HMPSA | HMPSA | HMPSA | HMPSA |
| Brookfield Viscosity @ 150° C. (cP) | 86,200 | 79,800 | 71,250 | 62,750 | 53,812 |
| Brookfield Viscosity @ 160° C. (cP) | 52,625 | 46,125 | 45,250 | 43,000 | 37,500 |
| Brookfield Viscosity @ 177° C. (cP) | 28,833 | 25,844 | 25,531 | 26,094 | 24,063 |
| R&B Softening Point Temperature (° C.) | 108.2 | 105.1 | 105.3 | 103.3 | 98.5 |
| Peel 180° (lb_{f}) | 0.41 | 0.31 | 0.62 | 0.39 | 0.44 |
| Loop Tack (lb_{f}/in2) | 0.15 | 0.12 | 0.17 | 0.32 | 0.09 |
| Holding Power (min-1000 g) | 0.3 | 0.2 | 10.9 | 11.2 | 3.3 |
| Tensile Stress @ Break (kg_{f}) | 0.34 | 0.23 | 0.25 | 0.33 | 0.32 |
| Strain @ Break (%) | 822 | 778 | 933 | 898 | 735 |
| Tan Delta Maximum Tg (° C.) | −20.8 | −20.8 | −20.8 | −20.8 | −19.2 |
| G′ @ 25° C. (Pa) | 2.60 × 105 | 2.51 × 105 | 2.49 × 105 | 2.47 × 105 | 2.31 × 105 |
| G″ @ 25° C. (Pa) | 1.25 × 105 | 1.24 × 105 | 1.21 × 105 | 1.20 × 105 | 1.14 × 105 |
| Crossover Temperature (° C.) | 66.3 | 66.3 | 66.3 | 66.3 | 66.4 |

### Example 8

Hot Melt Adhesives of Modified Diene Copolymer Compositions (MDC)

Several hot melt adhesive formulations containing modified diene copolymer compositions of the present invention MDC 10-13 were prepared in accordance to the procedure described in Example 7. The modified diene copolymer compositions MDC 10-13, described in Tables 3 and 4 of Example 2, were mixed with the materials and amounts described below.

The hot melt adhesive formulations of modified diene copolymer compositions MDC 10-13 consisted of the following amounts in parts per hundred of rubber (phr): 120.00 phr tackifying resin Piccotac 8095; 20.00 phr Nyflex 223 oil, and 4.00 phr Irganox 1010, based on the total amount (i.e., 100.00 phr) of modified diene copolymer composition in the hot melt adhesive formulation.

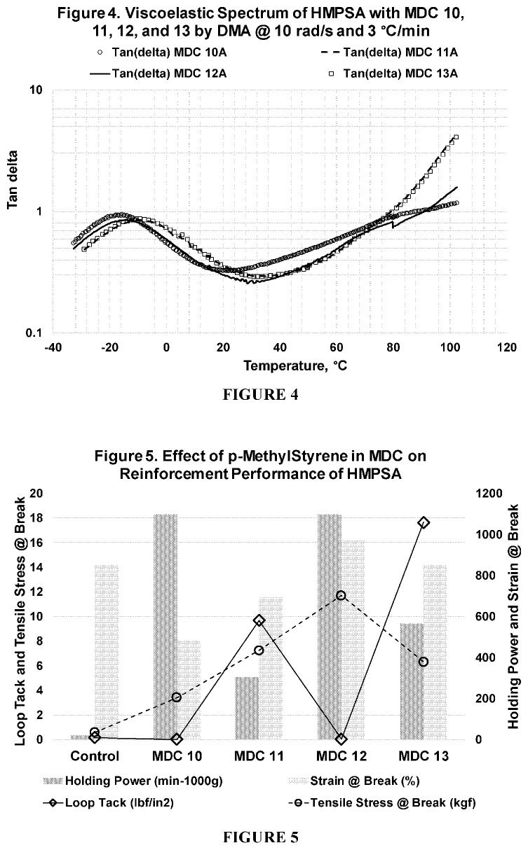

The novel hot melt adhesive compositions MDC 10-13 containing a modified diene copolymer of the present invention were characterized by dynamic mechanical analysis (DMA) according with the testing procedure and methodology described in Example 7, as shown in Table 14 and FIGS. 3 and 4. Dynamic mechanical analysis (DMA) methodology at 10 rad/s and 3° C./min was performed to predict structure-property relationships and ultimately adhesive performance. The first tan delta maximum (tan δ max) temperature, which is a measure of the Tg of the rubbery matrix, increases not only with increasing amount of substituted vinyl aromatic monomer (pMS) in the B-A blocks but more significantly with replacement of unsubstituted vinyl aromatic monomer (S) by substituted vinyl aromatic monomer (pMS) in the C and B-A blocks of the modified C-B-A diene copolymer composition: Control shows Tg of about −27.6° C.; MDC 10-11 increase from Tg of about −20.6° C. for MDC 10 with 5 wt % S in each C and B-A blocks to Tg of about −9.2° C. for MDC 11 with 5 wt % pMS in each C and B-A blocks; and MDC 12-13 increase from Tg of about −14.0° C. for MDC 12 with 10 wt % S in C block to Tg of about −9.2° C. for MDC 13 with 10 wt % pMS in C block. In addition, the tan delta maximum (tan δ max) peak height indicates how much energy the adhesive can dissipate. All the novel hot melt adhesive compositions MDC 10-13 containing a modified diene copolymer composition show similar energy dissipation capability: range from tan δ max peak height of about 0.847 for both MDC 11 with 5 wt % pMS in each C and B-A blocks and MDC 13 with 10 wt % pMS in C block to tan δ max peak height of about 0.850-0.939 for MDC 10 with 5 wt % S in each C and B-A blocks and MDC 12 with 10 wt % S in C block in the modified C-B-A diene copolymer composition, which are slightly lower than tan δ max peak height of about 1.144 for the Control. The storage modulus G′ at room temperature (25° C.) was also noted, to quantify how compliant the adhesive was at the application temperature. The novel hot melt adhesive compositions containing modified diene copolymer composition MDC 11 with 5 wt % pMS in each C and B-A blocks and MDC 13 with 10 wt % pMS in C block show surprisingly high storage modulus G′ at 25° C. from about 610,000 to about 620,000 Pa, which is well above the Dahlquist criterion: G′ at 25° C.≤300,000 Pa for measurable quick tack. The storage modulus G′ at 25° C. increases not only with increasing amount of substituted vinyl aromatic monomer (pMS) in the C block but more significantly with replacement of unsubstituted vinyl aromatic monomer (S) by substituted vinyl aromatic monomer (pMS) in the C and B-A blocks of the modified C-B-A diene copolymer composition: Control shows G′ at 25° C. of about 281,000 Pa; MDC 10-11 increase from G′ at 25° C. of about 264,000 Pa for MDC 10 with 5 wt % S in each C and B-A blocks to G′ at 25° C. of about 610,000 Pa for MDC 11 with 5 wt % pMS in each C and B-A blocks; and MDC 12-13 increase from G′ at 25° C. of about 145,000 Pa for MDC 12 with 10 wt % S in C block to G′ at 25° C. of about 620,000 Pa for MDC 13 with 10 wt % pMS in C block. Similarly, the temperature at which the G′ modulus meets the Dahlquist criterion maximum: G′ at 25° C.≈300,000 Pa for measurable quick tack (i.e., Dahlquist temperature TD) of the novel hot melt adhesive compositions MDC 10-13 of the present invention increases not only with increasing amount of substituted vinyl aromatic monomer (pMS) in the C block but more significantly with replacement of unsubstituted vinyl aromatic monomer (S) by substituted vinyl aromatic monomer (pMS) in the C and B-A blocks of the modified C-B-A diene copolymer composition: Control shows TD of about 24.7° C.; MDC 10-11 increase from TD of about 20.2° C. for MDC 10 with 5 wt % S in each C and B-A blocks to TD of about 48.5° C. for MDC 11 with 5 wt % pMS in each C and B-A blocks; and MDC 12-13 increase from TD of about 7.0° C. for MDC 12 with 10 wt % S in C block to TD of about 48.5° C. for MDC 13 with 10 wt % pMS in C block. Lastly, the third crossover temperature was measured. The third crossover temperature (tan δ=1), is the temperature near the Tg of the glassy polystyrene domains at which the storage and loss moduli are equal (e.g. same magnitude), and therefore, tan delta is equal to 1. The third crossover temperature (tan δ=1) is the temperature where the adhesive begins to flow and loses its cohesive strength, which can be correlated with Ring and Ball softening point temperature (RBSPT) and/or shear adhesion failure temperature (SAFT). The third crossover temperature (T3C) of the novel hot melt adhesive compositions MDC 10-13 containing a modified diene copolymer of the present invention decreases with replacement of unsubstituted vinyl aromatic monomer (S) by substituted vinyl aromatic monomer (pMS) in the C and B-A blocks of the modified C-B-A diene copolymer composition: Control shows T3C of about 72.3° C.; MDC 10-11 decrease from T3C of about 88.9° C. for MDC 10 with 5 wt % S in each C and B-A blocks to T3C of about 79.7° C. for MDC 11 with 5 wt % pMS in each C and B-A blocks; and MDC 12-13 decrease from T3C of about 91.1° C. for MDC 12 with 10 wt % S in the C block to T3C of about 81.3° C. for MDC 13 with 10 wt % pMS in the C block. Surprisingly, the viscoelastic spectra (G′ and Tan delta vs. Temperature) of the novel hot melt adhesive compositions MDC 10-13 predict that, not only with increasing amount of substituted vinyl aromatic monomer (pMS) in the B-A blocks but more significantly with replacement of unsubstituted vinyl aromatic monomer (S) by substituted vinyl aromatic monomer (pMS) in the C and B-A blocks of the modified C-B-A diene copolymer composition, the adhesive performance may show not only an increasingly narrower (i.e., 15-20° C.) temperature performance application window but also an increasingly less compliant adhesive.

The performance of the novel hot melt adhesive compositions MDC 10-13 containing a modified diene copolymer of the present invention was characterized according with the testing procedures described in Example 7, as shown in Table 14 and FIG. 5. Brookfield melt viscosities of the hot melt adhesives MDC 10-13 were determined at 150, 160 and 177° C. Brookfield melt viscosities decrease not only with increasing amount of substituted vinyl aromatic monomer (pMS) in the B-A blocks but more significantly with replacement of unsubstituted vinyl aromatic monomer (S) by substituted vinyl aromatic monomer (pMS) in the C and B-A blocks of the modified C-B-A diene copolymer composition: Control shows Brookfield melt viscosities of about 306,000 cP at 150° C., 115,000 cP at 160° C. and 39,500 cP at 177° C.; MDC 10-11 decrease from Brookfield melt viscosities of about 1,120,000 cP at 150° C., 354,000 cP at 160° C. and 81,000 cP at 177° C. for MDC 10 with 5 wt % S in each C and B-A blocks to Brookfield melt viscosities of about 83,400 cP at 150° C., 56,625 cP at 160° C. and 32,100 cP at 177° C. for MDC 11 with 5 wt % pMS in each C and B-A blocks; and MDC 12-13 slightly decrease at 150 and 160° C. from Brookfield melt viscosities of about 106,000 cP at 150° C., 67,750 cP at 160° C. and 35,583 cP at 177° C. for MDC 12 with 10 wt % S in C block to Brookfield melt viscosities of about 93,750 cP at 150° C., 62,750 cP at 160° C. and 35,708 cP at 177° C. for MDC 13 with 10 wt % pMS in C block. The decreasing effect of Brookfield melt viscosities is very significant at 177° C. (i.e., about 60%) for MDC 11 with 5 wt % pMS in each C and B-A blocks when compared with similar MDC 10 without pMS, and no decrease at 177° C. for MDC 13 with 10 wt % pMS in C block when compared with similar MDC 12 without pMS. The novel hot melt adhesives MDC 11 and MDC 13 showed improved processing during application on the substrate for testing procedures. Surprisingly, the decreasing effect of Brookfield melt viscosities is much more substantial at the lowest measurement temperature (i.e., 150° C.) for both MDC 11 and MDC 13 when compared with similar MDC without pMS, but extremely substantial for MDC 11 at 150° C. (i.e., ten times lower). The reduced Brookfield melt viscosity is not only an important processability performance advantage of the novel hot melt adhesives MDC 11 and MDC 13 over prior art, given that allow for higher production rates and cost efficiencies under the same processing conditions, but also a low energy processability performance advantage, given that allow for lower processing temperatures for the same production rates and cost efficiencies, which is a more environmental-friendly process.

Table 14 and FIG. 5 also show the following characterization of the performance of the novel hot melt adhesive compositions MDC 10-13 containing a modified diene copolymer of the present invention. Ring and Ball softening point temperature (TRBSP) slightly decreases not only with increasing amount of substituted vinyl aromatic monomer (pMS) in the B-A blocks but more significantly with replacement of unsubstituted vinyl aromatic monomer (S) by substituted vinyl aromatic monomer (pMS) in C and B-A blocks of the modified C-B-A diene copolymer composition: Control shows TRBSP of about 113.3° C.; MDC 10-11 decrease from TRBSP of about 125.0° C. for MDC 10 with 5 wt % S in each C and B-A blocks to TRBSP of about 97.1° C. for MDC 11 with 5 wt % pMS in each C and B-A blocks; and MDC 12-13 decrease from TRBSP of about 114.5° C. for MDC 12 with 10 wt % S in C block to TRBSP of about 96.3° C. for MDC 13 with 10 wt % pMS in C block, which show TRBSP decreases from about 15 to about 20% (i.e., 18.2-27.9° C.) that is consistent with the decreasing third crossover temperature (T3C) shown by DMA results. The hot melt adhesive compositions MDC 10-13 180° peel test, which determines the peel energy or peel force (lbf) per unit width in accordance with PSTC-101 method, shows low peel force for most of MDC that is comparable to the hot melt adhesive composition with the Control. The hot melt adhesive compositions MDC 10-13 loop tack test, which determines the maximum force (lbf) per unit width in accordance with PSTC-16 method, shows loop tack force increases not only with increasing amount of substituted vinyl aromatic monomer (pMS) in the C block but more significantly with replacement of unsubstituted vinyl aromatic monomer (S) by substituted vinyl aromatic monomer (pMS) in C and B-A blocks of the modified C-B-A diene copolymer composition: Control shows loop tack force of about 0.17 lbf; MDC 10-11 increase from loop tack force of about 0.02 lbf for MDC 10 with 5 wt % S in each C and B-A blocks to loop tack force of about 9.68 lbf for MDC 11 with 5 wt % pMS in each C and B-A blocks; and MDC 12-13 increase from loop tack force of about 0.03 lbf for MDC 12 with 10 wt % S in C block to loop tack force of about 17.7 lbf for MDC 13 with 10 wt % pMS in C block. The hot melt adhesive compositions containing modified C-B-A diene copolymers of the present invention provide: very high (i.e., about 2-3 times a typical loop tack force for hot melt pressure sensitive adhesive (HMPSA)) loop tack force of about 9.68 lbf for MDC 11 with 5 wt % pMS in each C and B-A blocks; and extremely high (i.e., about 4-5 times a typical loop tack force for HMPSA) loop tack force of about 17.7 lbf for MDC 13 with 10 wt % pMS in C block, which is unique and surprising adhesive performance when compared with the null loop tack force of hot melt adhesive compositions without pMS: MDC 10 with 5 wt % S in each C and B-A blocks and MDC 12 with 10 wt % S in C block, and the low loop tack force of the Control from prior art. The hot melt adhesive compositions MDC 10-13 holding power measurement, which determines the time (min) at which the adhesive failed in accordance with PSTC-107 method and correlates to the room temperature cohesive or shear properties, shows holding power time decreases not only with increasing amount of substituted vinyl aromatic monomer (pMS) in the B-A blocks but more significantly with replacement of unsubstituted vinyl aromatic monomer (S) by substituted vinyl aromatic monomer (pMS) in C and B-A blocks of the modified C-B-A diene copolymer composition: Control shows holding power time of about 20 min; MDC 10-11 decrease from holding power time of about 1,100 min for MDC 10 with 5 wt % S in each C and B-A blocks to holding power time of about 306 min for MDC 11 with 5 wt % pMS in each C and B-A blocks; and MDC 12-13 decrease from holding power time of about 1,100 min for MDC 12 with 10 wt % S in C block to holding power time of about 566 min for MDC 13 with 10 wt % pMS in C block. The hot melt adhesive compositions MDC 10-13 tensile performance, which determines the tensile stress (kgf) at break and the strain (%) at break with universal equipment testing method and correlates to the room temperature cohesive or shear properties, shows stress and strain variation not only with increasing amount of substituted vinyl aromatic monomer (pMS) in the B-A blocks but more significantly with replacement of unsubstituted vinyl aromatic monomer (S) by substituted vinyl aromatic monomer (pMS) in C and B-A blocks of the modified C-B-A diene copolymer composition: Control shows stress and strain of about 0.57 kgf and 850%; MDC 10-11 show variable stress and strain from about 3.42 kgf and 482% for MDC 10 with 5 wt % S in each C and B-A blocks to stress and strain of about 7.24 kgf and 693% for MDC 11 with 5 wt % pMS in each C and B-A blocks; and MDC 12-13 show variable stress and strain from about 11.7 kgf and 970% for MDC 12 with 10 wt % S in C block to stress and strain of about 6.31 kgf and 851% for MDC 13 with 10 wt % pMS in C block.

TABLE 14
Performance of Modified Diene Copolymers in Hot Melt
Pressure Sensitive Adhesive Compositions

| Hot Melt Pressure Sensitive Adhesives | Control | MDC 10 | MDC 11 | MDC 12 | MDC 13 |
|---|---|---|---|---|---|
| Brookfield Viscosity @ 150° C. (cP) | 306,000 | 1,120,000 | 83,400 | 106,000 | 93,750 |
| Brookfield Viscosity @ 160° C. (cP) | 115,000 | 354,000 | 56,625 | 67,750 | 62,750 |
| Brookfield Viscosity @ 177° C. (cP) | 39,500 | 81,000 | 32,100 | 35,583 | 35,708 |
| R&B Softening Point Temperature (° C.) | 113.3 | 125.0 | 97.1 | 114.5 | 96.3 |
| Peel 180° (lb_{f}) | 0.60 | 1.04 | 0.10 | 0.20 | 0.24 |
| Loop Tack (lb_{f}/in²) | 0.17 | 0.02 | 9.68 | 0.03 | 17.7 |
| Holding Power (min-1000 g) | 20 | 1100 | 306 | 1100 | 566 |
| Tensile Stress @ Break (kg_{f}) | 0.57 | 3.42 | 7.24 | 11.7 | 6.31 |
| Strain @ Break (%) | 850 | 482 | 693 | 970 | 851 |
| Tan Delta Maximum Tg (° C.) | −27.6 | −20.6 | −9.2 | −14.0 | −9.2 |
| G’ @ 25° C. (Pa) | 2.81 × 105 | 2.64 × 105 | 6.10 × 105 | 1.45 × 105 | 6.20 × 105 |
| G” @ 25° C. (Pa) | 1.35 × 105 | 8.65 × 104 | 1.96 × 105 | 3.98 × 104 | 1.94 × 105 |
| Crossover Temperature (° C.) | 72.3 | 88.9 | 79.7 | 91.1 | 81.3 |

The performance of the novel hot melt adhesive compositions MDC 10-13 containing a modified diene copolymer of the present invention provides a very significant improvement in processability (i.e., about 60% much lower melt viscosity at 177° C.) with slight decrease in high temperature properties (i.e., 15-20% lower TRBSP), compared with prior art compositions. Surprisingly, the novel hot melt adhesive compositions containing a modified diene copolymer of the present invention such as MDC 11 with 5 wt % pMS in each C and B-A blocks and MDC 13 with 10 wt % pMS in C block provide unique and surprising adhesive performance with very high (i.e., about 2-3 times a typical loop tack force for hot melt pressure sensitive adhesive (HMPSA)) and extremely high (i.e., about 4-5 times a typical loop tack force for hot melt pressure sensitive adhesive (HMPSA)) loop tack forces (i.e., about 9-18 lbf), which also provide reinforcement performance with low peel force, good holding power time, high tensile strength at break, and typical strain at break.

### Example 9

Hot Melt Adhesives of Modified Diene Copolymer Compositions (MDC)

Several hot melt adhesive formulations containing modified diene copolymer compositions of the present invention MDC 16-22 were prepared in accordance to the procedure described in Example 7. The modified diene copolymer compositions MDC 16-22, described in Tables 7 and 8 of Example 4, were mixed with the materials and amounts described below.

The hot melt adhesive formulations of modified diene copolymer compositions MDC 16-22 consisted of the following amounts in parts per hundred of rubber (phr): 178.00 phr tackifying resin Foral 85; 50.00 phr Nyflex 223 oil, and 4.00 phr Irganox 1010, based on the total amount (i.e., 100.00 phr) of modified diene copolymer composition in the hot melt adhesive formulation.

The performance of the novel hot melt adhesive compositions MDC 16-22 containing a modified diene copolymer of the present invention was characterized according with the testing procedures described in Example 7, as shown in Table 15. Brookfield melt viscosities of the hot melt adhesives MDC 16-22 were determined at 150, 160 and 177° C. Brookfield melt viscosities are similar with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-19 range from Brookfield melt viscosities of about 6,750 and 6,692 cP at 150° C., of about 4,670 and 4,550 cP at 160° C. and of about 2,741 and 2,662 cP at 177° C. for MDC 16 and MDC 18 both with 10 wt % S in terminal C block to Brookfield melt viscosities of about 7,867 and 6,786 cP at 150° C., of about 5,262 and 4,450 cP at 160° C. and of about 3,132 and 2,819 cP at 177° C. for MDC 17 and MDC 19 both with 10 wt % pMS in terminal C block; and MDC 20-22 range from Brookfield melt viscosities of about 25,250 cP at 150° C., of about 14,900 cP at 160° C. and of about 8,008 cP at 177° C. for MDC 20 with 10 wt % S in terminal C block to Brookfield melt viscosities of about 22,900 and 21,575 cP at 150° C., of about 15,333 and 14,265 cP at 160° C. and of about 9,090 and 8,275 cP at 177° C. for MDC 21 and MDC 22 both with 10 wt % pMS in terminal C block.

Table 15 also show the following characterization of the performance of the novel hot melt adhesive compositions MDC 16-22 containing a modified diene copolymer of the present invention. Ring and Ball softening point temperature (TRBSP) slightly decreases with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-19 decrease from TRBSP of about 88.9 and 89.6° C. for MDC 16 and MDC 18 both with 10 wt % S in terminal C block to TRBSP of about 73.5 and 73.8° C. for MDC 17 and MDC 19 both with 10 wt % pMS in terminal C block; and MDC 20-22 decrease from TRBSP of about 104.2° C. for MDC 20 both with 10 wt % S in terminal C block to TRBSP of about 85.6 and 86.5° C. for MDC 21 and MDC 22 both with 10 wt % pMS in terminal C block, which show TRBSP decreases from about 15 to about 20% (i.e., 15-20° C.). The hot melt adhesive compositions MDC 16-22 180° peel test, which determines the peel energy or peel force (lbf) per unit width in accordance with PSTC-101 method, shows peel force slightly decreases with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-19 decrease from peel force of about 7.0 and 11.1 lbf for MDC 16 and MDC 18 both with 10 wt % S in terminal C block to peel force of about 5.9 and 5.6 lbf for MDC 17 and MDC 19 both with 10 wt % pMS in terminal C block; and MDC 20-22 decrease from peel force of about 6.4 lbf for MDC 20 with 10 wt % S in terminal C block to peel force of about 5.3 and 5.0 lbf for MDC 21 and MDC 22 both with 10 wt % pMS in terminal C block. The hot melt adhesive compositions MDC 16-22 loop tack test, which determines the maximum force (lbf) per unit width in accordance with PSTC-16 method, shows loop tack force variation with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-22 show variable from loop tack force of about 6.8 and 10.9 lbf for MDC 16 and MDC 18 both with 10 wt % S in terminal C blocks to loop tack force of about 8.5 and 6.9 lbf for MDC 17 and MDC 19 both with 10 wt % pMS in terminal C block; and MDC 20-22 show variable from loop tack force of about 7.1 lbf for MDC 20 with 10 wt % S in terminal C block to loop tack force of about 6.1 and 5.4 lbf for MDC 21 and MDC 22 both with 10 wt % pMS in terminal C block. The hot melt adhesive compositions MDC 16-22 holding power measurement, which determines the time (min) at which the adhesive failed in accordance with PSTC-107 method and correlates to the room temperature cohesive or shear properties, shows holding power time variation with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-22 show variable from holding power time of about 1,077 and 393 min for MDC 16 and MDC 18 both with 10 wt % S in terminal C block to holding power time of about 762 and 1,263 min for MDC 17 and MDC 19 both with 10 wt % pMS in terminal C block; and MDC 20-22 show variable from holding power time of about 1,114 min for MDC 20 with 10 wt % S in terminal C block to holding power time of about 218 and 336 min for MDC 21 and MDC 22 both with 10 wt % pMS in terminal C block. The hot melt adhesive compositions MDC 16-22 rolling ball tack experiment, which determines the distance (in) the ball travels in accordance with PSTC-6 method, and correlates the less the ball rolls down the tackier the adhesive and the better quick tack performance, shows rolling ball tack distance variation with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-22 show variable from rolling ball tack distance of about 1.9 and 9.0 in for MDC 16 and MDC 18 both with 10 wt % S in terminal C block to rolling ball tack distance of about 2.4 and 4.6 in for MDC 17 and MDC 19 both with 10 wt % pMS in terminal C block; and MDC 20-22 show variable from rolling ball tack distance of about 2.2 in for MDC 20 with 10 wt % S in terminal C block to rolling ball tack distance of about 2.6 and 1.5 in for MDC 21 and MDC 22 both with 10 wt % pMS in terminal C block. The hot melt adhesive compositions MDC 16-22 tensile performance, which determines the tensile stress (kgf) at break and the strain (%) at break with universal equipment testing method and correlates to the room temperature cohesive or shear properties, shows stress and strain variation with replacement of unsubstituted vinyl aromatic monomer (S) by substituted vinyl aromatic monomer (pMS) in the terminal C block at two peak molecular weights Mp of the modified A-B-C and (A-B)nX diene copolymer composition: MDC 16-22 show variable from stress and strain of about 5.33 and 7.41 kgf and 1,629 and 1,365% for MDC 16 and MDC 18 both with 10 wt % S in terminal C block to stress and strain of about 5.44 and 5.94 kgf and 1,265 ad 1,299% for MDC 17 and MDC 19 both with 10 wt % pMS in terminal C block; and MDC 20-22 show variable from stress and strain of about 7.18 kgf and 1,813% for MDC 20 with 10 wt % S in terminal C block to stress and strain of about 9.70 and 10.7 kgf and 1,424 ad 1,437% for MDC 21 and MDC 22 both with 10 wt % pMS in terminal C block.

TABLE 15
Performance of Modified Diene Copolymers in Hot Melt Pressure Sensitive Adhesive Compositions

| | MDC | MDC | MDC | MDC | MDC | MDC | MDC |
|---|---|---|---|---|---|---|---|
| Hot Melt Pressure Sensitive Adhesives | 16 | 17 | 18 | 19 | 20 | 21 | 22 |
| Brookfield Viscosity @ 150° C. (cP) | 6,750 | 7,867 | 6,692 | 6,786 | 25,250 | 22,900 | 21,575 |
| Brookfield Viscosity @ 160° C. (cP) | 4,670 | 5,262 | 4,550 | 4,450 | 14,900 | 15,333 | 14,265 |
| Brookfield Viscosity @ 177° C. (cP) | 2,741 | 3,132 | 2,662 | 2,819 | 8,008 | 9,090 | 8,275 |
| R&B Softening Point Temperature (° C.) | 88.9 | 73.5 | 89.6 | 73.8 | 104.2 | 85.6 | 86.5 |
| Peel 180° (lb_{f}) | 7.0 | 5.9 | 11.1 | 5.6 | 6.4 | 5.3 | 5.0 |
| Loop Tack (lb_{f}/in2) | 6.8 | 8.5 | 10.9 | 6.9 | 7.1 | 6.1 | 5.4 |
| Holding Power (min-1000 g) | 1,077 | 762 | 393 | 1,263 | 1,114 | 218 | 336 |
| Rolling Ball Tack (in) | 1.9 | 2.4 | 9.0 | 4.6 | 2.2 | 2.6 | 1.5 |
| Tensile Stress @ Break (kg_{f}) | 5.33 | 5.44 | 7.41 | 5.94 | 7.18 | 9.70 | 10.70 |
| Strain @ Break (%) | 1,629 | 1,265 | 1,365 | 1,299 | 1,813 | 1,424 | 1,437 |

The performance of the novel hot melt adhesive compositions MDC 16-22 containing a modified diene copolymer of the present invention provides similar processability with slight decrease in high temperature properties (i.e., 15-20% lower TRBSP), compared with prior art compositions. Surprisingly, the novel hot melt adhesive compositions MDC 16-22 containing a modified diene copolymer of the present invention provide excellent adhesive performance with an exceptional balance between adhesive and cohesive properties: high peel force; high loop tack force; good to excellent holding power time, excellent rolling ball tack; high to excellent tensile strength at break and strain at break.

### Example 9a

Reactive Hot Melt Adhesives of Modified Diene Copolymer Compositions (Hypothetical)

A novel reactive hot melt adhesive formulation containing the modified diene copolymer composition of the present invention MDC 3 would be prepared in accordance with the procedure described in Example 7. The modified diene copolymer composition MDC 3, described in Tables 1 and 2 of Example 1, would be mixed with the materials and amounts described below.

The novel reactive hot melt adhesive formulation of modified diene copolymer composition MDC 3 would consist of the following amounts in parts per hundred of rubber (phr): 178.00 phr tackifying resin Piccotac 8095; 50.00 phr Nyflex 223 oil, 4.00 phr Irganox 1010, and 4.00 phr Irgacure 819 as photoinitiator, based on the total amount (i.e., 100.00 phr) of modified diene copolymer composition in the hot melt adhesive formulation. The reactive hot melt adhesive formulation would be cured by exposure to 7.5 Mrad of electronic beam (EB) radiation.

The performance of the novel reactive hot melt adhesive composition MDC 3R HMA containing the modified diene copolymer MDC 3 of the present invention would be characterized according with the testing procedures described in Example 7. Brookfield melt viscosities of the reactive hot melt adhesive MDC 3R HMA would be determined at 150, 160 and 177° C. Brookfield melt viscosities would decrease with replacement of unsubstituted vinyl aromatic monomer (S) by substituted vinyl aromatic monomer (pMS) in the modified diene copolymer composition: Control without pMS would show Brookfield melt viscosities of about 19,500 cP at 150° C., 5,600 cP at 160° C. and 3,200 cP at 177° C.; and would decrease to Brookfield melt viscosities of about 6,500 cP at 150° C., 2,800 cP at 160° C. and 1,650 cP at 177° C. for MDC 3 with 5 wt % pMS. The novel reactive hot melt adhesive MDC 3R HMA would show improved processing during application on the substrate for testing procedures. Surprisingly, the decreasing effect of Brookfield melt viscosities would be much more substantial at the lowest measurement temperature (150° C.) when compared with Control without pMS. The reduced Brookfield melt viscosity would not only be an important processability performance advantage of the novel reactive hot melt adhesive MDC 3R HMA over prior art, given that would allow for higher production rates and cost efficiencies under the same processing conditions, but also would be a low energy processability performance advantage, given that would allow for lower processing temperatures for the same production rates and cost efficiencies, which would be a more environmental-friendly process.

The performance of the novel reactive hot melt adhesive composition MDC 3R HMA containing the modified diene copolymer MDC 3 of the present invention, after the curing process, would show that Ring and Ball softening point temperature (TRBSP) would significantly increase with replacement of unsubstituted vinyl aromatic monomer (S) by substituted vinyl aromatic monomer (pMS) in the modified diene copolymer composition: Control without pMS would show TRBSP of about 95° C.; and MDC 3 with 5 wt % pMS would significantly increase to TRBSP of about 155 NC. The reactive hot melt adhesive composition MDC 3R HMA holding power measurement at 100° C., which determines the time (min) at which the adhesive failed in accordance with PSTC-107 method and correlates to the room temperature cohesive or shear properties, would show a holding power time of about 27 hours for MDC 3R HMA that would be significantly longer than the holding power at 100° C. for the reactive hot melt adhesive composition with the Control without pMS (i.e., 12 hours). The hot melt adhesive compositions MDC 1-9 180° peel test, which determines the peel energy or peel force (lbf) per unit width in accordance with PSTC-101 method, would show a peel force of about 4.5 lbf for MDC 3R HMA that is comparable to the hot melt adhesive composition with the Control without pMS. The hot melt adhesive compositions MDC 3R HMA loop tack test, which determines the maximum force (lbf) per unit width in accordance with PSTC-16 method, would show a loop tack force of about 5.0 lbf for MDC 3R HMA that is comparable to the hot melt adhesive composition with the Control without pMS.

The performance of the novel reactive hot melt adhesive compositions MDC 3R HMA containing the modified diene copolymer MDC 3 of the present invention would provide a very significant improvement in processability (i.e., about 50-65% lower melt viscosity) that would be much more substantial at lower temperature (i.e., 150° C.). After the curing process, the novel reactive hot melt adhesive compositions MDC 3R HMA would show a very significant increase in high temperature properties (i.e., about 60% higher TRBSP) and holding power at 100° C. (i.e., about 120% longer time), compared with prior art composition without pMS.

### Example 10

Applications in Polymer Modified Asphalt for Paving and Roofing Test Procedures for Polymer Modified Asphalt Performance

Polymer modified asphalt performance can be evaluated by following the standards of the American Association of State Highway and Transportation Officials (AASHTO), which rate asphalts in accordance to performance grade (PG). The standards of the American Society for Testing and Materials (ASTM) are also used for asphalt evaluation. Among the properties evaluated in polymer modified asphalts are the following: a) Ring and ball softening point temperature (TRBSP) measured in accordance with ASTM D 36, which indicates the temperature at which asphalt softens and becomes unsuitable for the subject application. The softening point temperature may be measured by using a Ring and Ball apparatus, also known as R&B apparatus; b) Penetration at 25° C. measured in accordance with ASTM D5, which is the distance a weighted needle or cone will sink into the asphalt during a specified time and is a parameter related to the rigidity of the modified asphalt; c) Dynamic viscosity measured in accordance with ASTM D4402, which is a property relating to the stable stationary flow of asphalt. Dynamic viscosity may be measured by using a Brookfield viscometer; d) Resilience measured in accordance with ASTM D 113, which is a property that measures the elasticity of an asphalt material; e) Rutting factor measured in accordance with AASHTO TP5, which is defined as G*/sin δ at various temperatures, wherein G* is the complex modulus and δ is the phase angle. The rutting factor is useful for determining the performance of modified asphalt at high temperature, which indicates how resistant a pavement is to the permanent deformation that can occur over time: with repeated loads at high temperature or when the pavement is subjected to a load much greater than the maximum allowed in the original design. Therefore, higher rutting factor at high temperature indicates that the asphalt materials can withstand greater deformation; f) Upper temperature limit measured in accordance with AASHTO standards, which is related to the maximum temperature at which the asphalt may retain adequate rigidity to resist rutting. The upper temperature limit is determined by measuring the rutting factor at different temperatures; g) Lower temperature limit measured in accordance with AASHTO standards, which is related to the minimum temperature at which the asphalt may retain adequate flexibility to resist thermal cracking. The lower temperature limit is determined by measuring the rutting factor at different temperatures; h) Phase segregation measured as phase separation index, which is the difference between the R&B softening point temperatures TRBSP measured at the top and bottom surfaces of a cylindrical probe containing the formulated asphalt aged at 163° C. for 48 hours in a vertical position without agitation and frozen at 30° C. before measurement, which is a critical factor in the modification of asphalt with elastomers that provides a measure of the compatibility between the asphalt-rich phase and the polymer-rich phase in a polymer modified asphalt blend or mixture.

### Polymer Modified Asphalt of Modified Diene Copolymer Compositions (MDC)

Several polymer modified asphalt formulations containing modified diene copolymer compositions of the present invention MDC 1-9 were prepared in accordance to the following procedure. The modified diene copolymer compositions MDC 1-9, described in Tables 1 and 2 of Example 1, were mixed with the materials and amounts described below. Each modified diene copolymer composition MDC was evaluated as asphalt modifier or asphalt reinforcing agent in polymer modified asphalt (PMA) for road paving formulations at 3 wt % polymer content and for roofing formulations at 8 and 11 wt % polymer content based on total amount of formulation. PG 70-22 neat asphalt (EKBE) and PG 64-22 neat asphalt (EXBE) were modified by a hot mix and high shear rate process with a trigonal high shear mill. First, neat asphalt was heated and temperature was increased to about 120° C. to soften the asphalt under a nitrogen atmosphere, without agitation or with very slow agitation to prevent asphalt from overheating and oxidation. Once the asphalt was softened, heating continued and temperature was increased to 190° C.+/−5° C. and the mixer agitation speed was increased to about 3,000 rpm. As 190° C. was reached, the modified diene copolymer composition MDC was gradually dosed to the asphalt at a rate of about 10 g/min. Once the MDC was added into the asphalt, the mixing was continued from about 180 to about 240 minutes for an effective and total dispersion of the MDC as reinforcing agent. For road paving formulations, a conventional crosslinking agent (i.e., sulfur) was added to promote asphalt-polymer phase stability in an amount of about 2.0 wt % based on polymer, and then the mixing was continued for about 60 min under the same temperature and agitation speed conditions. To ensure that the same level of dispersion was achieved in all formulations, the MDC dispersion in asphalt was monitored through fluorescence microscopy using a Zeiss microscope Axiotecy 20X model.

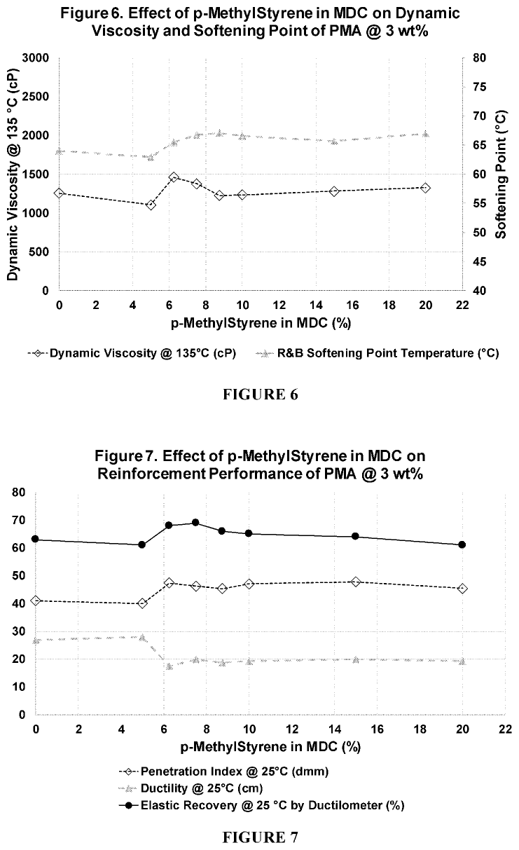

The performance of the novel polymer modified asphalt compositions MDC 1-9 containing a modified diene copolymer of the present invention is shown in Tables 16, 17 and 18, and FIGS. 6, 7 and 9. The polymer modified asphalt (PMA) compositions MDC 1-9 were characterized by the testing procedures described in Example 10, and the following specific conditions and equipments: Dynamic viscosities at 115, 125 and 135° C. for 3 wt % formulations and 160 and 190° C. for 8 and 11 wt % formulations were measured in accordance to ASTM D4402 by using a Brookfield viscometer model RDVS-II+; Ring and Ball Softening Point Temperature (TRBSP) was measured according to ASTM D36; Penetration was measured according to ASTM D5 at 25° C., 10 seconds and 100 grams by using a Koheler Penetrometer model K95500; Elastic recovery at 25° C. in torsion mode was measured in accordance to AASHTO-TF31R. Elastic recovery at 25° C. and Ductility at 25° C. were measured by using a Ductilometer; Phase segregation was measure by TRBSP difference after aging; and Maximum application temperature (Maximum Use Temperature) was measured according to AASHTO TP5 as the temperature at which the Rutting Factor or Dynamic Shear Stiffness (G*/sin δ) takes the value of 1.0 kPa, wherein G* is the complex modulus and sin δ is the phase angle by using a Paar Physica rheometer model MCR-300-SP, and AASHTO SUPERPAVE performance grade PG was determined based on these rheological measurements. Low temperature stiffness (i.e., cracking resistance) was measured by using a bending beam rheometer. Cold bending temperature was measured by using a BDA bending tester.

Table 16 and FIGS. 6 and 7 show the characterization of the novel polymer modified asphalt (PMA) compositions MDC 1-9 prepared by using a formulation for road paving applications at 3.0 wt % of modified diene copolymer based on total amount of the formulation and at 2.0 wt % of crosslinking agent based on total polymer amount in the formulation. The polymer modified asphalt compositions MDC 3-9 and the Control were formulated with PG 70-22 asphalt (EKBE) and MDC 1-2 were formulated with PG 64-22 asphalt (EKBE). Dynamic viscosities of the polymer modified asphalt compositions MDC 1-9 were determined at 115, 125 and 125° C. Dynamic viscosities of the polymer modified asphalt compositions MDC 3-9 are similar with increasing replacement of unsubstituted vinyl aromatic monomer (S) by substituted vinyl aromatic monomer (pMS) in the modified diene copolymer composition: Control without pMS shows dynamic viscosities of about 4,740 cP at 115° C., 2,380 cP at 125° C. and 1,257 cP at 135° C.; and MDC 3-9 range from dynamic viscosities of about 3,880 cP at 115° C., 2,060 cP at 125° C. and 1,106 cP at 135° C. to dynamic viscosities of about 5,556 cP at 115° C., 2,725 cP at 125° C. and 1,462 cP at 135° C. Dynamic viscosities of the polymer modified asphalt compositions MDC 1-2 are lower with PG 64-22 asphalt: range from dynamic viscosities of about 2,560 cP at 115° C., 1,414 cP at 125° C. and 833 cP at 135° C. to dynamic viscosities of about 2,741 cP at 115° C., 1,500 cP at 125° C. and 879 cP at 135° C. Surprisingly, the dynamic viscosities of MDC 3-9 range: from about 3,880 to about 5,556 cP at 115° C.; from about 2,060 to about 2,725 cP at 125° C.; and from about 1,106 to about 1,462 cP at 135° C., and the dynamic viscosities of MDC 1-2 range: from about 2,560 to about 2,741 cP at 115° C.; from about 1,414 to about 1,500 cP at 125° C.; and from about 833 to about 879 cP at 135° C., most of which are well below the maximum dynamic viscosity of about 3,000 cP at 135° C. desirable for road paving applications. The low dynamic viscosities of the novel polymer modified asphalt (PMA) compositions MDC 1-9 make them suitable for facilitating the preparation and increasing the processability of polymer modified asphalt emulsion compositions (PMAE or PME) for road paving rehabilitation and maintenance such as chip seals applications. The reduced dynamic viscosities are not only an important processability performance advantage of the novel polymer modified asphalt (PMA) compositions MDC 1-9, given that allow for higher production rates and cost efficiencies under the same processing conditions, but also low energy processability performance advantage, given that allow for lower processing temperatures for the same production rates and cost efficiencies, which is a more environmental-friendly process.

Table 16 and FIGS. 6 and 7 also show the following characterization of the performance of the novel polymer modified asphalt (PMA) compositions MDC 1-9 containing a modified diene copolymer of the present invention. The Ring and Ball softening point temperature (TRBSP) slightly increases with increasing replacement of unsubstituted vinyl aromatic monomer (S) by substituted vinyl aromatic monomer (pMS) in the modified diene copolymer composition: Control without pMS shows TRBSP of about 64° C.; and MDC 3-9 increase from TRBSP of about 63° C. for MDC 3 with 5 wt % pMS to TRBSP of about 67° C. for MDC 9 with 20 wt % pMS, which show TRBSP increase of about 5% (i.e., 3-4° C.) for MDC 3-9. Ring and Ball softening point temperature (TRBSP) of the polymer modified asphalt compositions MDC 1-2 is lower with PG 64-22 asphalt: increase from TRBSP of about 59° C. for MDC 1 with 1 wt % pMS to TRBSP of about 60° C. for MDC 2 with 2.5 wt % pMS. The penetration index also slightly increases with increasing replacement of unsubstituted vinyl aromatic monomer (S) by substituted vinyl aromatic monomer (pMS) in the modified diene copolymer composition: Control without pMS shows penetration index of about 41 dmm; and MDC 3-9 increase from penetration index of about 40 dmm for MDC 3 with 5 wt % pMS to penetration index of about 45 dmm for MDC 9 with 20 wt % pMS, which show penetration index increase from about 10 to about 20% (i.e., 4-8 dmm) for MDC 3-9. The penetration index of the polymer modified asphalt compositions MDC 1-2 is lower with PG 64-22 asphalt: same penetration index of about 45 dmm for both MDC 1 with 1 wt % pMS and MDC 2 with 2.5 wt % pMS. The ductility at 25° C. decreases with increasing replacement of unsubstituted vinyl aromatic monomer (S) by substituted vinyl aromatic monomer (pMS) in the modified diene copolymer composition: Control without pMS shows ductility at 25° C. of about 27 cm; and MDC 3-9 increase from ductility at 25° C. of about 28 cm for MDC 3 with 5 wt % pMS to ductility at 25° C. of about 19 cm for MDC 9 with 20 wt % pMS, which show ductility at 25° C. decrease of about 30% (i.e., 9 cm) for MDC 3-9. The ductility at 25° C. of the polymer modified asphalt compositions MDC 1-2 is higher with PG 64-22 asphalt: increase from ductility at 25° C. of about 62 cm for MDC 1 with 1 wt % pMS to ductility at 25° C. of about 66 cm for MDC 2 with 2.5 wt % pMS. The elastic recovery at 25° C. by torsion is variable with increasing replacement of unsubstituted vinyl aromatic monomer (S) by substituted vinyl aromatic monomer (pMS) in the modified diene copolymer composition: Control without pMS shows elastic recovery at 25° C. by torsion of about 31%; and MDC 3-9 range from elastic recovery at 25° C. by torsion of about 24% to elastic recovery at 25° C. by torsion of about 30%, which show elastic recovery at 25° C. by torsion variation up to about 20% (i.e., 6-7% elastic recovery at 25° C.) for MDC 3-9. The elastic recovery at 25° C. by torsion of the polymer modified asphalt compositions MDC 1-2 with PG 64-22 asphalt: ranges from elastic recovery at 25° C. by torsion of about 28% to elastic recovery at 25° C. by torsion of about 36%. The elastic recovery at 25° C. by ductilometer is variable with increasing replacement of unsubstituted vinyl aromatic monomer (S) by substituted vinyl aromatic monomer (pMS) in the modified diene copolymer composition: Control without pMS shows elastic recovery at 25° C. by ductilometer of about 63%; and MDC 3-9 range from elastic recovery at 25° C. by ductilometer of about 61% to elastic recovery at 25° C. by ductilometer of about 69%, which show elastic recovery at 25° C. by ductilometer variation up to about 15% (i.e., 7-8% elastic recovery at 25° C.) for MDC 3-9. The elastic recovery at 25° C. by ductilometer of the polymer modified asphalt compositions MDC 1-2 with PG 64-22 asphalt: shows same elastic recovery at 25° C. by ductilometer of about 75% for both MDC 1 and MDC 2. The phase segregation is variable with increasing replacement of unsubstituted vinyl aromatic monomer (S) by substituted vinyl aromatic monomer (pMS) in the modified diene copolymer composition: Control without pMS shows phase segregation of about 2.3%; and MDC 3-9 range from phase segregation of about 0.1% to phase segregation of about 5.1%, which show phase segregation range up to about 5.0% phase segregation for MDC 3-9. The phase segregation of the polymer modified asphalt compositions MDC 1-2 with PG 64-22 asphalt: ranges from phase segregation of about 0.3% to phase segregation of about 1.6%. The maximum use temperature (TG*/sin δ=1.0 kPa) increases with increasing replacement of unsubstituted vinyl aromatic monomer (S) by substituted vinyl aromatic monomer (pMS) in the modified diene copolymer composition: Control without pMS shows TG*/sin δ=1.0 kPa of about 80.6° C.; and MDC 3-9 increase from TG*/sin δ=1.0 kPa of about 79.7° C. for MDC 3 with 5 wt % pMS to TG*/sin δ=1.0 kPa of about 83.4° C. for MDC 9 with 20 wt % pMS, which show TG*/sin δ=1.0 kPa increase of about 5% (i.e., 4-5° C.) for MDC 3-9. The maximum use temperature (TG*/sin δ=1.0 kPa) of the polymer modified asphalt compositions MDC 1-2 is lower with PG 64-22 asphalt: shows similar from TG*/sin δ=1.0 kPa of about 75.5° C. for MDC 1 with 1 wt % pMS to TG*/sin δ=1.0 kPa of about 75.3° C. for MDC 2 with 2.5 wt % pMS. The AASHTO SUPERPAVE performance grade (PG PMA) increases with increasing replacement of unsubstituted vinyl aromatic monomer (S) by substituted vinyl aromatic monomer (pMS) in the modified diene copolymer composition: Control without pMS shows PG PMA of about 76-16; and MDC 3-9 increase from PG PMA of about 76-16 for MDC 3 with 5 wt % pMS to PG PMA of about 82-16 for MDC 9 with 20 wt % pMS, which show a PG PMA increase of about 1 PG level (i.e., 6° C.) for MDC 3-9. More significantly, the AASHTO SUPERPAVE performance grade (PG PMA) of the polymer modified asphalt compositions for most MDC 3-9 increases 2 PG levels relative to PG Asphalt (i.e., from 70 to 82), when compared to a Control increase of about 1 PG level relative to PG Asphalt (i.e., from 70 to 76). The AASHTO SUPERPAVE performance grade (PG PMA) of the polymer modified asphalt compositions MDC 1-2 is lower with PG 64-22 asphalt: shows same PG PMA of about 70-22 for both MDC 1 and MDC 2. FIGS. 6 and 7 show that performance of the novel polymer modified asphalt (PMA) compositions MDC 3-9 containing a modified diene copolymer of the present invention has a distinct and optimum range from about 5 to about 10 wt % for the replacement of unsubstituted vinyl aromatic monomer (S) by substituted vinyl aromatic monomer (pMS) in the modified diene copolymer compositions. The distinct and optimum range of pMS in MDC 3-9 shows an increasing effect on: dynamic viscosity that presents a maximum peak of about 1,462 cP at 135° C. for MDC 4 with 6.25 wt % pMS; Ring and Ball softening point temperature (TRBSP) that presents a maximum peak of about 67° C. for MDC 5 with 7.5 wt % pMS; penetration index that presents a maximum peak of about 47 dmm for MDC 4 with 6.25 wt % pMS; ductility at 25° C. that presents a minimum peak of about 18 cm for MDC 4 with 6.25 wt % pMS; and elastic recovery at 25° C. by ductilometer that presents a maximum peak of about 69% for MDC 5 with 7.5 wt % pMS.

TABLE 16
Performance of Modified Diene Copolymers in Polymer Modified Asphalt Compositions

| | | MDC | MDC | MDC | MDC | MDC | MDC | MDC | MDC | MDC |
|---|---|---|---|---|---|---|---|---|---|---|
| Polymer Modified Asphalt (PMA) @ 3 wt % | Control | 1 | 2 | 3 | 4 | 5 | 6 | 7 | 8 | 9 |
| Dynamic Viscosity @ 115° C. (cP) | 4,740 | 2,741 | 2,560 | 3,880 | 5,556 | 4,695 | 4,491 | 4,270 | 4,525 | 4,521 |
| Dynamic Viscosity @ 125° C. (cP) | 2,380 | 1,500 | 1,414 | 2,060 | 2,725 | 2,461 | 2,320 | 2,215 | 2,290 | 2,375 |
| Dynamic Viscosity @ 135° C. (cP) | 1,257 | 879 | 833 | 1,106 | 1,462 | 1,378 | 1,228 | 1,235 | 1,284 | 1,326 |
| R&B Softening Point Temperature (° C.) | 64 | 59 | 60 | 63 | 66 | 67 | 67 | 67 | 66 | 67 |
| Penetration Index @ 25° C. (dmm) | 41 | 45 | 45 | 40 | 47 | 46 | 45 | 47 | 48 | 45 |
| Ductility @ 25° C. (cm) | 27 | 62 | 66 | 28 | 18 | 20 | 19 | 19 | 20 | 19 |
| Elastic Recovery @ 25° C. by Torsion (%) | 31 | 36 | 28 | 30 | 25 | 29 | 30 | 24 | 28 | 27 |
| Elastic Recovery @ 25° C. by Ductilometer (%) | 63 | 75 | 75 | 61 | 68 | 69 | 66 | 65 | 64 | 61 |
| Phase Segregation (%) | 2.3 | 0.3 | 1.6 | 0.1 | 1.4 | 0.8 | 5.1 | 3.7 | 2.5 | 1.2 |
| Maximum Use Temperature, ° C. | 80.6 | 75.5 | 75.3 | 79.7 | 84.1 | 84.7 | 83.8 | 82.4 | 81.7 | 83.4 |
| AASHTO SUPERPAVE - PG Asphalt | 70 | 64 | 64 | 70 | 70 | 70 | 70 | 70 | 70 | 70 |
| AASHTO SUPERPAVE - PG PMA | 76-16 | 70-22 | 70-22 | 76-16 | 82-16 | 82-16 | 82-16 | 82-16 | 76-16 | 82-16 |

The performance of the novel polymer modified asphalt (PMA) compositions MDC 1-9 containing a modified diene copolymer of the present invention formulated for road paving applications provides similar processability with slight increase in high temperature properties (i.e., 5% higher TRBSP), compared with prior art compositions. Surprisingly, the novel polymer modified asphalt compositions MDC 1-9 containing a modified diene copolymer of the present invention provide excellent PMA performance with an exceptional increase from asphalt performance to PMA PG 82-16, and a distinct and optimum range from about 5 to about 10 wt % of pMS, wherein desirable performance maximum and minimum peaks show from about 6 to about 8 wt % of pMS for dynamic viscosities, Ring and Ball softening point temperature, penetration index, ductility at 25° C. and elastic recovery at 25° C. by ductilometer.

Table 17 shows the characterization of the novel polymer modified asphalt (PMA) compositions MDC 1-9 prepared by using a formulation for roofing applications at 8.0 wt % of modified diene copolymer based on total amount of the formulation. The polymer modified asphalt compositions MDC 3-9 and the Control were formulated with PG 70-22 asphalt (EKBE) and MDC 1-2 were formulated with PG 64-22 asphalt (EKBE). Dynamic viscosities of the polymer modified asphalt compositions MDC 1-9 were determined at 160 and 190° C. Dynamic viscosities of the polymer modified asphalt compositions MDC 3-9 are similar with increasing replacement of unsubstituted vinyl aromatic monomer (S) by substituted vinyl aromatic monomer (pMS) in the modified diene copolymer composition: Control without pMS shows dynamic viscosities of about 1,215 cP at 160° C. and 441 cP at 190° C.; and MDC 3-9 range from dynamic viscosities of about 1,314 cP at 160° C. and 436 cP at 190° C. to dynamic viscosities of about 1,393 cP at 160° C. and 481 cP at 190° C. Dynamic viscosities of the polymer modified asphalt compositions MDC 1-2 are lower with PG 64-22 asphalt: range from dynamic viscosities of about 849 cP at 160° C. and 318 cP at 190° C. to dynamic viscosities of about 955 cP at 160° C. and 368 cP at 190° C. Surprisingly, the dynamic viscosities of MDC 3-9 range: from about 1,314 to about 1,393 cP at 160° C.; and from about 436 to about 481 cP at 190° C., and the dynamic viscosities of MDC 1-2 range: from about 849 to about 955 cP at 160° C.; and from about 318 to about 368 cP at 190° C., most of which are well below the typical dynamic viscosities of about 8,000 cP at 160° C. and 6,000 cP at 190° C. desirable for roofing applications. The very low dynamic viscosities of the novel polymer modified asphalt (PMA) compositions MDC 1-9 make them suitable for facilitating the preparation and increasing the processability of polymer modified asphalt compositions with higher polymer concentration, and masterbatch or concentrate applications. The reduced dynamic viscosities are not only an important processability performance advantage of the novel polymer modified asphalt (PMA) compositions MDC 1-9, given that allow for higher production rates and cost efficiencies under the same processing conditions, but also low energy processability performance advantage, given that allow for lower processing temperatures for the same production rates and cost efficiencies, which is a more environmental-friendly process.

Table 17 also shows the following characterization of the performance of the novel polymer modified asphalt (PMA) compositions MDC 1-9 containing a modified diene copolymer of the present invention. The Ring and Ball softening point temperature (TRBSP) is similar with increasing replacement of unsubstituted vinyl aromatic monomer (S) by substituted vinyl aromatic monomer (pMS) in the modified diene copolymer composition: Control without pMS shows TRBSP of about 74° C.; and MDC 3-9 range from TRBSP of about 73° C. to TRBSP of about 77° C., which show TRBSP increase of about 5% (i.e., 4° C.) for MDC 3-9. Ring and Ball softening point temperature (TRBSP) of the polymer modified asphalt compositions MDC 1-2 is lower with PG 64-22 asphalt: ranges from TRBSP of about 69.1° C. to TRBSP of about 71.2° C. The penetration index shows variation with increasing replacement of unsubstituted vinyl aromatic monomer (S) by substituted vinyl aromatic monomer (pMS) in the modified diene copolymer composition: Control without pMS shows penetration index of about 76 dmm; and MDC 3-9 show variable from penetration index of about 68 dmm for MDC 4 with 6.25 wt % pMS to penetration index of about 97 dmm for MDC 9 with 20 wt % pMS, which show penetration index variable from about 25 to about 40% (i.e., 21-29 dmm) for MDC 3-9. The penetration index of the polymer modified asphalt compositions MDC 1-2 is lower with PG 64-22 asphalt: increases from penetration index of about 63 dmm for MDC 1 with 1 wt % pMS to penetration index of about 70 dmm for MDC 2 with 2.5 wt % pMS. The ductility at 25° C. shows variation with increasing replacement of unsubstituted vinyl aromatic monomer (S) by substituted vinyl aromatic monomer (pMS) in the modified diene copolymer composition: Control without pMS shows ductility at 25° C. of about 6 cm; and MDC 3-9 range from ductility at 25° C. of about 5 cm to ductility at 25° C. of about 7 cm, which show ductility at 25° C. variable of about 10% (i.e., 1 cm) for MDC 3-9. The ductility at 25° C. of the polymer modified asphalt compositions MDC 1-2 is higher with PG 64-22 asphalt: shows variable from ductility at 25° C. of about 9.0 cm to ductility at 25° C. of about 11.8 cm. The BDA cold bending temperature (TBDA) shows variation with increasing replacement of unsubstituted vinyl aromatic monomer (S) by substituted vinyl aromatic monomer (pMS) in the modified diene copolymer composition: Control without pMS shows TBDA of about −9° C.; and MDC 3-9 range from TBDA of about 0° C. to TBDA of about −15° C., which show TBDA variable from about 60 to about 90% (i.e., 6-9° C.) for MDC 3-9. The BDA cold bending temperature (TBDA) of the polymer modified asphalt compositions MDC 1-2 is lower with PG 64-22 asphalt: shows variable from TBDA of about −9° C. to TBDA of about −12° C.

TABLE 17
Performance of Modified Diene Copolymers in Polymer Modified Asphalt Compositions

| | | MDC | MDC | MDC | MDC | MDC | MDC | MDC | MDC | MDC |
|---|---|---|---|---|---|---|---|---|---|---|
| Polymer Modified Asphalt @8 wt % | Control | 1 | 2 | 3 | 4 | 5 | 6 | 7 | 8 | 9 |
| Brookfield Viscosity @ 160° C. (cP) | 1,215 | 955 | 849 | 1,314 | 1,381 | 1,340 | 1,368 | 1,357 | 1,393 | 1,360 |
| Brookfield Viscosity @ 190° C. (cP) | 441 | 368 | 318 | 436 | 478 | 475 | 470 | 475 | 481 | 473 |
| R&B Softening Point Temperature (° C.) | 74.0 | 71.2 | 69.1 | 74.0 | 73.0 | 75.0 | 77.0 | 75.0 | 74.0 | 74.0 |
| Penetration Index @ 25° C. (dmm) | 76 | 63 | 70 | 78 | 68 | 71 | 84 | 78 | 76 | 97 |
| Ductility @ 25° C. (cm) | 6.0 | 9.0 | 11.8 | 7.0 | 7.0 | 6.0 | 5.0 | 7.0 | 6.0 | 6.0 |
| BDA Cold Bending Temperature (° C.) | −9 | −12 | −9 | −15 | 0 | −3 | −3 | −3 | −3 | −3 |

The performance of the novel polymer modified asphalt (PMA) compositions MDC 1-9 containing a modified diene copolymer of the present invention formulated for roofing applications provides similar processability with slight increase in high temperature properties (i.e., 5% higher TRBSP), compared with prior art compositions. Surprisingly, the novel polymer modified asphalt compositions MDC 1-9 containing a modified diene copolymer of the present invention provide PMA performance with less rigidity (i.e., higher penetration index) and similar ductility at 25° C.

Table 18 shows the characterization of the novel polymer modified asphalt (PMA) compositions MDC 1-9 prepared by using a formulation for roofing applications at 11.0 wt % of modified diene copolymer based on total amount of the formulation. The polymer modified asphalt compositions MDC 3-9 and the Control were formulated with PG 70-22 asphalt (EKBE) and MDC 1-2 were formulated with PG 64-22 asphalt (EKBE). Dynamic viscosities of the polymer modified asphalt compositions MDC 1-9 were determined at 160 and 190° C. Dynamic viscosities of the polymer modified asphalt compositions MDC 3-9 are similar with increasing replacement of unsubstituted vinyl aromatic monomer (S) by substituted vinyl aromatic monomer (pMS) in the modified diene copolymer composition: Control without pMS shows dynamic viscosities of about 2,626 cP at 160° C. and 901 cP at 190° C.; and MDC 3-9 range from dynamic viscosities of about 2,616 cP at 160° C. and 893 cP at 190° C. to dynamic viscosities of about 2,845 cP at 160° C. and 1,010 cP at 190° C. Dynamic viscosities of the polymer modified asphalt compositions MDC 1-2 are lower with PG 64-22 asphalt: range from dynamic viscosities of about 1,650 cP at 160° C. and 653 cP at 190° C. to dynamic viscosities of about 1,811 cP at 160° C. and 698 cP at 190° C. Surprisingly, the dynamic viscosities of MDC 3-9 range: from about 2,616 to about 2,845 cP at 160° C.; and from about 893 to about 1,010 cP at 190° C., and the dynamic viscosities of MDC 1-2 range: from about 1,650 to about 1,811 cP at 160° C.; and from about 653 to about 698 cP at 190° C., most of which are well below the typical dynamic viscosities of about 8,000 cP at 160° C. and 6,000 cP at 190° C. desirable for roofing applications. The very low dynamic viscosities of the novel polymer modified asphalt (PMA) compositions MDC 1-9 make them suitable for facilitating the preparation and increasing the processability of polymer modified asphalt compositions with even higher polymer concentration, and masterbatch or concentrate applications. The reduced dynamic viscosities are not only an important processability performance advantage of the novel polymer modified asphalt (PMA) compositions MDC 1-9, given that allow for higher production rates and cost efficiencies under the same processing conditions, but also low energy processability performance advantage, given that allow for lower processing temperatures for the same production rates and cost efficiencies, which is a more environmental-friendly process.

Table 18 and FIG. 9 also show the following characterization of the performance of the novel polymer modified asphalt (PMA) compositions MDC 1-9 containing a modified diene copolymer of the present invention. The Ring and Ball softening point temperature (TRBSP) slightly decreases with increasing replacement of unsubstituted vinyl aromatic monomer (S) by substituted vinyl aromatic monomer (pMS) in the modified diene copolymer composition: Control without pMS shows TRBSP of about 82.5° C.; and MDC 3-9 decrease from TRBSP of about 81.4° C. for MDC 3 with 5 wt % pMS to TRBSP of about 75.3° C. for MDC 9 with 20 wt % pMS, which show TRBSP decrease of about 8% (i.e., 6-7° C.) for MDC 3-9. Ring and Ball softening point temperature (TRBSP) of the polymer modified asphalt compositions MDC 1-2 is lower with PG 64-22 asphalt: ranges from TRBSP of about 72.5° C. to TRBSP of about 73.5° C. The penetration index shows variation with increasing replacement of unsubstituted vinyl aromatic monomer (S) by substituted vinyl aromatic monomer (pMS) in the modified diene copolymer composition: Control without pMS shows penetration index of about 66 dmm; and MDC 3-9 show variable from penetration index of about 67 dmm to penetration index of about 123 dmm, which show penetration index variable of about 80% (i.e., 56-57 dmm) for MDC 3-9. The penetration index of the polymer modified asphalt compositions MDC 1-2 is lower with PG 64-22 asphalt: shows variable from penetration index of about 62 dmm to penetration index of about 65 dmm. The ductility at 25° C. shows variation with increasing replacement of unsubstituted vinyl aromatic monomer (S) by substituted vinyl aromatic monomer (pMS) in the modified diene copolymer composition: Control without pMS shows ductility at 25° C. of about 6 cm; and MDC 3-9 range from ductility at 25° C. of about 5 cm to ductility at 25° C. of about 8.3 cm, which show ductility at 25° C. variable from about 20 to about 30% (i.e., 2-3 cm) for MDC 3-9. The ductility at 25° C. of the polymer modified asphalt compositions MDC 1-2 is higher with PG 64-22 asphalt: shows variable from ductility at 25° C. of about 13.0 cm to ductility at 25° C. of about 20.8 cm. The BDA cold bending temperature (TBDA) shows variation with increasing replacement of unsubstituted vinyl aromatic monomer (S) by substituted vinyl aromatic monomer (pMS) in the modified diene copolymer composition: Control without pMS shows TBDA of about −3° C.; and MDC 3-9 range from TBDA of about −12° C. to TBDA of about −3° C., which show TBDA variable of about 300% (i.e., 9° C.) for MDC 3-9. The BDA cold bending temperature (TBDA) of the polymer modified asphalt compositions MDC 1-2 is lower with PG 64-22 asphalt: shows variable from TBDA of about −15° C. to TBDA of about −18° C. FIG. 9 shows that the performance of the novel polymer modified asphalt (PMA) compositions MDC 3-9, containing a modified diene copolymer of the present invention and PG 70-22 asphalt, has a distinct and optimum range from about 5 to about 10 wt % for the replacement of unsubstituted vinyl aromatic monomer (S) by substituted vinyl aromatic monomer (pMS) in the modified diene copolymer compositions. The distinct and optimum range of pMS in MDC 3-9 shows a decreasing effect on BDA cold bending temperature (TBDA) that presents a minimum peak of about −12° C. for MDC 4 with 6.25 wt % pMS and MDC 5 with 7.5 wt % pMS; Ring and Ball softening point temperature (TRBSP) of about 79.3° C. for MDC 5 with 7.5 wt % pMS; penetration index that presents a maximum peak of about 123 dmm for MDC 5 with 7.5 wt % pMS; and ductility at 25° C. that presents a maximum peak of about 8.3 cm for MDC 4 with 6.25 wt % pMS.

TABLE 18
Performance of Modified Diene Copolymers in Polymer Modified Asphalt Compositions

| | | MDC | MDC | MDC | MDC | MDC | MDC | MDC | MDC | MDC |
|---|---|---|---|---|---|---|---|---|---|---|
| Polymer Modified Asphalt @ 11 wt % | Control | 1 | 2 | 3 | 4 | 5 | 6 | 7 | 8 | 9 |
| Brookfield Viscosity @ 160° C. (cP) | 2,626 | 1,650 | 1,811 | 2,782 | 2,822 | 2,843 | 2,709 | 2,845 | 2,777 | 2,616 |
| Brookfield Viscosity @ 190° C. (cP) | 901 | 653 | 698 | 965 | 984 | 980 | 926 | 1,010 | 942 | 893 |
| R&B Softening Point Temperature (° C.) | 82.5 | 72.5 | 73.5 | 81.4 | 76.9 | 79.3 | 79.8 | 79.9 | 76.5 | 75.3 |
| Penetration Index @ 25° C. (dmm) | 66 | 65 | 62 | 67 | 86 | 123 | 83 | 79 | 78 | 123 |
| Ductility 25° C. (cm) | 6.0 | 20.8 | 13.0 | 7.5 | 8.3 | 5.0 | 7.0 | 7.5 | 7.0 | 5.0 |
| BDA Cold Bending Temperature (° C.) | −3 | −15 | −18 | −3 | −12 | −12 | −9 | −9 | −9 | −9 |

The performance of the novel polymer modified asphalt (PMA) compositions MDC 1-9 containing a modified diene copolymer of the present invention formulated for roofing applications provides similar processability with slight increase in high temperature properties (i.e., 8% lower TRBSP), compared with prior art compositions. Surprisingly, the novel polymer modified asphalt compositions MDC 1-9 containing a modified diene copolymer of the present invention provide excellent PMA performance with a distinct and optimum range from about 5 to about 10 wt % of pMS, wherein desirable performance maximum and minimum peaks show from about 6 to about 8 wt % of pMS for BDA cold bending temperature, Ring and Ball softening point temperature, penetration index, and ductility at 25° C. The excellent PMA performance provides the roofing application with desirable high and low temperature properties, good workability, better flexibility or improved fracture resistance, and less rigidity.

### Example 11

Applications in Polymer Modified Asphalt for Roofing Polymer Modified Asphalt of Modified Diene Copolymer Compositions (MDC)

Several polymer modified asphalt formulations containing modified diene copolymer compositions of the present invention MDC 10-13 were prepared in accordance to the procedure described in Example 10. The modified diene copolymer compositions MDC 10-13, described in Tables 3 and 4 of Example 2, were mixed with the materials and amounts described below.

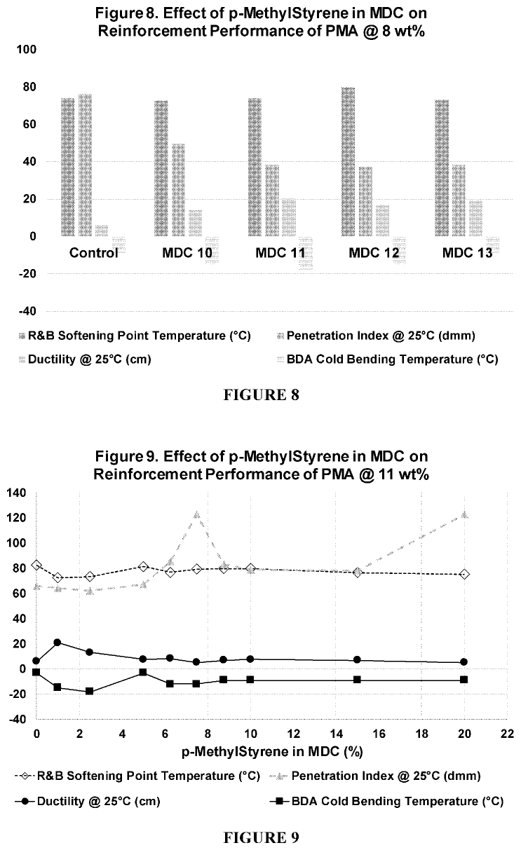

The performance of the novel polymer modified asphalt compositions MDC 10-13 containing a modified diene copolymer of the present invention is shown in Tables 19 and 20, and FIG. 8. The polymer modified asphalt (PMA) compositions MDC 10-13 were characterized by the testing procedures and the specific conditions and equipments described in Example 10.

Tables 19 and 20 shows the characterization of the novel polymer modified asphalt (PMA) compositions MDC 10-13 prepared by using formulations for roofing applications at 8.0 and 11.0 wt % of modified diene copolymer based on total amount of the formulation. The polymer modified asphalt compositions MDC 11 and MDC 13 and the Control were formulated with PG 70-22 asphalt (EKBE), and MDC 10 and MDC 12 were formulated with PG 64-22 asphalt (EKBE). Dynamic viscosities of the polymer modified asphalt compositions MDC 10-13 were determined at 160 and 190° C. Dynamic viscosities of the polymer modified asphalt compositions MDC 11 and MDC 13 are similar with replacement of unsubstituted vinyl aromatic monomer (S) by substituted vinyl aromatic monomer (pMS) in the modified diene copolymer composition. For dynamic viscosities at 8.0 wt % polymer in PMA formulation: Control without pMS shows dynamic viscosities of about 1,215 cP at 160° C. and 441 cP at 190° C.; and MDC 11 and MDC 13 range from dynamic viscosities of about 1,200 cP at 160° C. and 395 cP at 190° C. to dynamic viscosities of about 1,385 cP at 160° C. and 473 cP at 190° C. Dynamic viscosities of the polymer modified asphalt compositions MDC 10 and MDC 12 are lower with PG 64-22 asphalt: range from dynamic viscosities of about 882 cP at 160° C. and 333 cP at 190° C. to dynamic viscosities of about 1,020 cP at 160° C. and 343 cP at 190° C. For dynamic viscosities at 11.0 wt % polymer in PMA formulation: Control without pMS shows dynamic viscosities of about 2,626 cP at 160° C. and 901 cP at 190° C.; and MDC 11 and MDC 13 range from dynamic viscosities of about 2,533 cP at 160° C. and 821 cP at 190° C. to dynamic viscosities of about 2.608 cP at 160° C. and 842 cP at 190° C. Dynamic viscosities of the polymer modified asphalt compositions MDC 10 and MDC 12 are lower with PG 64-22 asphalt: range from dynamic viscosities of about 2,028 cP at 160° C. and 756 cP at 190° C. to dynamic viscosities of about 2,109 cP at 160° C. and 798 cP at 190° C. Surprisingly, all the dynamic viscosities for both 8.0 and 11.0 wt % polymer in PMA formulations are well below the typical dynamic viscosities of about 8,000 cP at 160° C. and 6,000 cP at 190° C. desirable for roofing applications. The very low dynamic viscosities of the novel polymer modified asphalt (PMA) compositions MDC 10-13 make them suitable for facilitating the preparation and increasing the processability of polymer modified asphalt compositions with even higher polymer concentration, and masterbatch or concentrate applications. The reduced dynamic viscosities are not only an important processability performance advantage of the novel polymer modified asphalt (PMA) compositions MDC 10-13, given that allow for higher production rates and cost efficiencies under the same processing conditions, but also low energy processability performance advantage, given that allow for lower processing temperatures for the same production rates and cost efficiencies, which is a more environmental-friendly process.

Tables 19 and 20, and FIG. 8 also show the following characterization of the performance of the novel polymer modified asphalt (PMA) compositions MDC 10-13 containing a modified diene copolymer of the present invention. The Ring and Ball softening point temperature (TRBSP) slightly decreases with replacement of unsubstituted vinyl aromatic monomer (S) by substituted vinyl aromatic monomer (pMS) in the modified diene copolymer composition. For Ring and Ball softening point temperature (TRBSP) at 8.0 wt % polymer in PMA formulation: Control without pMS shows TRBSP of about 74.0° C.; and MDC 11 and MDC 13 decrease from TRBSP of about 73.0° C. to TRBSP of about 74.0° C., which show TRBSP decrease of about 2% (i.e., 1° C.). Ring and Ball softening point temperature (TRBSP) of the polymer modified asphalt compositions MDC 10 and MDC 12 is variable with PG 64-22 asphalt: ranges from TRBSP of about 72.6° C. to TRBSP of about 79.7° C. For Ring and Ball softening point temperature (TRBSP) at 11.0 wt % polymer in PMA formulation: Control without pMS shows TRBSP of about 82.5° C.; and MDC 11 and MDC 13 decrease from TRBSP of about 78.2° C. to TRBSP of about 79.0° C., which show TRBSP decrease of about 4-5% (i.e., 3-4° C.). Ring and Ball softening point temperature (TRBSP) of the polymer modified asphalt compositions MDC 10 and MDC 12 is similar with PG 64-22 asphalt: ranges from TRBSP of about 81.5° C. to TRBSP of about 81.8° C. The penetration index decreases with replacement of unsubstituted vinyl aromatic monomer (S) by substituted vinyl aromatic monomer (pMS) in the modified diene copolymer composition. For penetration index at 8.0 wt % polymer in PMA formulation: Control without pMS shows penetration index of about 76 dmm; and both MDC 11 and MDC 13 decrease to penetration index of about 38 dmm, which show penetration index decrease of about 50% (i.e., 38 dmm). The penetration index of the polymer modified asphalt compositions MDC 10 and MDC 12 is variable with PG 64-22 asphalt: shows variation from penetration index of about 37 dmm to penetration index of about 49 dmm. For penetration index at 11.0 wt % polymer in PMA formulation: Control without pMS shows penetration index of about 66 dmm; and both MDC 11 and MDC 13 decrease to penetration index of about 36 dmm, which show penetration index decrease of about 45% (i.e., 30 dmm). The penetration index of the polymer modified asphalt compositions MDC 10 and MDC 12 is variable with PG 64-22 asphalt: shows variation from penetration index of about 34 dmm to penetration index of about 46 dmm. The ductility at 25° C. shows increase with replacement of unsubstituted vinyl aromatic monomer (S) by substituted vinyl aromatic monomer (pMS) in the modified diene copolymer composition. For ductility at 25° C. at 8.0 wt % polymer in PMA formulation: Control without pMS shows ductility at 25° C. of about 6 cm; and MDC 11 and MDC 13 increase from ductility at 25° C. of about 19 cm to ductility at 25° C. of about 20 cm, which show ductility at 25° C. increase to about 200% (i.e., 13-14 cm). The ductility at 25° C. of the polymer modified asphalt compositions MDC 10 and MDC 12 is lower with PG 64-22 asphalt: shows increase from ductility at 25° C. of about 14.0 cm to ductility at 25° C. of about 16.8 cm. For ductility at 25° C. at 11.0 wt % polymer in PMA formulation: Control without pMS shows ductility at 25° C. of about 6 cm; and MDC 11 and MDC 13 increase from ductility at 25° C. of about 17.5 cm to ductility at 25° C. of about 22.8 cm, which show ductility at 25° C. increase to about 200-300% (i.e., 11.5-16.8 cm). The ductility at 25° C. of the polymer modified asphalt compositions MDC 10 and MDC 12 is higher with PG 64-22 asphalt: shows increase from ductility at 25° C. of about 24.5 cm to ductility at 25° C. of about 35.0 cm. The BDA cold bending temperature (TBDA) shows variation with replacement of unsubstituted vinyl aromatic monomer (S) by substituted vinyl aromatic monomer (pMS) in the modified diene copolymer composition. For BDA cold bending temperature (TBDA) at 8.0 wt % polymer in PMA formulation: Control without pMS shows TBDA of about −9° C.; and MDC 11 and MDC 13 range from TBDA of about −9° C. to TBDA of about −18° C., which show TBDA decrease of about 0-100% (i.e., 0-9° C.). The BDA cold bending temperature (TBDA) of the polymer modified asphalt compositions MDC 10 and MDC 12 is lower with PG 64-22 asphalt: shows decrease to TBDA of about −15° C. for both. For BDA cold bending temperature (TBDA) at 11.0 wt % polymer in PMA formulation: Control without pMS shows TBDA of about −3° C.; and MDC 11 and MDC 13 show TBDA of about −3° C. for both. The BDA cold bending temperature (TBDA) of the polymer modified asphalt compositions MDC 10 and MDC 12 is lower with PG 64-22 asphalt: shows decrease from TBDA of about −18° C. to TBDA of about −21° C. FIG. 8 shows the performance of the novel polymer modified asphalt (PMA) composition MDC 11 at 8 wt % polymer that has a distinct and optimum distribution of about 5 wt % pMS in block C and about 5 wt % pMS in blocks B-A of the modified C-B-A diene copolymer composition for the replacement of unsubstituted vinyl aromatic monomer (S) by substituted vinyl aromatic monomer (pMS) in the modified diene copolymer compositions. The distinct and optimum distribution of pMS in MDC 11 shows a decreasing effect on BDA cold bending temperature (TBDA) that presents a minimum peak of about −18° C.; Ring and Ball softening point temperature (TRBSP) of about 74° C.; penetration index that presents a minimum peak of about 38 dmm; and ductility at 25° C. that presents a maximum peak of about 20 cm.

The performance of the novel polymer modified asphalt (PMA) compositions MDC 10-13 containing a modified diene copolymer of the present invention formulated at 8 wt % and 11 wt % polymer for roofing applications provides similar processability with slight decrease in high temperature properties (i.e., 0-5% lower TRBSP), compared with prior art compositions. Surprisingly, the novel polymer modified asphalt composition MDC 11 provides excellent PMA performance at 8 wt % of a polymer that has a distinct and optimum distribution of about 5 wt % pMS in block C and about 5 wt % pMS in blocks B-A of the modified C-B-A diene copolymer composition, wherein desirable performance maximum and minimum peaks show for BDA cold bending temperature, Ring and Ball softening point temperature, penetration index, and ductility at 25° C. The excellent PMA performance provides the roofing application with desirable high and low temperature properties, good workability, and better flexibility or improved fracture resistance.

TABLE 19
Performance of Modified Diene Copolymers in Polymer Modified Asphalt Compositions

| Polymer Modified Asphalt @8 wt % | Control | MDC 10 | MDC 11 | MDC 12 | MDC 13 |
|---|---|---|---|---|---|
| Brookfield Viscosity @ 160° C. (cP) | 1,215 | 882 | 1,385 | 1,020 | 1,200 |
| Brookfield Viscosity @ 190° C. (cP) | 441 | 333 | 473 | 343 | 395 |
| R&B Softening Point Temperature (° C.) | 74.0 | 72.6 | 74.0 | 79.7 | 73.0 |
| Penetration Index @ 25° C. (dmm) | 76 | 49 | 38 | 37 | 38 |
| Ductility @ 25° C. (cm) | 6.0 | 14.0 | 20.0 | 16.8 | 19.0 |
| BDA Cold Bending Temperature (° C.) | −9 | −15 | −18 | −15 | −9 |

TABLE 20
Performance of Modified Diene Copolymers in Polymer Modified Asphalt Compositions

| Polymer Modified Asphalt @ 11 wt % | Control | MDC 10 | MDC 11 | MDC 12 | MDC 13 |
|---|---|---|---|---|---|
| Brookfield Viscosity @ 160° C. (cP) | 2,626 | 2,028 | 2,533 | 2,109 | 2,608 |
| Brookfield Viscosity @ 190° C. (cP) | 901 | 756 | 821 | 798 | 842 |
| R&B Softening Point Temperature (° C.) | 82.5 | 81.8 | 79.0 | 81.5 | 78.2 |
| Penetration Index @ 25° C. (dmm) | 66 | 46 | 36 | 34 | 36 |
| Ductility @ 25° C. (cm) | 6.0 | 24.5 | 22.8 | 35.0 | 17.5 |
| BDA Cold Bending Temperature (° C.) | −3 | −21 | −3 | −18 | −3 |

1. A modified diene copolymer composition, comprising:
(i) a copolymer comprising units of a conjugated diene (CD) monomer, an unsubstituted vinyl aromatic (UVA) monomer and a substituted vinyl aromatic (SVA) monomer, wherein the copolymer includes a segment that comprises a copolymer of the CD monomer and the SVA monomer in addition to or other than by bonding of a block of CD monomer to a block of SVA monomer; or
(ii) a mixture of a copolymer of CD monomer and UVA monomer with a copolymer of CD monomer, UVA monomer and SVA monomer,
wherein the SVA monomer provides an in-chain or a chain-end reaction site useful in end-use applications for the modified diene copolymer composition.

2. The composition of claim 1, wherein the SVA monomer is a ring-substituted vinyl aromatic monomer.

3. The composition of claim 1, wherein the structure of the copolymer of CD and SVA is a random, tapered, counter-tapered or a controlled distribution of the units of the CD and the SVA monomers.

4. The composition of claim 1, wherein the copolymer comprising units of the CD monomer, the UVA monomer and the SVA monomer has a structure of
[CD/SVA]-[CD/SVA/UVA]-[UVA/SVA-SVA],
wherein a forward slash, /, indicates a copolymer of the units of the monomer identified by its abbreviation, wherein a closed pair of brackets, [ ], indicates a segment of the copolymer, and wherein the structure is determined by simultaneous anionic copolymerization of CD, UVA and SVA under unaltered reaction kinetics.

5. The composition of claim 4, wherein the copolymer has a structure X-([CD/SVA]-[CD/SVA/UVA]-[UVA/SVA-SVA])n determined by using a multifunctional initiator or a linking agent, wherein the copolymer comprises at least two of said copolymer chains, and wherein the copolymer may be totally or partially multi-initiated or linked.

6. The composition of claim 1, wherein the copolymer comprises a block copolymer, wherein the block copolymer has a structure of UVA-(CD-UVA)-SVA or UVA-(CD-SVA)-SVA or SVA-(CD-UVA)-SVA or SVA-(CD-SVA)-SVA.

7. The composition of claim 6, wherein the structure of the (CD-UVA) block or the (CD-SVA) block is a random, tapered, counter-tapered or a controlled distribution of the units of the CD and the UVA or SVA monomers.

8. The composition of claim 6, further comprises a second copolymer having a structure of [UVA-(CD-UVA)]ₙ-X or [UVA-(CD-SVA)]ₙ-X or [SVA-(CD-UVA)]n-X or [SVA-(CD-SVA)]n-X, wherein X is a residual moiety from a coupling agent.

9. A process for making a modified diene copolymer (MDC) composition, comprising the steps of:
adding a solvent to a reactor;
adding an unsubstituted vinyl aromatic (UVA) monomer to the reactor;
adding a substituted vinyl aromatic (SVA) monomer to the reactor;
adding a conjugated diene (CD) monomer to the reactor;
adding an initiator to the reactor to initiate a reaction; and
copolymerizing the CD, UVA and SVA monomers simultaneously, thereby forming a product copolymer comprising units of the CD, UVA and SVA monomers.

10. The process of claim 9, wherein the product copolymer has a structure of
[CD/SVA]-[CD/SVA/UVA]-[UVA/SVA-SVA],
wherein a forward slash, /, indicates a copolymer of the units of the monomer identified by its abbreviation, and wherein a closed pair of brackets, [ ], indicates a segment of the product copolymer.

11. The process of claim 10, wherein the copolymer has a structure X-([CD/SVA]-[CD/SVA/UVA]-[UVA/SVA-SVA])n determined by using a multifunctional initiator or a linking agent, wherein the copolymer comprises at least two of said copolymer chains, and wherein the copolymer may be totally or partially multi-initiated or linked.

12. The process of claim 9, wherein the SVA monomer is a ring-substituted vinyl aromatic monomer.

13. The process of claim 12, wherein the ring-substituted vinyl aromatic monomer is selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene.

14. A modified diene copolymer composition, comprising:
(i) a copolymer comprising units of a conjugated diene (CD) monomer, styrene (STY) monomer and a ring-substituted vinyl aromatic (P) monomer, wherein the copolymer includes a segment that comprises a copolymer of CD and P in addition to or other than by bonding of a CD block to a P block; or
(ii) a mixture of a STY-CD copolymer and a STY-CD-P copolymer,
wherein P provides an in-chain or a chain-end reaction site useful in end-use applications for the modified diene copolymer composition.

15. The composition of claim 14, wherein the structure of the copolymer of CD and P is a random, tapered, counter-tapered or a controlled distribution of the units of the CD and the P monomers.

16. The composition of claim 14, wherein the copolymer has a structure of
[CD/P]-[CD/P/STY]-[STY/P-P],
wherein a forward slash, /, indicates a copolymer of the units of the monomer identified by its abbreviation, wherein a closed pair of brackets, [ ], indicates a segment of the copolymer, and wherein the structure is determined by simultaneous anionic copolymerization of CD, STY and P under unaltered reaction kinetics.

17. The composition of claim 16, wherein the copolymer has a structure X-([CD/P]-[CD/P/STY]-[STY/P-P])n determined by using a multifunctional initiator or a linking agent, wherein the copolymer comprises at least two of said copolymer chains, and wherein the copolymer may be totally or partially multi-initiated or linked.

18. The composition of claim 14, wherein the copolymer comprises a block copolymer, wherein the block copolymer has a structure of STY-([CD/P]-[CD/P/STY]-[STY/P-P]), wherein the [CD/P]-[CD/P/STY]-[STY/P-P] block is formed by simultaneous anionic copolymerization of CD, STY and P.

19. The composition of claim 18, wherein the second block is formed under altered reaction kinetics due to a polar modifier.

20. The composition of claim 19, wherein the second block copolymer is formed while adding the CD to a reactor at a slower rate than the STY and/or the P are added to the reactor, thereby forming a counter-tapered structure in which more STY and/or P are initially incorporated into the [CD/P]-[CD/P/STY]-[STY/P-P] block copolymer than if the CD had been added to the reactor at the same rate that the STY was added to the reactor, wherein counter tapered means that the molar ratio of the CD monomer to STY and/or P monomer in the second block is lower proximal to the STY block relative to the molar ratio of the CD monomer to the STY and/or the P monomer distal to the STY block.

21. The composition of claim 14, wherein the copolymer comprises a block copolymer, wherein the block copolymer has a structure of P-([CD/P]-[CD/P/STY]-[STY/P-P]), wherein the P block is formed by anionic polymerization of P, and wherein the [CD/P]-[CD/P/STY]-[STY/P-P] block is formed by simultaneous anionic copolymerization of CD, STY and P.

22. The composition of claim 21, wherein the second block is formed under altered reaction kinetics due to a polar modifier.

23. The composition of claim 22, wherein the second block copolymer is formed while adding the CD to a reactor at a slower rate than the STY and/or the P are added to the reactor, thereby forming a counter-tapered structure in which more STY and/or P are initially incorporated into the [CD/P]-[CD/P/STY]-[STY/P-P] block copolymer than if the CD had been added to the reactor at the same rate that the STY was added to the reactor, wherein counter tapered means that the molar ratio of the CD monomer to STY and/or P monomer in the second block is lower proximal to the P block relative to the molar ratio of the CD monomer to the STY and/or the P monomer distal to the P block.

24. The composition of claim 14, wherein the copolymer comprises a block copolymer, wherein the block copolymer has a structure of STY-(CD/STY)-P or STY-(CD/P)-P or P-(CD/STY)-P or P-(CD/P)-P.

25. The composition of claim 24, wherein the (CD/STY) block or the (CD/P) block is formed under altered reaction kinetics due to a polar modifier.

26. The composition of claim 25, wherein the (CD/STY) or the (CD/P) block copolymer is formed while adding the CD to a reactor at a slower rate than the STY or the P is added to the reactor, thereby forming a counter-tapered structure in which more STY or P is initially incorporated into the (CD/STY) or the (CD/P) block copolymer, respectively, than if the CD had been added to the reactor at the same rate that the STY or the P was added to the reactor, wherein counter tapered means that the molar ratio of the CD monomer to STY or P monomer in the (CD/STY) or the (CD/P) block is lower proximal to the first STY or the first P block relative to the molar ratio of the CD monomer to the STY or the P monomer distal to the first STY or the first P block.

27. The composition of claim 24, wherein the copolymer further comprises a second copolymer having a structure of [STY-(CD/STY)]ₙ-X or [STY-(CD/P)]ₙ-X or [P-(CD/STY)]n-X or [P-(CD/P)]n-X, wherein X is a residual moiety from a coupling agent.

28. The composition of claim 14, wherein the copolymer comprises a mixture of a triblock copolymer and a coupled copolymer, wherein the triblock copolymer has a structure of STY-CD-P, and wherein the coupled copolymer has a structure of (STY-CD)ₙ-X, wherein X is a residual moiety from a coupling agent.

29. The composition of claim 14, wherein the copolymer comprises a block copolymer, wherein the block copolymer has a structure of STY-(CD/P)-P or P-(CD/P)-P or STY-(CD/P)-STY.

30. The composition of claim 29, wherein the (CD/P) block is formed under altered reaction kinetics due to a polar modifier.

31. The composition of claim 30, wherein the (CD/P) block copolymer is formed while adding the CD to a reactor at a slower rate than the P is added to the reactor, thereby forming a counter-tapered structure in which more P is initially incorporated into the (CD/P) block copolymer than if the CD had been added to the reactor at the same rate that the P was added to the reactor, wherein counter tapered means that the molar ratio of the CD monomer to P monomer in the (CD/P) block is lower proximal to the first STY or the first P block relative to the molar ratio of the CD monomer to the P monomer distal to the first STY or the first P block.

32. The composition of claim 14, wherein P is selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene.

33. The composition of claim 14, wherein CD is at least one monomer selected from the group consisting of a butadiene, isoprene, β-myrcene and β-farnesene, and wherein P is p-methylstyrene or p-tertbutylstyrene.

34. The composition of claim 14, wherein the copolymer is selectively, partially or fully hydrogenated, or wherein the modified diene copolymer composition is presented in the form of a bale, free-flowing, powder, emulsion, or encapsulated.

35. A bituminous or asphalt composition, comprising:
at least one bitumen or asphalt; and
a modified diene copolymer (MDC) composition according to claim 1,
wherein the bituminous or asphalt composition includes from about 0.5 to about 25 percent by weight of the MDC composition.

36. The bituminous or asphalt composition of claim 35, further comprising at least one emulsifying agent, wherein the bituminous or asphalt composition is emulsified in water.

37. An adhesive or coating composition, comprising:
at least one additive selected from the group consisting of plasticizers, fillers, coupling agents, crosslinking agents, photoinitiators, flow resins, tackifying resins, processing aids, antiozonants and antioxidants; and
a modified diene copolymer (MDC) composition according to claim 1,
wherein the adhesive or coating composition includes from about 0.5 to about 50 percent by weight of the MDC composition.

38. A sealant composition, comprising:
at least one additive selected from the group consisting of plasticizers, fillers, coupling agents, crosslinking agents, photoinitiators, flow resins, tackifying resins, processing aids, antiozonants and antioxidants; and
a modified diene copolymer (MDC) composition according to claim 1,
wherein the sealant composition includes from about 0.5 to about 50 percent by weight of the MDC composition.

39. A plastic composition, comprising:
a polymeric composition; and
a modified diene copolymer (MDC) composition according to claim 1,
wherein the MDC composition is mixed into the polymeric composition.

40. A process for making a modified diene copolymer (MDC) composition, comprising the steps of:
adding a solvent to a reactor;
adding styrene (STY) monomer to the reactor;
adding a ring-substituted vinyl aromatic (P) monomer to the reactor;
adding a conjugated diene (CD) monomer to the reactor;
adding a lithium initiator to the reactor to initiate a reaction; and
copolymerizing the CD, STY and P monomers simultaneously, thereby forming a product copolymer comprising units of the CD, STY and P monomers, wherein P is selected from the group consisting of o-methylstyrene, m-methylstyrene, p-methylstyrene, p-tertbutylstyrene, o-chlorostyrene, 2-butenyl naphthalene, 4-t-butoxystyrene, 3-isopropenyl biphenyl, 4-vinylpyridine, 2-vinylpyridine, isopropenyl naphthalene and 4-n-propylstyrene.

41. The process of claim 40, wherein the product copolymer has a structure of
[CD/P]-[CD/P/STY]-[STY/P-P],
wherein a forward slash, /, indicates a copolymer of the units of the monomer identified by its abbreviation, and wherein a closed pair of brackets, [ ], indicates a segment of the product copolymer.

42.-46. (canceled)

47. A process for making a modified diene copolymer (MDC) composition, comprising the steps of:
adding a solvent to a reactor;
adding a polar modifier to the reactor;
adding styrene (STY) monomer or a ring-substituted vinyl aromatic (P) monomer to the reactor;
adding a lithium initiator to the reactor to initiate a reaction;
allowing the STY monomer or the P monomer to polymerize, thereby forming a STY block or a P block, respectively;
adding P monomer to the reactor;
adding STY monomer to the reactor;
adding a conjugated diene (CD) monomer to the reactor, and
allowing the CD monomer, the STY monomer and the P monomer to copolymerize, thereby forming a ([CD/P]-[CD/P/STY]-[STY/P-P]) copolymer block and finally forming a STY-([CD/P]-[CD/P/STY]-[STY/P-P]) diblock copolymer or a P-([CD/P]-[CD/P/STY]-[STY/P-P]) diblock copolymer.

48.-56. (canceled)

57. A process for making a modified diene copolymer (MDC) composition, comprising the steps of:
adding a solvent to a reactor;
adding a polar modifier to the reactor;
adding styrene (STY) monomer or a ring-substituted vinyl aromatic (P) monomer to the reactor;
adding a lithium initiator to the reactor to initiate a reaction;
allowing the STY monomer or the P monomer to polymerize, thereby forming a STY block or a P block, respectively;
adding a conjugated diene (CD) monomer and P monomer to the reactor;
allowing the CD and P monomers to copolymerize, thereby forming a CD/P copolymer block and a living STY-(CD/P) diblock copolymer or P-(CD/P) diblock copolymer; and
adding P or STY monomer to the reactor and allowing copolymerization to proceed, thereby forming a STY-(CD/P)-P triblock copolymer or a P-(CD/P)-P triblock copolymer or a STY-(CD/P)-STY triblock copolymer.

58.-62. (canceled)

63. A process for making a modified diene copolymer (MDC) composition, comprising the steps of:
adding a solvent to a reactor;
adding a polar modifier to the reactor;
adding styrene (STY) monomer or a ring-substituted vinyl aromatic (P) monomer to the reactor;
adding a lithium initiator to the reactor to initiate a reaction;
allowing the STY or P monomer to polymerize, thereby forming a STY block or a P block;
adding STY monomer or P monomer and a conjugated diene (CD) monomer to the reactor;
allowing the CD monomer and the STY monomer or the P monomer to copolymerize, thereby forming a [(CD/STY) or a (CD/P)] copolymer block and a living [STY-(CD/STY) or P-(CD/STY) or STY-(CD/P) or P-(CD/P)] diblock copolymer;
adding a coupling agent to the reactor and partially coupling the living [STY-(CD/STY) or P-(CD/STY) or STY-(CD/P) or P-(CD/P)] diblock copolymer, thereby forming a mixture of the living [STY-(CD/STY) or P-(CD/STY) or STY-(CD/P) or P-(CD/P)] diblock copolymer and coupled [STY-(CD/STY)]ₙ-X or [P-(CD/STY)]ₙ-X or [STY-(CD/P)]ₙ-X or [P-(CD/P)]ₙ-X copolymer, where X is a residual moiety from the coupling agent; and
adding P monomer to the reactor and allowing copolymerization to proceed, thereby forming a mixture of a [STY-(CD/STY)-P or P-(CD/STY)-P or STY-(CD/P)-P or P-(CD/P)-P]triblock copolymer and coupled [STY-(CD-STY)]ₙ-X or [P-(CD-STY)]ₙ-X or [STY-(CD/P)]ₙ-X or [P-(CD/P)]ₙ-X copolymer.

64.-68. (canceled)

69. A process for making a modified diene copolymer (MDC) composition, comprising the steps of:
adding a solvent to a reactor;
adding a polar modifier to the reactor;
adding styrene (STY) monomer or a ring-substituted vinyl aromatic (P) monomer to the reactor;
adding a lithium initiator to the reactor to initiate a reaction;
allowing the STY or P monomer to polymerize, thereby forming a STY block or a P block;
adding a conjugated diene (CD) monomer to the reactor;
allowing the CD monomer to polymerize, thereby forming a CD polymer block and a living [STY-CD or P-CD] diblock copolymer;
adding a coupling agent to the reactor and partially coupling the living [STY-CD or P-CD] diblock copolymer, thereby forming a mixture of the living [STY-CD or P-CD] diblock copolymer and coupled [(STY-CD)ₙ-X or (P-CD)ₙ-X] copolymer, where X is a residual moiety from the coupling agent; and
adding P monomer to the reactor and allowing copolymerization to proceed, thereby forming a mixture of a [STY-CD-P or P-CD-P] triblock copolymer and coupled [(STY-CD)ₙ-X or (P-CD)ₙ-X] copolymer.

70.-73. (canceled)
